(19) United States
(12) Patent Application Publication
(10) Pub. No.: US 2018/0016027 A1
(43) Pub. Date: Jan. 18, 2018

(54) SYSTEM AND METHOD FOR PAYLOAD MANAGEMENT FOR AN UNMANNED AIRCRAFT

(71) Applicant: Elwha LLC, Bellevue, WA (US)

(72) Inventors: JESSE R. CHEATHAM, III, SEATTLE, WA (US); WILLIAM DAVID DUNCAN, SAMMAMISH, WA (US); RODERICK A. HYDE, REDMOND, WA (US); YAROSLAV A. URZHUMOV, BELLEVUE, WA (US); LOWELL L. WOOD, JR., BELLEVUE, WA (US)

(73) Assignee: Elwha LLC

(21) Appl. No.: 15/213,133

(22) Filed: Jul. 18, 2016

(51) Int. Cl. B64D 45/00; G06Q 10/08; G05D 1/00; B64C 39/02; B64D 9/00; G06Q 30/02; G05D 1/10

(52) U.S. Cl. CPC B64D 45/00; G06Q 30/0284; G06Q 10/0832; G05D 1/101; B64C 39/024; B64D 9/00; G05D 1/0011; B64C 2201/128

(57) ABSTRACT

A system and method for payload management for a UAV/aircraft is disclosed. UAV/craft may be configured for a mission with aerodynamically-exposed payload to be delivered from originator to destination on a route in operating conditions. UAV/aircraft may provide an aerodynamic profile indicative of the expected aerodynamic performance in view of considerations such as flight characteristics and effects; a base aerodynamic profile without payload and a loaded aerodynamic profile with payload may be determined. The system and method may comprise estimation/determination and assessment/transaction of a freight charge for the mission based on aerodynamic profile and other considerations; freight charge may comprise a surcharge or penalty based on performance using unit reference points and factors/considerations. UAV/aircraft system can be configured and operated/managed to interface with the system; missions may be optimized based on freight charge or other considerations. The system comprises an interface with UAV/aircraft and data sources and/or networks for data communications.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority applications”), if any, listed below (e.g. claims earliest available priority dates for other than provisional patent applications or claims benefits under 35 U.S.C. §119(e) for provisional patent applications, for any and all parent, grandparent, great-grandparent, etc. applications of the Priority application(s)).

### PRIORITY APPLICATIONS

[None]

### RELATED APPLICATIONS

[None]

### BACKGROUND

It is known to use unmanned aircraft (e.g. referred to as unmanned air/aerial vehicle (UAV) or drone) and unmanned aircraft systems (UAS) (e.g. with an operator/pilot at a remote location, etc.) for various purposes in various environments.

Such unmanned aircraft (UAV/craft or UAV/drone craft) at present exist in a wide variety of forms (shapes/sizes), types (e.g. winged craft, rotor-driven craft, etc.) with a variety of propulsion systems (e.g. engines, thrust-production, etc.), capacities, etc., and with a variety of capabilities, carrying capacities, control systems, telemetry systems, robustness, range, etc. Such UAV/craft are able to perform a wide variety of functions in military, commercial, recreational and other applications. Some UAV/drone craft may have on-board control systems and/or may be operated by pilots at remote stations with data communications and instrumentation/feedback from the craft; other UAV/drone craft may have relatively simple control systems (e.g. basic remote control by line of sight by the operator).

The design, configuration, size and form and operation of UAV/drone craft are different (e.g. typically smaller) from typical commercial aircraft and may vary significantly between types of UAV/drone craft; UAV/drone craft may be provided in various forms, including in forms that range from relatively simple to relatively complex.

Differences in size/form, use and operation of UAV/drone craft allow for variations/differences in design configuration, use and operation that can be implemented to facilitate various specific functionality modifications and enhancements for UAV/drone craft. Differences in the use, operation, operational requirements and design of UAV/drone craft can facilitate differences in the manner of operation and accompanying systems and methods of operating UAV/craft and of supporting UAV/craft operation. UAV/drone craft may be designed and constructed to have varied capabilities for widely varied functions. Some UAV/drone craft may be designed for cost-efficiency and simplicity; other UAV/drone systems may be designed for heavy-duty tasks in operation. UAV/drone craft vary in types of design/form, propulsion system configuration, size, primary purpose, airworthiness/robustness, controllability/telemetry, data communications and failure modes, etc.

One common form of UAV/craft is configured with a base and one or a set of rotors (e.g. to provide lift/thrust for propulsion) as in a conventional helicopter. It is known to provide a such UAV/aircraft with a propulsion system includes an electric motor driven by an energy storage system including a battery.

In such known arrangements, the range and usefulness of the UAV/aircraft may be limited by the amount of energy available (e.g. from the battery system). In a typical implementation the UAV/aircraft will be used in a manner such that it can travel from one location to another location (e.g. destination) on the amount of energy available (e.g. stored) in the battery; the battery may typically be charged at one location and then recharged upon arrival at the other location (e.g. destination). The requirement that the UAV/aircraft operate in such a charge and recharge arrangement may limit the route and utility of the UAV/aircraft.

It is known to provide a UAV/craft for use in any of a wide variety of functions and operations including monitoring/surveillance, data transmission/communications, hobby/entertainment, advertising/marketing, etc. UAV/drone craft may be configured specially to perform functions for such as local/light parcel delivery.

In operation and performing a function, UAV/aircraft will have an aerodynamic performance in use that is based on the form and operation/use and conditions. In use UAV/aircraft may encounter effects such as drag and operating conditions (e.g. weather) that affect performance and efficiency. UAV/aircraft may be limited in usefulness and range/operation by energy use and efficiency. UAV/aircraft that carry payload will have effects such as reduced aerodynamic performance, loss of efficiency and increased energy use due to flight characteristics.

A consideration in operation of UAV/aircraft in commercial use to carry payload is aerodynamic performance including the effects of the form of the aircraft (e.g. shape, structure, type, configuration, flight characteristics, etc.) and the operation (e.g. mission requirements, speed, route, function/purpose, payload, payload attachment, etc.) and the operating conditions (e.g. weather, wind, etc.) on the mission. The operator of a UAV/craft on a mission to deliver payload from an originator to a destination on a route (e.g. along a flyway) in operating conditions (e.g. weather conditions) will incur costs of operation. The aerodynamic performance (including energy use/efficiency) for such a mission to deliver payload that is aerodynamically exposed may be substantially affected by the payload (e.g. payload type and form and carrying configuration resulting in increased costs of operation). Management of payload and payload effects generally affect the aerodynamic performance of a UAV/craft.

It would be advantageous to provide an improved payload management system configured to manage the operation of UAV/drone craft carrying payload; it would also be advantageous to have a system and method of assessing costs for operating of a UAV/aircraft to carry and deliver payload (e.g. costs that may be charged to the originator or destination entity for payload delivery).

### SUMMARY

It would be advantageous to provide a system and method for payload management for an unmanned aircraft system. It would be advantageous to provide an improved payload management system configured to manage the operation of UAV/drone craft carrying payload. It would be advantageous to provide a system for payload management for UAV/craft carrying and delivering payload that can be used to manage operation of UAV/craft and payload carrying and configuration.

The present inventions relate generally to a system and method for payload management for an unmanned aircraft system. The present inventions generally relate to improvements to methods and systems for payload management for unmanned aircraft systems.

The present invention relates to payload management system to determine freight charge for an unmanned aircraft system providing an aircraft configured to carry a payload with an aerodynamically-exposed portion on a mission from an originator by a carrier to a destination in operating conditions. The system comprises an aerodynamic profile for the aircraft with the payload; the aerodynamic profile for the aircraft comprises consideration of an effect of the payload on the flight characteristics of the aircraft. The freight charge for carrying the payload as freight on the mission to the destination is based on the aerodynamic profile of the aircraft with the payload.

The present invention also relates to a method of managing payload for an unmanned aircraft system comprising an aircraft configured to carry a payload with an aerodynamically-exposed portion as freight on a mission from an originator by a carrier to a destination in operating conditions. The method comprises the steps of associating the payload with the aircraft; and determining an aerodynamic profile of the aircraft with payload. An effect of the payload on the flight characteristics of the aircraft is determined; a freight charge for carrying the payload as freight on the mission to the destination is based on the aerodynamic profile of the aircraft with payload.

The present invention further relates to a method of managing an unmanned aircraft system comprising an aircraft configured to carry a payload with an aerodynamically-exposed portion on a mission from an originator by a carrier to a destination in operating conditions. The method comprises the steps of associating the payload with the aircraft; determining aerodynamic profile of the aircraft with payload; assessing freight charge for the mission based on aerodynamic profile of the aircraft with the payload including consideration of an effect of the payload on flight characteristics of the aircraft. Flight characteristics for the unmanned aircraft system comprise at least one of: mass properties; center of mass; moment of inertia; oscillatory effect of movement and/or oscillation of the payload; drag effect of aircraft carrying the payload.

The present invention further relates to a method for assessing a charge for carrying a payload in an unmanned aircraft based on effect of the payload with an aerodynamically-exposed portion. The method comprises the steps of: assessing characteristics of the payload on a mission; assessing packaging of the payload on a mission; assessing effect of characteristics of the payload on a mission; assessing effect of packaging of the payload on a mission; determining the charge based on effect of the payload carried on a mission.

The present invention further relates to a payload management system for an unmanned aircraft system providing an aircraft configured to carry a payload with an aerodynamically-exposed portion on a mission from an originator by a carrier to a destination to determine a charge for carrying the payload as freight in operating conditions. The system comprises a container for the payload to be associated with the aircraft; an aerodynamic profile for the aircraft with the payload. The aerodynamic profile for the aircraft comprises consideration of an effect of the payload on the flight characteristics of the aircraft; the charge for carrying the payload as freight is based on the aerodynamic profile of the aircraft with the payload.

The present invention further relates to a method of managing an unmanned aircraft system comprising an aircraft configured to carry a payload with an aerodynamically-exposed portion on a mission to a destination. The method comprises the steps of associating the payload with the aircraft; determining aerodynamic profile of the aircraft with payload. An effect of the payload on the flight characteristics of the aircraft is determined. Flight characteristics comprise at least one of: mass properties; center of mass; moment of inertia; oscillatory effect of movement and/or oscillation of the payload; drag effect of aircraft carrying the payload. Freight charge for carrying the payload as freight on the mission to the destination is based on the aerodynamic profile of the aircraft with the payload.

The foregoing summary is illustrative only and is not intended to be in any way limiting. In addition to the illustrative aspects, embodiments, and features described above, further aspects, embodiments, and features will become apparent by reference to the drawings and the following detailed description.

### FIGURES

FIG. 1A is a schematic diagram of an unmanned aircraft system according to an exemplary embodiment.

FIG. 1B is a schematic side view of an unmanned aircraft system with craft and pod for payload according to an exemplary embodiment.

FIG. 1C is a schematic perspective view of an unmanned aircraft system with craft and pod for payload according to an exemplary embodiment.

FIG. 1D is a schematic perspective view of an unmanned aircraft system with craft and pod for payload according to an exemplary embodiment.

FIGS. 2A and 2B are schematic perspective views of an unmanned aircraft system with craft and pod for payload according to an exemplary embodiment.

FIGS. 2C and 2D are schematic side elevation views of an unmanned aircraft system with craft and pod for payload according to an exemplary embodiment.

FIGS. 3A through 3F are schematic side elevation views of pod for payload according to an exemplary embodiment.

FIG. 4 is a schematic plan view of an airspace for unmanned aircraft according to an exemplary embodiment.

FIG. 5 is a schematic perspective view of flyway with system for managing unmanned aircraft according to an exemplary embodiment.

FIG. 6 is a schematic perspective view of flyway with system for managing unmanned aircraft according to an exemplary embodiment.

FIG. 7 is a schematic perspective view of a flyway with a system for managing unmanned aircraft according to an exemplary embodiment.

FIGS. 8A and 8B are schematic perspective views of an apparatus for attachment for the system according to an exemplary embodiment.

FIG. 8C is a schematic side elevation view of an apparatus for attachment for the system according to an exemplary embodiment.

FIG. 8D is a schematic perspective view of an apparatus for attachment for the system according to an exemplary embodiment.

FIGS. 8E through 8G are schematic side elevation views of flight surfaces of an aircraft according to an exemplary embodiment.

FIG. 9 is a schematic perspective view of a payload container (or pod) for an aircraft according to an exemplary embodiment.

FIGS. 10, 11A and 11B are schematic side elevation views of an unmanned aircraft system with craft and pod for payload according to an exemplary embodiment.

FIGS. 12A and 12B are schematic side elevation views of an unmanned aircraft system with craft and pod for payload according to an exemplary embodiment.

FIGS. 13A to 13D are schematic side elevation views of an unmanned aircraft system with craft and pod for payload according to an exemplary embodiment.

FIG. 14 is a schematic side elevation view of the pod with payload for the system according to an exemplary embodiment.

FIGS. 15A to 15C are schematic side elevation views of the pod with payload for the system according to an exemplary embodiment.

FIG. 15D is a schematic side elevation view of the pod with payload for the system according to an exemplary embodiment.

FIGS. 16A and 16B are schematic side elevation views of an apparatus for the pod of the system according to an exemplary embodiment.

FIGS. 17A and 17B are schematic side elevation views of an apparatus for the pod of the system according to an exemplary embodiment.

FIGS. 18A to 18B are schematic side elevation views of the pod for the system according to an exemplary embodiment.

FIG. 19 is a schematic side elevation view of the pod for the system according to an exemplary embodiment.

FIG. 20 is a schematic side elevation view of the pod for the system according to an exemplary embodiment.

FIGS. 21A and 21B are schematic side elevation views of the pod with payload for the system according to an exemplary embodiment.

FIGS. 22A and 22B are schematic side elevation views of the pod with payload for the system according to an exemplary embodiment.

FIGS. 23A and 23B are schematic side elevation views of the pod with payload for the system according to an exemplary embodiment.

FIG. 24 is a schematic side elevation view of the pod with payload for the system according to an exemplary embodiment.

FIGS. 25A and 25B are schematic system block diagrams of a system for management of unmanned aircraft system according to an exemplary embodiment.

FIG. 26 is a schematic system block diagram of an identifier of an unmanned aircraft system according to an exemplary embodiment.

FIG. 27 is a schematic system block diagram of a system for management of unmanned aircraft system according to an exemplary embodiment.

FIG. 28 is a schematic system block diagram of a system for management of unmanned aircraft system according to an exemplary embodiment.

FIG. 29 is a schematic system block diagram of a system for management of unmanned aircraft system according to an exemplary embodiment.

FIG. 30 is a schematic system block diagram of a system for management of unmanned aircraft system according to an exemplary embodiment.

FIG. 31 is a schematic system block diagram of a computing system according to an exemplary embodiment.

FIG. 32 is a schematic system block diagram of system functions and programs according to an exemplary embodiment.

FIG. 33 is a schematic system block diagram of system modules according to an exemplary embodiment.

FIG. 34 is a schematic system block diagram of a system for management of unmanned aircraft system according to an exemplary embodiment.

FIG. 35 is a schematic system block diagram of an unmanned aircraft system according to an exemplary embodiment.

FIG. 36 is a schematic system block diagram of data/information sets for an unmanned aircraft system according to an exemplary embodiment.

FIG. 37 is a schematic system block diagram of an unmanned aircraft system according to an exemplary embodiment.

FIG. 38 is a schematic system block diagram of a system for management of unmanned aircraft system according to an exemplary embodiment.

FIG. 39 is a schematic process flow diagram of a method of operation and use for a payload management system for an unmanned aircraft system according to an exemplary embodiment.

FIGS. 40A and 40B are schematic process flow diagrams of a method of operation and use for a payload management system for an unmanned aircraft system according to an exemplary embodiment.

FIGS. 41A through 41C are schematic process flow diagrams of a method of operation and use for a payload management system for an unmanned aircraft system according to an exemplary embodiment.

FIGS. 42A and 42B are schematic process flow diagrams of a method of operation and use for a payload management system for an unmanned aircraft system according to an exemplary embodiment.

FIGS. 43A through 43C are schematic process flow diagrams of a method of operation and use for a payload management system for an unmanned aircraft system according to an exemplary embodiment.

FIGS. 44A through 44C are schematic process flow diagrams of a method of operation and use for a payload management system for an unmanned aircraft system according to an exemplary embodiment.

FIGS. 45A and 45B are schematic process flow diagrams of a method of operation and use for a payload management system for an unmanned aircraft system according to an exemplary embodiment.

FIGS. 46A and 46B are schematic process flow diagrams of a method of operation and use for a payload management system for an unmanned aircraft system according to an exemplary embodiment.

FIG. 47 is a schematic process flow diagram of a method of operation and use for a payload management system for an unmanned aircraft system according to an exemplary embodiment.

### DESCRIPTION

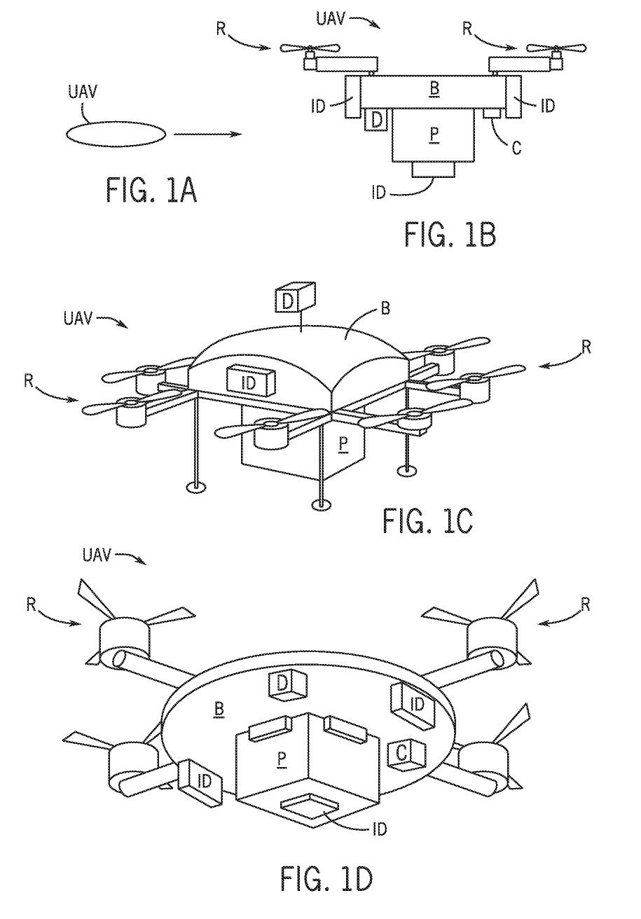

A system and method for payload management for an unmanned aircraft system comprising one or more UAV/craft is shown and described according to exemplary embodiments. The system and method is configured to facilitate the payload management for a UAV/craft on a mission to deliver payload on a route from an originator to a destination in operating conditions. The system and method may be configured to estimate/determine and assess/transact a charge for carrying the payload on the mission based on considerations that may include the aerodynamic profile/performance of the UAV/craft and other effects. The system and method for payload management may be configured according to exemplary and alternative embodiments including (but not limited to) as indicated and shown schematically and representationally in FIGS. 1A-47.

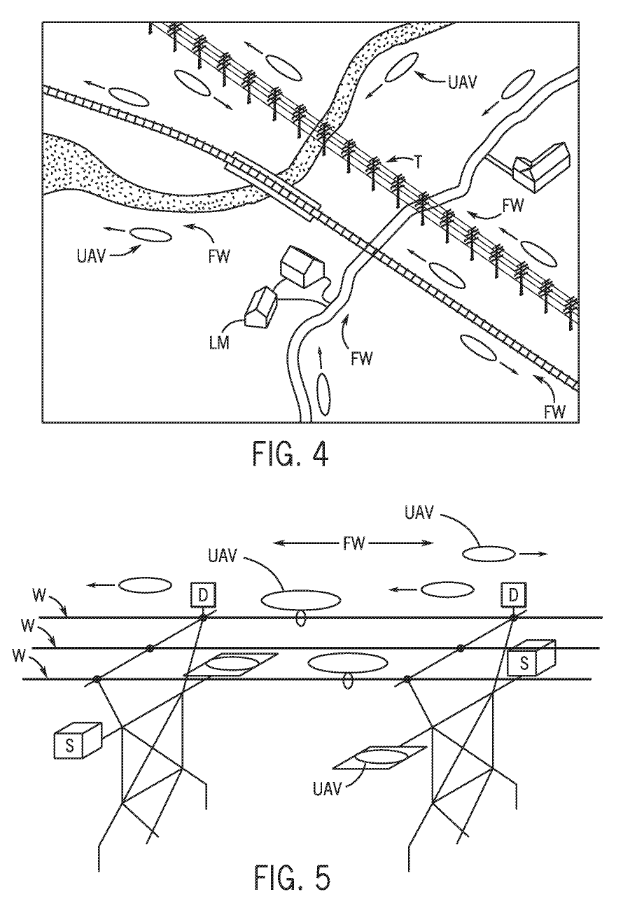

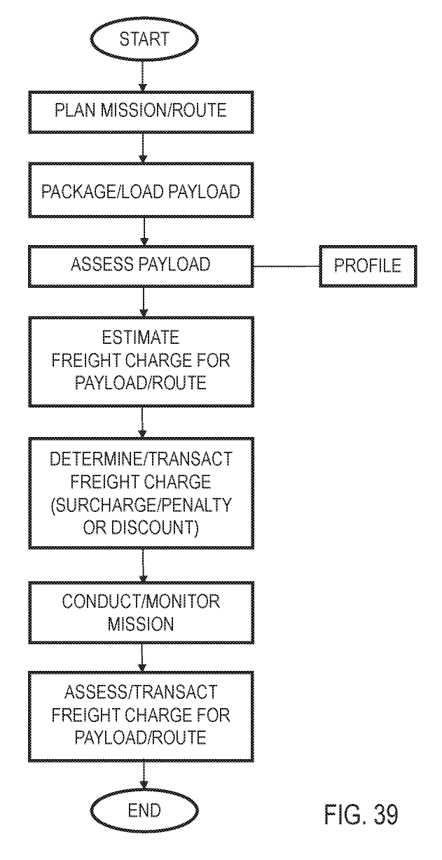

According to an exemplary embodiment, the system and method for payload management is configured to operate with UAV/craft carrying payload in various configurations (see e.g. FIGS. 1A-3F, 8A-24 and 25A-38) along a flyway (see e.g. FIGS. 4-7); according to an exemplary embodiment, the system can be configured and/or located (e.g. in association with other systems/subsystems and in data communications such as over a network) to manage payload for UAV/craft (see e.g. FIGS. 5-7 and 25A-38); according to an exemplary embodiment, the method can be configured to manage payload for UAV/craft (including to estimate/determine and assess/transact freight charge) based on considerations (e.g. from data/information) (see e.g. FIGS. 39-47).

### UAV/Craft Configuration

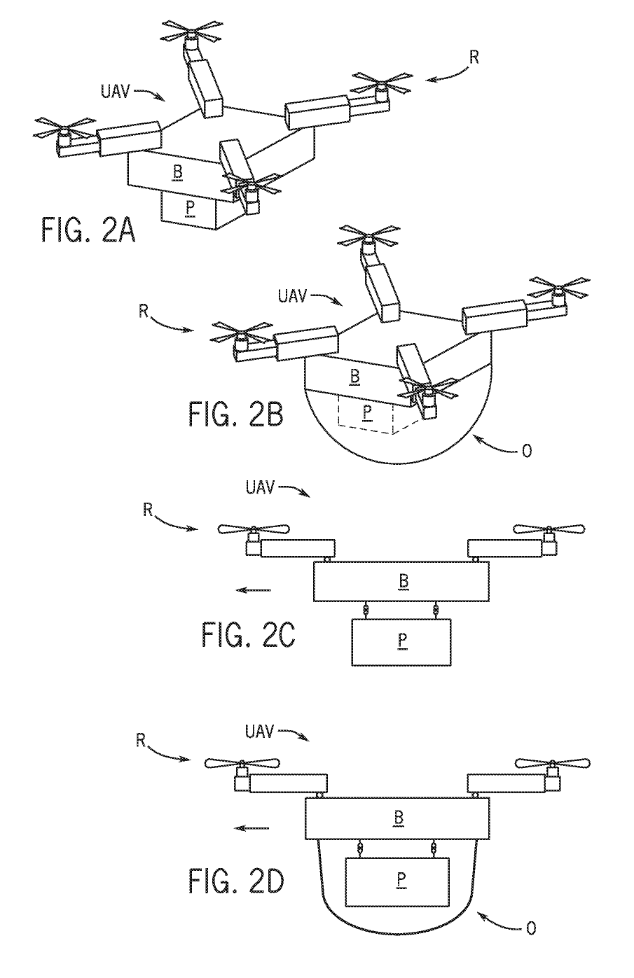

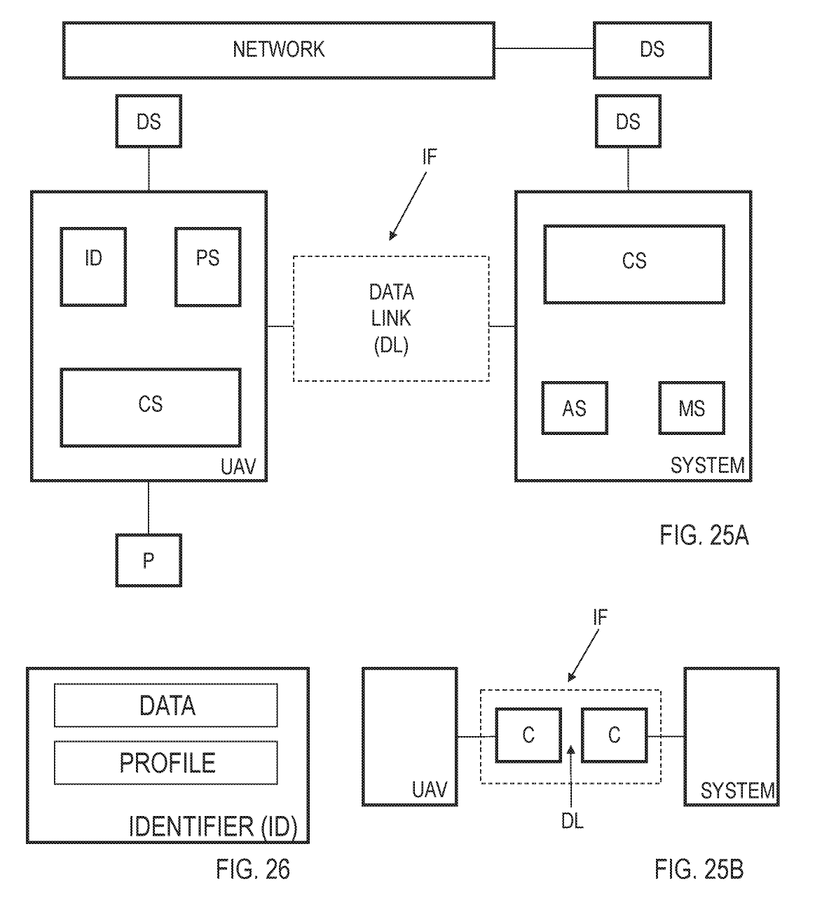

Referring to FIGS. 1A-1D and 2A-2D, unmanned aircraft systems shown as comprising UAV/craft are shown representationally and schematically according to exemplary embodiments. Referring to FIGS. 25A-25B and 37-38, the UAV/craft is shown schematically and representationally according to an exemplary embodiment (including with interface to the system). According to the exemplary embodiments, the system and UAV/craft interact under management and control as indicated representationally and schematically in FIGS. 5-7, 25A-38 and 39-47. Methods of use and operation of UAV/craft and system are shown representationally and schematically according to exemplary embodiments in FIGS. 39-47.

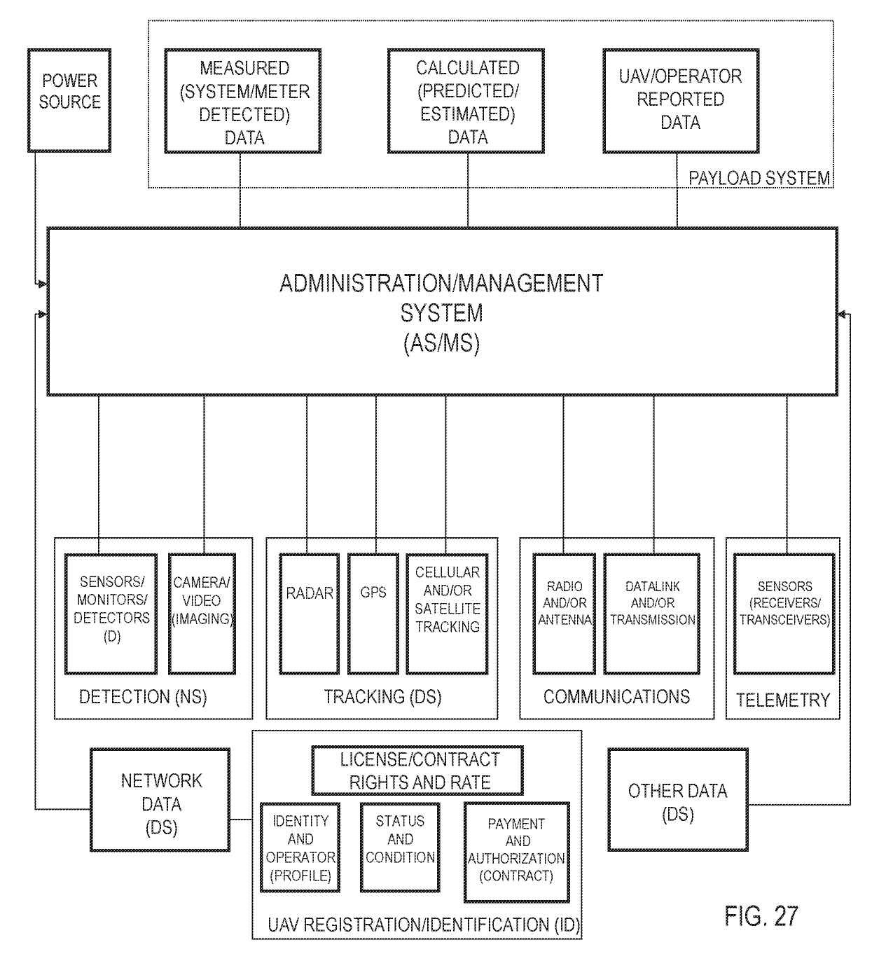

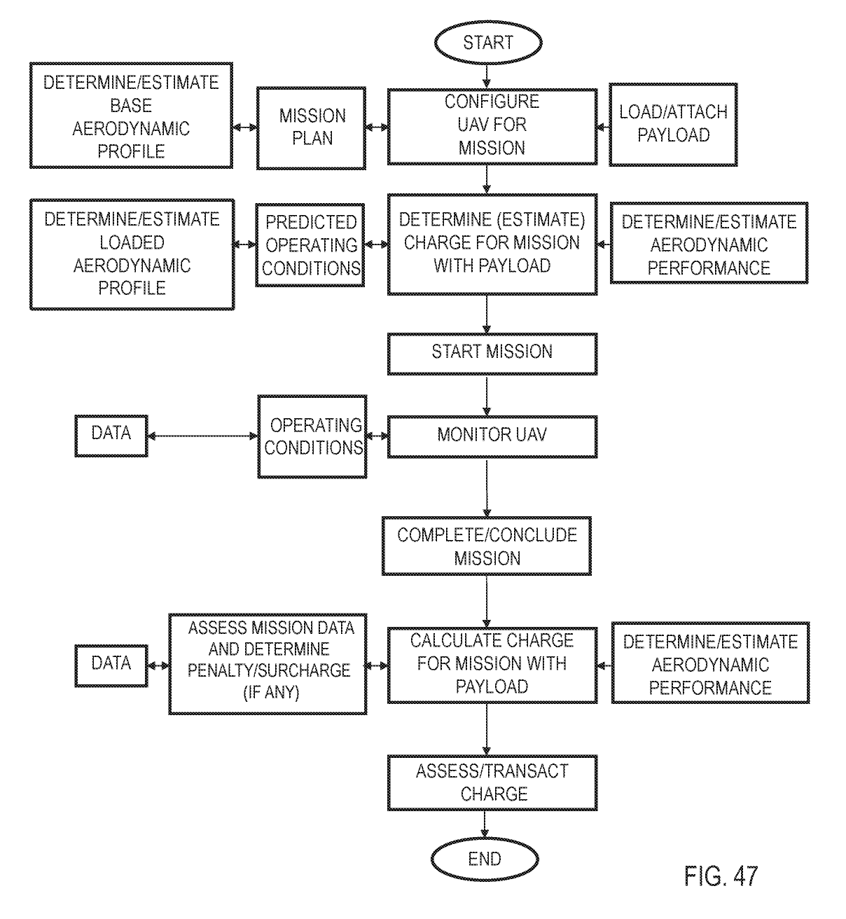

Referring to FIGS. 1A-1D, a UAV/craft is shown schematically according to an exemplary embodiment. As indicated schematically in FIG. 1A, the UAV/craft may be provided in any of a wide variety of types and forms including but not limited to the forms of conventional aircraft such as airplanes, helicopters, etc. See also FIGS. 4-7 and 27-30. Referring to FIGS. 1B-1D according to an exemplary embodiment shown schematically and representationally, the UAV/craft will be configured to carry a payload P on a mission. (As indicated, the mission may comprise a carrier to manage/control operation including carrying the payload P from an originator to a destination in operating conditions, see FIGS. 39 and 47) As shown schematically and representationally in FIGS. 1B-1D, the UAV/craft may provide a base B and a rotor system with rotors R. According to an exemplary embodiment as shown schematically, the UAV/craft may also comprise a system or module containing an identifier ID which may comprise and/or communicate data or information and or be presented visually for detection so that the UAV/craft can be identified when in operation (e.g. when on a mission on a flyway). The UAV/craft may comprise a connector C in the form of a system or module configured to establish a data link with the administration/management system (e.g. shown representationally as system S in FIGS. 5-7 and schematically in FIGS. 27-30). The UAV/craft may comprise a detector D in the form of a system or module configured to monitor and acquire data/information for the UAV/craft and/or system during operation (e.g. while in operation along a flyway or otherwise).

According to exemplary embodiments shown in the FIGURES, the UAV/craft is an aircraft generally of a “helicopter” type with an aircraft/space frame or base and rotor system (with propulsion system and energy storage system). See for example FIGS. 2A-2D, 3A-3F, 25A and 38. (e.g. aircraft with rotor system to generate thrust and lift to propel the aircraft (including with any payload) under the direction of a control system)

According to an exemplary embodiment, the UAV/craft may be provided in any of a wide variety of shapes and forms (including shapes/forms of aircraft that have been used or are presently in use or may be put into use in the future). According to any preferred embodiment, the UAV/craft is configured with a plurality of operational lift surfaces such as provided on rotors positioned relative to base to provide for safe/stable and efficient control/management and operation of the UAV/craft in expected operating conditions. See e.g. FIGS. 39-47.

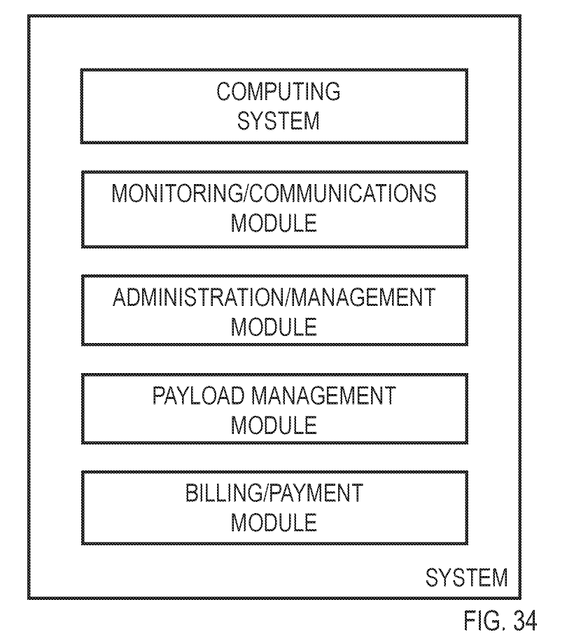

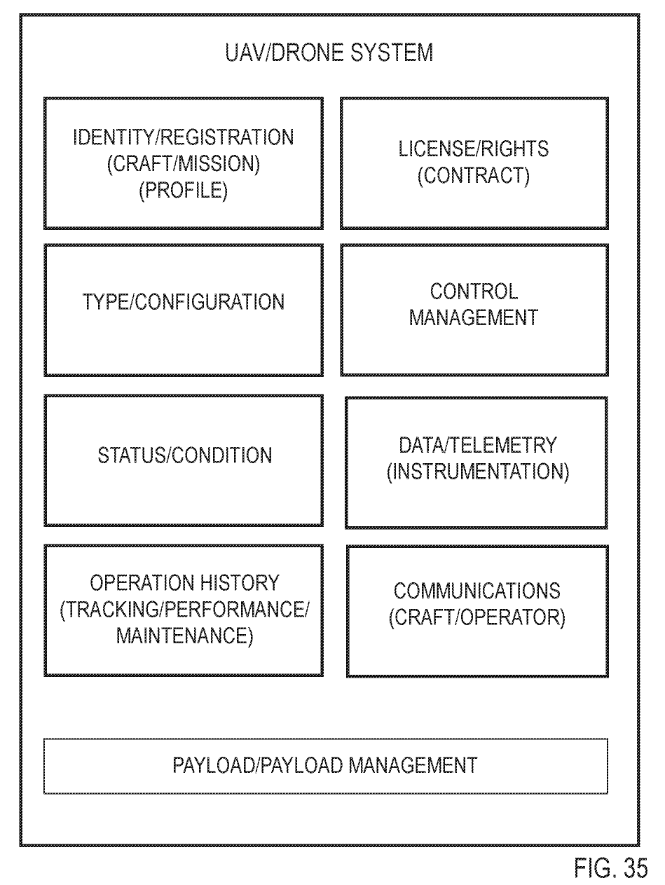

According to an exemplary embodiment, the rotor system of the UAV/craft may be driven by an electric motor or other type of power plant (e.g. as known and used presently); the base of the UAV/craft may comprise the power plant and other associated systems providing for operation of the rotors according to an exemplary embodiment (see for example FIGS. 35-37); associated with the power plant will be an energy/energy storage system such as a battery system and/or fuel storage; according to an alternative embodiment, the UAV/craft may comprise a hybrid energy/power system comprising at least two different subsystems (e.g. fuel/electric, etc.). According to any preferred embodiment, the UAV/craft will comprise a power/energy system as can be used to power and control rotational speed/thrust of rotor as well as to power and control mechanisms/subsystems used to configure the UAV/craft (e.g. position/reposition rotors/arms, etc.) and other on-board systems (e.g. control/computing systems, data/network communications, etc.). See also FIGS. 34-38.

According to an exemplary embodiment, the UAV/craft may be configured to perform any of a wide variety of functions including but not limited to carrying a payload such as for parcel/item delivery, monitoring/surveillance, data transmission/communications, hobby/entertainment, advertising/marketing, etc. According to an exemplary embodiment, the UAV/craft may be provided in any of a wide variety of configurations for any of a wide variety of functions and operated and/or controlled by any of a wide variety of systems as presently known and used in the art or as may be known and used in the art in the future. The system and method of the present application as shown and described representationally and schematically, can be adapted and implemented for use with any such UAV/craft according to the exemplary embodiments and according to other/alternative embodiments.

According to an exemplary embodiment, the UAV/craft may be provided in any of a wide variety of shapes and forms (including shapes/forms of aircraft that have been used or are presently in use or may be put into use in the future). According to any preferred embodiment, the UAV/craft is configured with a propulsion system (e.g. rotor system with plurality of operational rotors) positioned relative to base to provide for safe/stable and efficient control/management and operation of the UAV/craft in expected operating conditions. See e.g. FIGS. 27-30. According to exemplary embodiments, the UAV/craft may be provided in the form of a quad-copter (four rotors) as shown representationally and schematically in FIGS. 1B-1D and 2A-2D.

### Airspace/Flyway

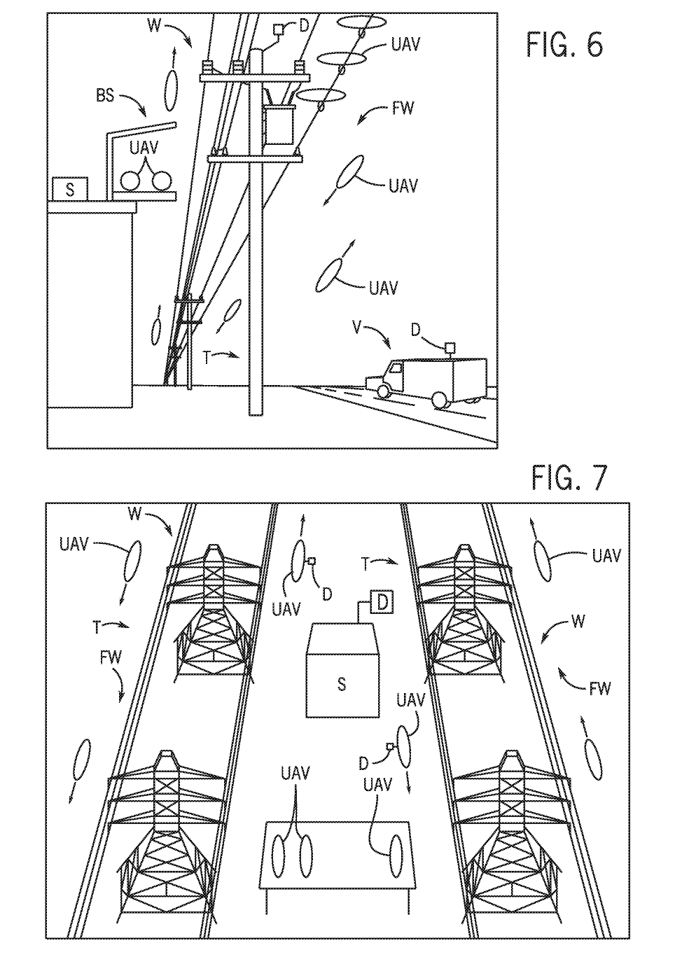

Referring to FIGS. 4-7, an airspace above a region is shown schematically and representationally according to an exemplary embodiment. Airspace comprises a space above land in a region with physical features shown as a road and a river and associated terrain, etc. According to an exemplary embodiment, the land in the region below the airspace comprises facilities for commerce, industry, inhabitants, transportation, etc. See e.g. FIGS. 4 and 6. For example, the region includes ground transportation for common carriers such as a railroad as well as obstructions to flight such as terrain and buildings shown schematically and representationally as homes (indicated as ground obstacles LW).

Region also comprises a utility transmission line system (e.g. power lines) comprising wires W connected and supported by structures or supports shown schematically and representationally as towers T. Unmanned aircraft (UAV) are shown in transit on flyways (FW) designated in the airspace above the region. As shown schematically and representationally according to an exemplary embodiment, a flyway is designated above a road, a flyway is designated above a railroad line/track, a flyway is designated above a waterway (e.g. river or creek) and a flyway is designated above a utility transmission system (e.g. power lines supported by utility towers).

As indicated in FIGS. 4-7, the UAV/craft is configured to perform missions conducted by travel along flyway FW in terrain that may comprise landmarks such as homes, transportation lines, utility lines, etc. (indicated generally as obstacle or landmark LM). See e.g. FIG. 4. As shown schematically and representationally in FIGS. 5, 6 and 7, UAV/craft can use various on the ground structures and routes/paths such as utility wires W and rail lines and roads and/or water ways for developing routes along which missions are conducted.

As indicated in FIGS. 5, 6 and 7, a system S for administrating and managing UAV/craft may be provided in and along a flyway FW. As shown in FIG. 6, the system for managing and administrating UAV/craft traffic may comprise a detector D (which may further comprise a monitoring system). The flyway for UAV/craft may be configured to facilitate two-way passage of UAV/craft as indicated schematically and representationally. Referring to FIGS. 4 through 7, a flyway arrangement for the system is shown schematically and representationally according to an exemplary embodiment.

According to an exemplary embodiment, as shown schematically in FIGS. 5 through 7, the system S for interaction (e.g. administration/management) for UAV/craft may provide multiple systems and subsystem for interaction with UAV/craft including a monitoring system with a detector D for monitoring with UAV/craft and a payload management system for UAV/craft. See also for example FIGS. 27-30. Referring to FIGS. 1B-1D and 25A-25B and 27-30 and 38, UAV/craft configurations to interface with the system are shown. UAV/craft may be provided with a detector D to interact or provide data to the control system of the UAV/craft. According to an exemplary embodiment, UAV also comprises an identifier ID (e.g. a visual indicator, tag, electronic device, RFID device, transmitter, etc.) presenting information or data communication to facilitate identification of the UAV/craft to a monitoring system. According to an exemplary embodiment a shown schematically, UAV/craft may connect to the system through an apparatus (e.g. system or module) shown as comprising a connector C configured to provide an interface to the system (or a subsystem or network, etc.). See for example FIGS. 1B-1D and 25A-25B.

### UAV/Craft—Identifier/Profile

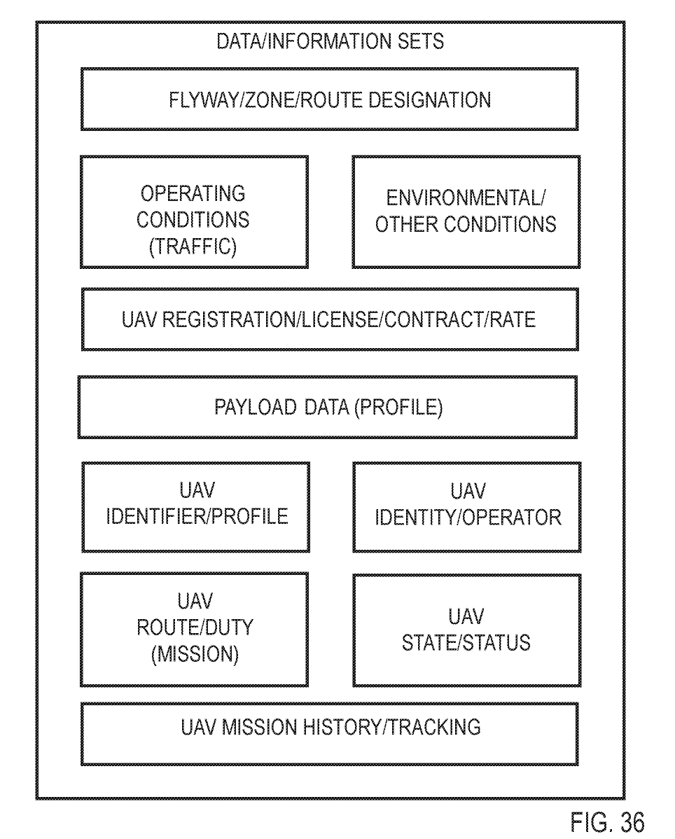

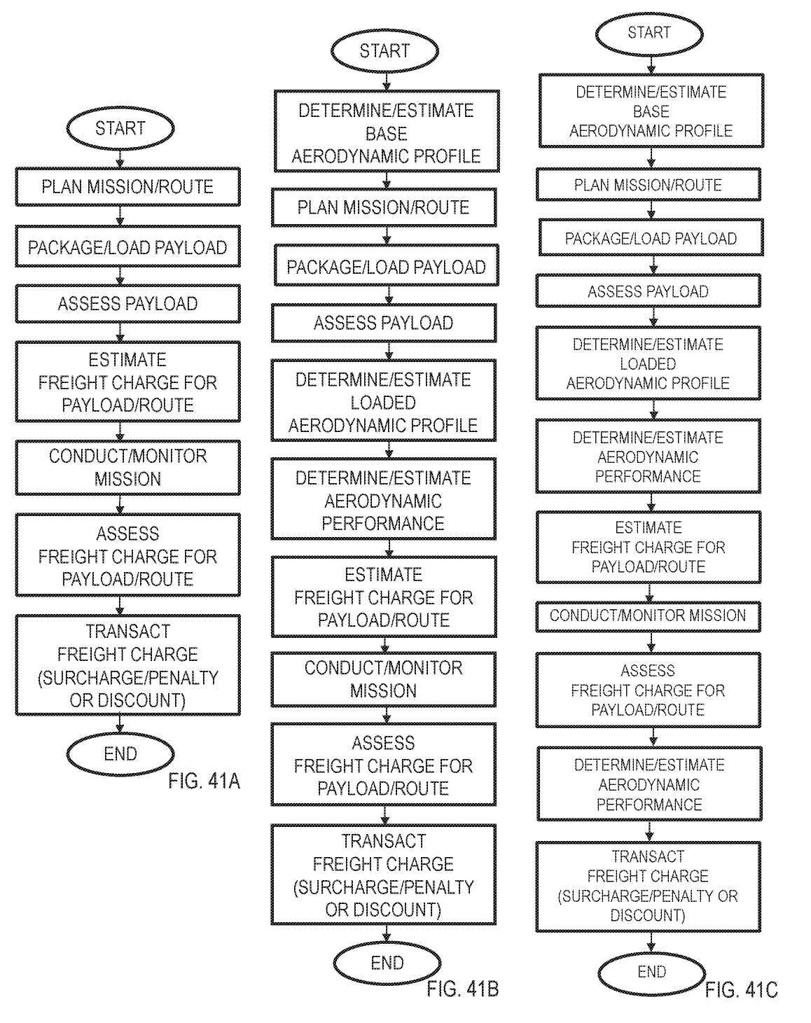

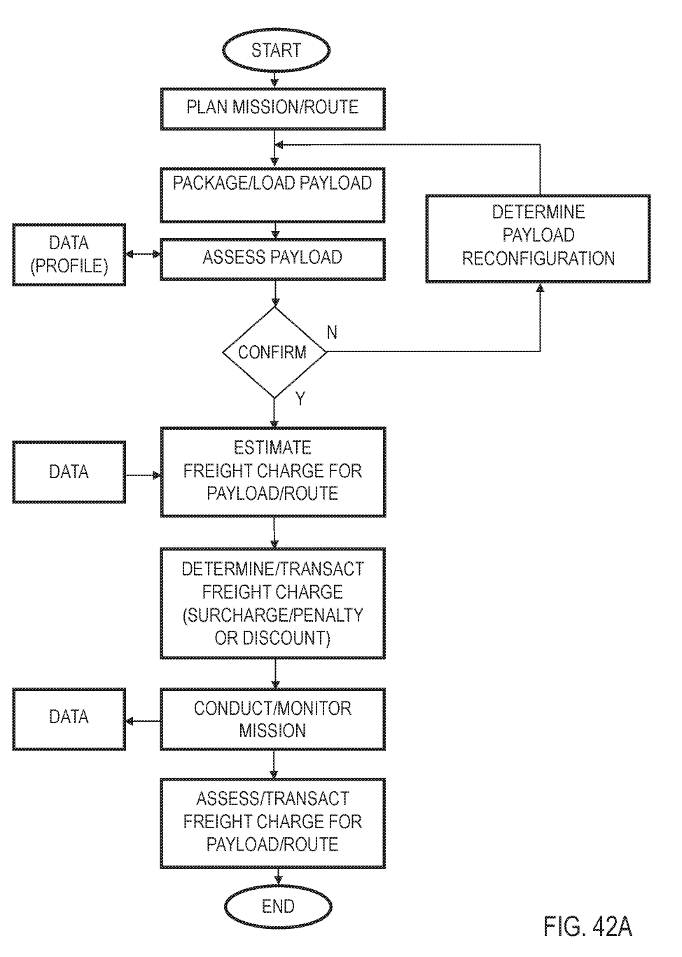

According to an exemplary embodiment, the UAV/craft may comprise an identifier. See for example FIGS. 1B-1D and 26, 27 and 35. See also for example FIGS. 36 and 41B-41C (identifier/profile comprising aerodynamic/other profile data/information). According to an exemplary embodiment, the identifier is on the exterior of the UAV/craft. See for example FIGS. 1B-1D and 26-36. According to an exemplary embodiment, the identifier may comprise a registration identification, a data set, a profile for the UAV/craft, an account for the UAV/craft, a tag for the UAV/craft (e.g. data tag, RFID tag), a transmitter, a license, a marking on the UAV/craft, a license plate on the UAV/craft. See FIGS. 27-30 and 35-38. According to an exemplary embodiment, the identifier is used by the administration system, the management system, the monitoring system, the payload management system, etc. See FIGS. 25A through 38 and 39 through 47. According to an exemplary embodiment, the UAV/craft may comprise a profile (e.g. for interaction with the administration/management system or other systems); the profile may comprise at least one of (a) an identifier for the UAV/craft; (b) an account for the UAV/craft to use with the system; (c) a billing arrangement between the UAV/craft and system; (d) operator identification for the UAV/craft; (e) data for the UAV/craft or for interaction with the system. See for example FIGS. 35-36 and 37-38. According to an exemplary embodiment, the profile may comprise data or a data device/storage used for the UAV/craft to interact (e.g. be monitored, detected, identified, registered, contracted, communicated with, etc.) and transact (e.g. be negotiated with, billed/invoiced, make payment, otherwise be communicated with, etc.) by the system. See for example FIGS. 25A, 27-30, 35-38 (profile data may be associated with the identifier of the device and/or otherwise stored for or with the UAV/craft).

According to an exemplary embodiment, the identifier/profile of the UAV/craft comprises data/information relating to the UAV/craft (e.g. to be accessed by any of a wide variety of arrangements) that can be used by the system and method including for administration and management of UAV/craft (including payload management system).

### Unmanned Aircraft System (UAS)

As indicated schematically, according to an exemplary embodiment UAV/craft may be used/operated according to any of a wide variety of system implementations for interaction with a system and method to administrate/manage UAV/craft; the system and method may be configured to operate with unmanned aircraft systems of a wide variety of types and configurations with UAV/craft of a wide variety of types and configurations (including individual UAV/craft and multiple UAV/craft and/or with various operator arrangements). See for example FIGS. 27-30.

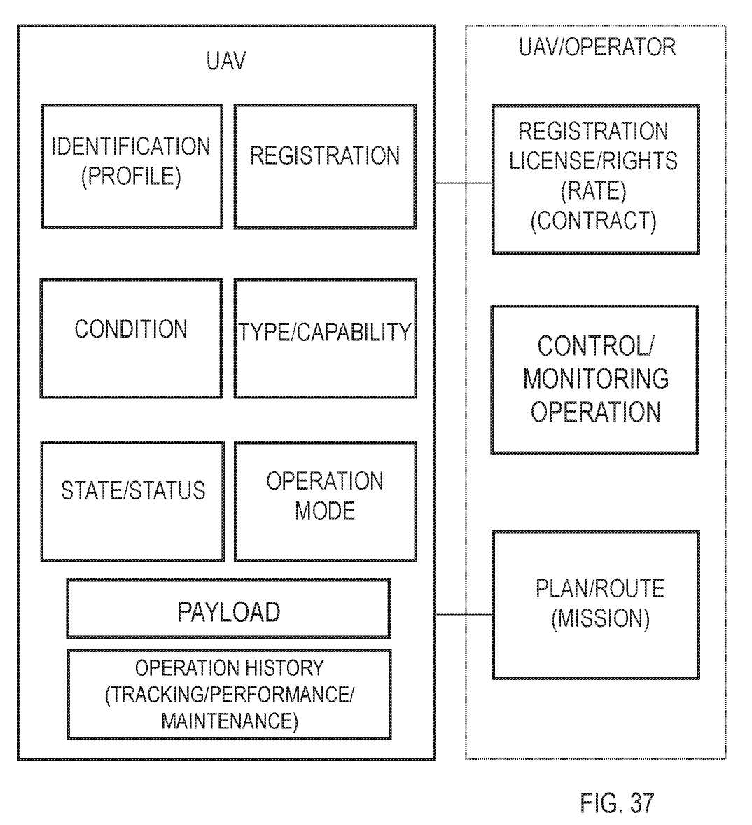

Referring to FIGS. 35-37, as shown schematically and representationally according to an exemplary embodiment, the UAV/craft may comprise a computer-based system configured to interact and transact with the administration/management system (e.g. exchanging, creating, obtaining, monitoring, communicating, maintaining, storing, etc.) data and information. See also FIGS. 27-30. As indicated in FIGS. 35-36, the UAV/craft system may manage data (data sets) relating to identity/registration, license/contract rights, type/configuration, control program, status/condition, telemetry/instrumentation, operational history, communication, operator, payload/payload configuration, etc. as well as to routing/duty/mission, operating conditions, environmental conditions, tracking, flight characteristics, aerodynamic profile/performance, etc. from various data sources (e.g. on the aircraft, from the system/power source, from other systems, etc.). According to an exemplary embodiment, as shown in FIG. 37, the UAV/craft may be managed by an operator or may operate in a generally autonomous (e.g. programmed or directed) manner with configured or configurable license rights/contract (e.g. through an entity) on a route/mission. See also FIGS. 27-30, 38 and 47.

According to an exemplary embodiment, data communications for the payload management system may be established by interface with subsystems such as a monitoring system associated with the system and/or to a management system associated with the system. The system for data communication may comprise at least one of data provided by the identifier or the transmitter on the aircraft; the identifier may comprise a transmitter/device (e.g. active element capable of transmitting a communication with a detector) and/or a visual object (e.g. physical object or marking capable of being perceived by a detector) and/or any other type of object or device (e.g. such as a tag or element that is detectable or readable such as a pass as used for electronic payment of tolls on highways, RFID element, etc.). See for example FIGS. 1B-1D, 25A-25B, 35-38.

Referring to FIGS. 25A-25B, 30, 31, 34-38, as shown schematically and representationally according to an exemplary embodiment, the UAV/craft may comprise a computer-based system (or subsystem) configured to interact and transact with the payload management system by managing (e.g. exchanging, creating, obtaining, monitoring, communicating, maintaining, storing, etc.) data and information relating to the mission and payload (e.g. routing, operating conditions, logistics/scheduling, aerodynamic performance, etc.).

### System Configuration

Referring to FIG. 25A, the system is shown schematically and representationally with UAV/craft and network according to an exemplary embodiment. The system comprises an administrative system or module AS and management system or module MS (e.g. implemented on a computing system); the system is connected to a network (e.g. set of networks including the Internet) and by a data link DL to UAV/craft. As shown schematically and representationally, a UAV/craft may comprise an identifier ID (e.g. data set with information for the UAV/craft) and a propulsion system PS (e.g. system to provide energy/propulsion for the UAV/craft) and a control/computing system CS (e.g. system to operate/control the UAV/craft); UAV/craft may also carry payload P (e.g. payload in any of a variety of configurations and/or segment or segments, see e.g. FIGS. 1B-1D, 2A, 2C, 3A-3F, 8A-8B, 10, 11A-11B, 12A-12B, 13A-13D, 14, 15A-15D, 16A-16B, 17A-17B, 18A-18B, 19, 20, 21A-21B, 22A-22B, 23A-23B and 24). As shown schematically in FIG. 25A, the system and the network and UAV/craft are connected to data sources DS (e.g. sources of data for the UAV/craft). See also FIGS. 27, 28, 30 and 38.

As indicated schematically and representationally in FIG. 25B, the data link DL between the system and UAV/craft may comprise an interface and/or connections C configured for data/communications interchange; as indicated schematically, the data link DL may comprise a wireless datalink (e.g. of any suitable type).

As shown schematically in FIG. 26, the identifier of a UAV/craft may comprise data and information such as a profile; the profile may comprise any of a variety of data sets/information for the UAV/craft (e.g. a base profile, a configured profile for a mission, etc.). See also FIGS. 1B-1D (identifier module on UAV/craft). According to an exemplary embodiment, the profile may comprise a data set with aerodynamic profile for UAV/craft (e.g. without payload, with payload, etc.).

As indicated schematically and representationally in FIG. 27, the system (e.g. including administration/management system AS/MS) may be connected to a variety of other systems and data sources for administration/management of UAV/craft (including UAV/craft carrying payload) to implement the payload management system and method. According to an exemplary embodiment, the system may comprise a payload management system or module configured to process data/information relating to payload to be carried by the UAV/craft (e.g. on a mission comprising delivery of payload by a carrier from an originator to a destination on a route in operating conditions). Data/information for the system (including payload management system) may comprise data/information (e.g. from data sources) of a variety of types and in a variety of forms (including in real time) such as measured (system/meter detected) data, calculated (e.g. predicted/estimated) data, UAV/craft operator reported data relating to payload carried by the UAV/craft, etc. See also FIGS. 36-38. According to an exemplary embodiment, the system AS/MS may be coupled to a variety of other systems/subsystems as indicated schematically including monitoring/detection system NS and tracking system TS and communications system and telemetry system; the system may receive data from network data source DS or other data sources DS; the system may also comprise a registration/identification system for UAV/craft configured to manage registration/administration and identity of UAV/craft and operator (e.g. profile data) and status/condition of UAV/craft and payment/authorization for craft (e.g. according to contract terms, etc.) and to manage license/contract rights and rates (e.g. including freight charge for carrying payload). See also FIGS. 35-37.

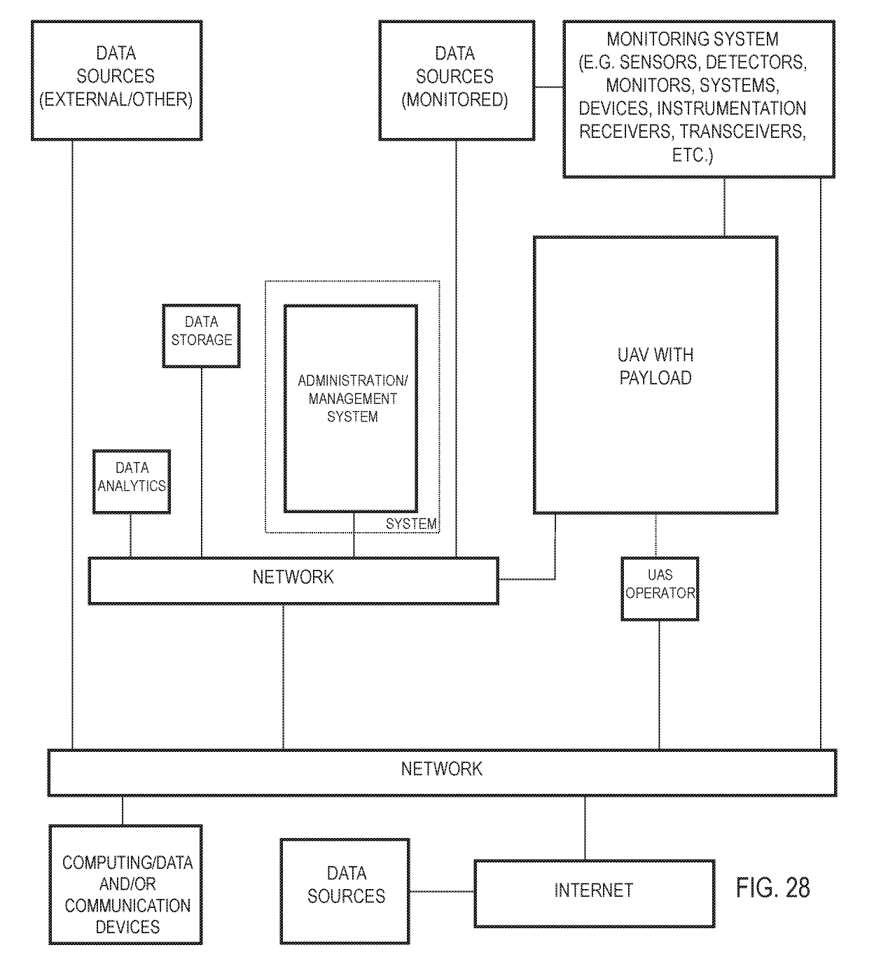

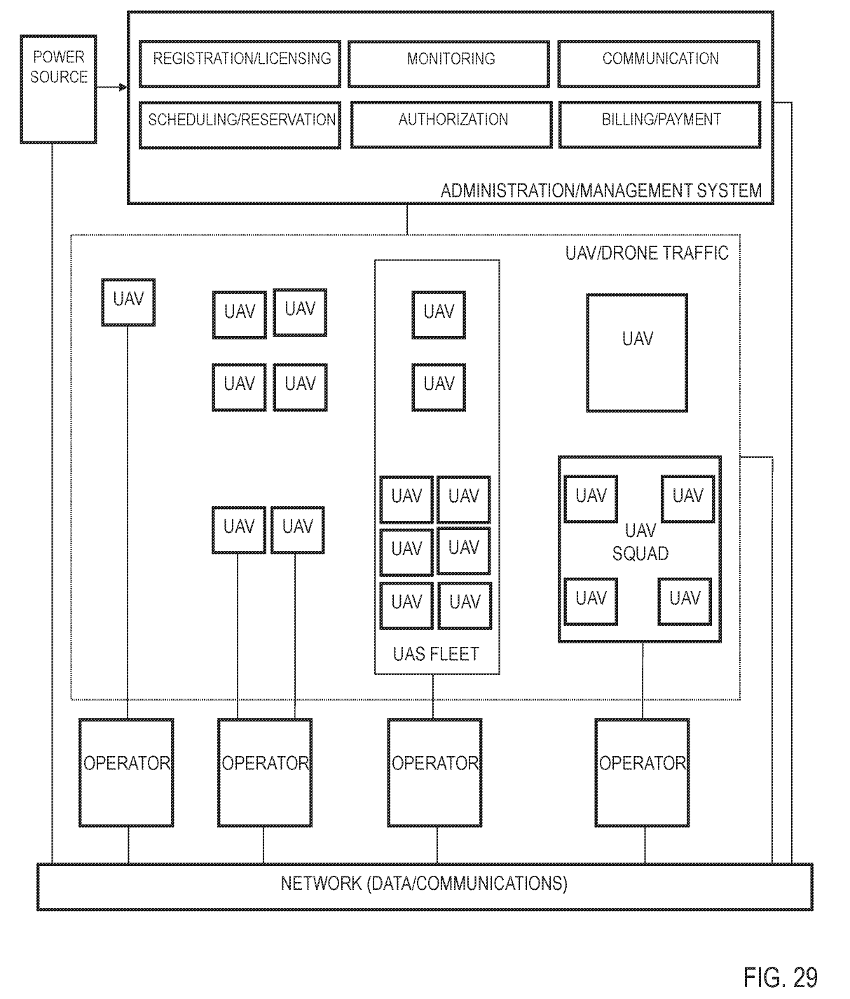

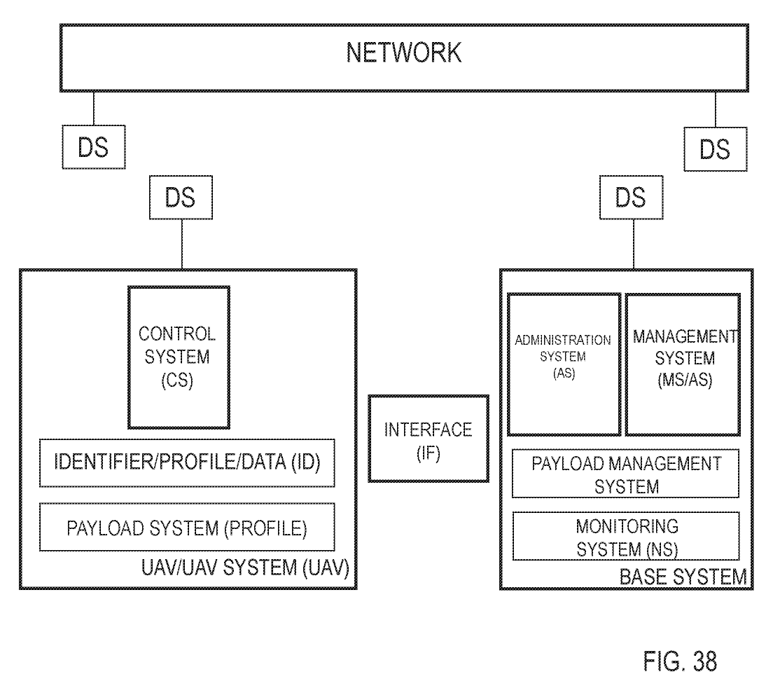

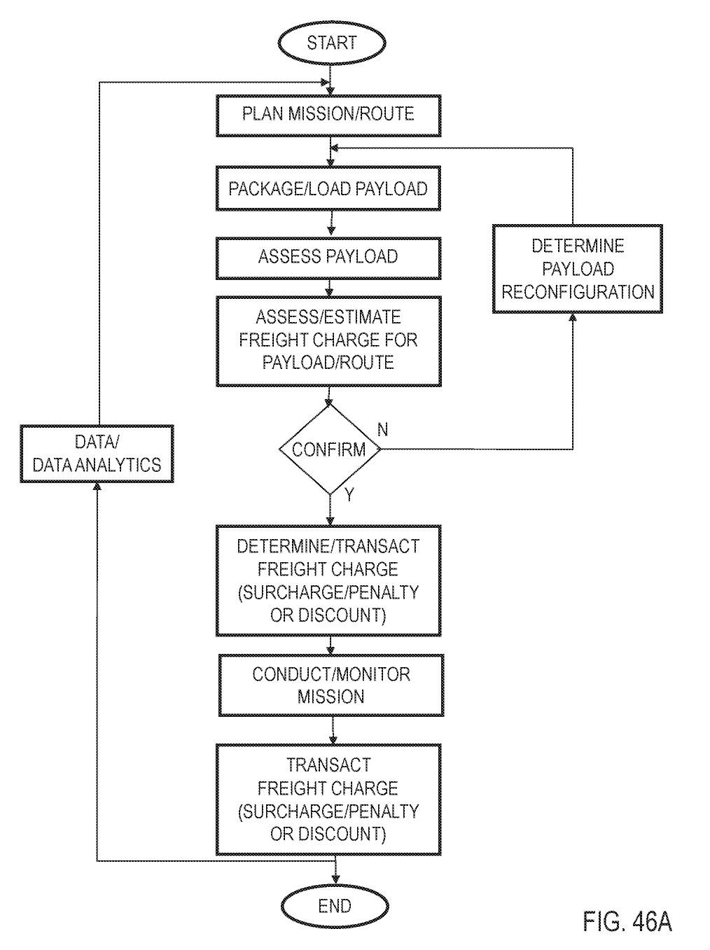

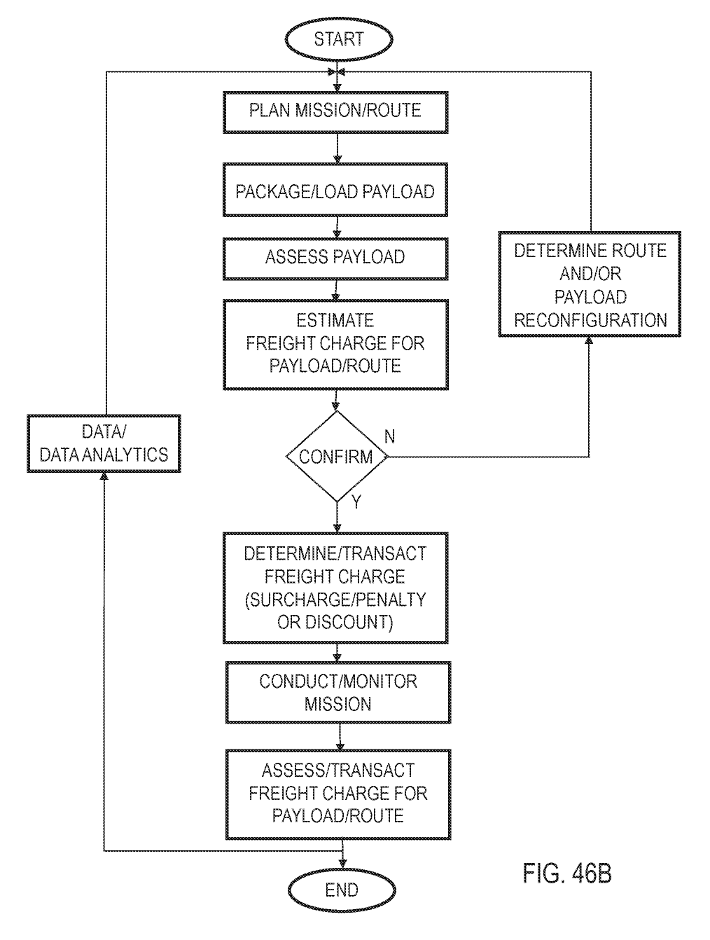

As indicated schematically in FIGS. 28 and 29, the system may be configured to manage and communicate with UAV/craft and on a network and to interchange data/information with data sources (including data collected, recorded, calculated, created, stored, updated, etc. by the system and subsystems). As shown schematically in FIG. 28, the system may comprise a monitoring system (e.g. with sensors, detectors, monitors, systems, devices, instrumentation, receivers, transceivers, etc.) in association with UAV/craft carrying payload (e.g. and operated by an operator); data interchange over the network may comprise connection with the Internet and other data sources as well as other computing/data and communication devices on the network (e.g. computers and mobile devices, etc.). According to an exemplary embodiment, the system (e.g. administration/management system) may be connected to a network (e.g. a secure/local network) with UAV/craft and data sources; the system may also comprise or be connected to data storage (e.g. disk, solid state, etc. or other storage media) and a data analytics system or module. See also FIGS. 46A-46B. Data source may comprise data sources on the network as well as data sources associated with a monitoring system or external/other data sources (including accessible from the Internet). See also FIGS. 25A and 38.

As shown schematically in FIG. 29, UAV/craft (e.g. UAV traffic) of a wide variety of types operating in association with the system may be operated individually (e.g. single craft) or in groups (e.g. in such configurations as squads, fleets, groups, etc.). According to an exemplary embodiment, the system may comprise modules/subsystems for administration/management of a variety of UAV/craft and UAV/craft functions including registration/licensing, scheduling/reservations, monitoring, authorization, communications, billing/payment, etc.; payload management for UAV/craft may be performed by the system using system modules/subsystems. See also FIGS. 34-37.

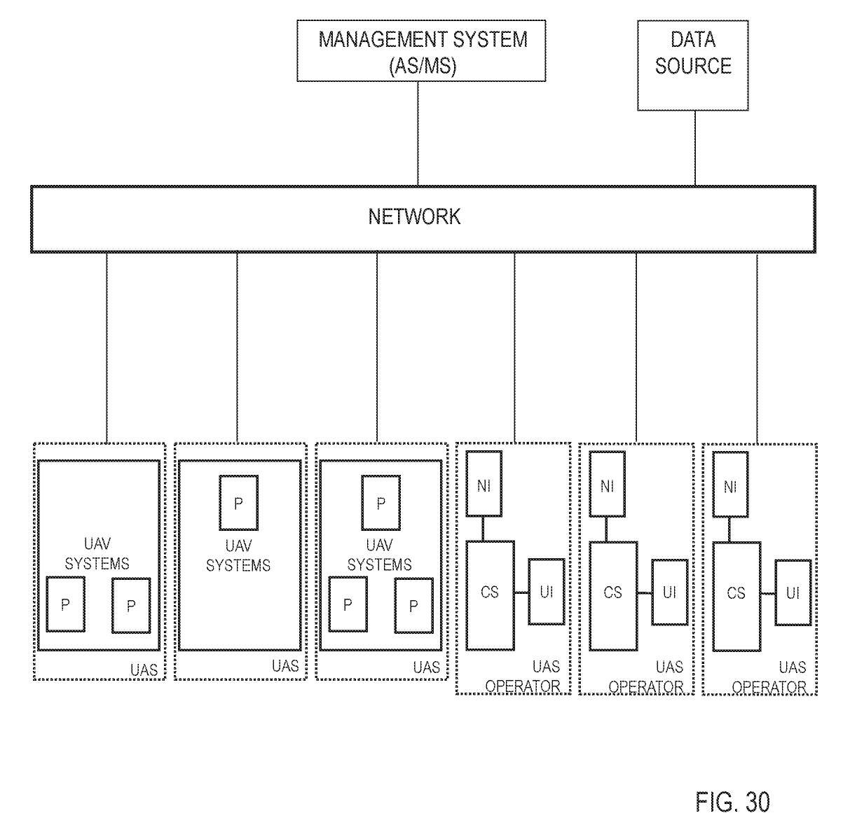

As shown schematically in FIG. 30, the network connection for the system may facilitate a wide variety of data connections to UAV/craft (e.g. UAS) and operators (as well as networks, subsystems, data sources, etc.); as indicated, UAV/craft (e.g. UAS) may comprise any of a variety of payload configurations (e.g. with payload segments P). UAV/UAS operators may employ a computing system CS (e.g. of any suitable type) with a network interface NI (e.g. of any suitable type) and user interface UI (e.g. of any suitable type) for communications with the system and with UAV/craft. See also FIGS. 29 and 37. As indicated schematically and representationally, the UAV/UAS operator may function independently of a carrier/entity operating the payload management system or as an affiliate (e.g. staff); the UAV/UAS operator may operate under direction of a carrier (e.g. entity operating UAV/craft to carry and deliver payload).

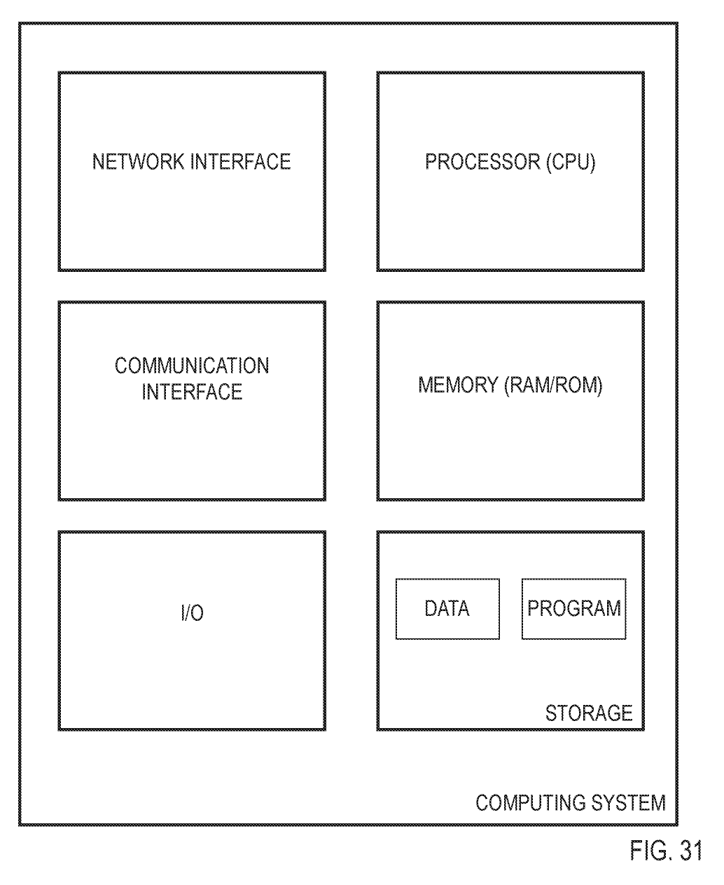

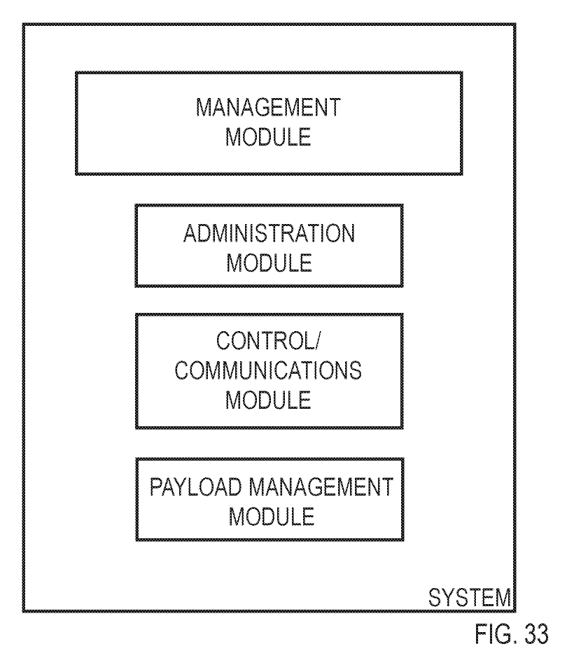

Referring to FIG. 31, a computing system is shown schematically according to an exemplary embodiment; as indicated computing system comprises subsystems/modules (e.g. of a conventional type) that can be configured (e.g. by arrangement of hardware and software such as operating programs) to perform functions of the system. According to an exemplary embodiment, computing system comprises (among other subsystems/modules) a processor (CPU), network interface, communication interface, memory (RAM/ROM), input/output control (I/O) and storage (e.g. for data and programs). According to an exemplary embodiment, the computing system is configured (e.g. with operating programs) and connected (e.g. by network) to function as and perform the operations/processes of the administrative/management system (AS/MS) including payload management system for UAV/craft. See for example FIGS. 39, 40A-40B, 41A-41C, 42A-42B, 43A-43C, 44A-44C, 45A-45B, 46, 47 and 47. According to an exemplary embodiment, the computing system for the system/subsystems may be configured as a special-purpose machine or may be configured to operate on a general-purpose computer to perform the system functions (e.g. with code, programs, operating system, interface, etc.). See also FIGS. 33-38.

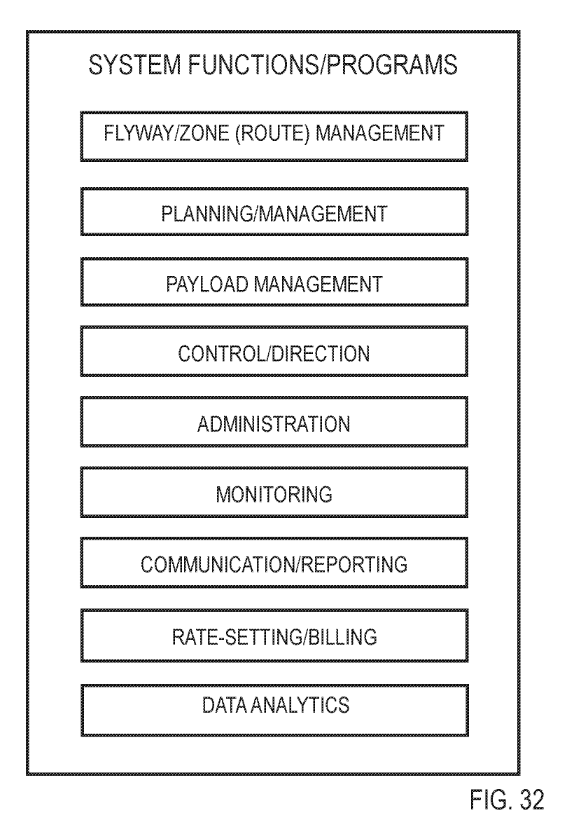

As indicated schematically in FIGS. 32 and 33, the functions and programs (e.g. operating on a computer system) for the administration/management system for UAV/craft may comprise (among other functions) flyway/zone (route) management, planning/management, payload management, control/direction, administration, monitoring, communication/reporting, rate-setting/billing (e.g. for transacting freight charge, surcharge, penalty, etc.), data analytics (e.g. for collecting and analyzing data relating to operation, etc.), etc. As indicated schematically in FIG. 33, the system to facilitate interaction with UAV/craft may comprise operating modules (e.g. program/data organization) including (but not limited to) a management module, administration module, control/communications module (including monitoring) and a payload management module. According to an exemplary embodiment shown schematically in FIG. 34, the system to facilitate interaction with UAV/craft may be configured with a computing system and operational modules (e.g. with hardware/software) for monitoring/communications, for administration/management, for payload management and for billing/payment (e.g. transactions). As indicated according to an exemplary embodiment, the system may be configured to estimate/determine and assess/transact a charge for use of UAV/craft carrying payload on a mission from originator to destination (e.g. freight charge, surcharge, etc.). See FIGS. 39-47.

As shown schematically according to an exemplary embodiment in FIG. 35, the UAV/craft (e.g. drone/UAS) system may comprise a set of subsystems/modules for operation of the UAV/craft and interaction with the administration/management system and other systems/subsystems to perform on missions and other service/duty. See also FIGS. 4, 5, 6, 7 and 28-30. According to an exemplary embodiment, the UAV/craft subsystems/modules may be provide for functions including identity/registration (e.g. for UAV/craft, missions) including of profile, for license/rights (e.g. contracting), type/configuration, control/management, status/condition (e.g. of UAV/craft and operating conditions), data/telemetry (e.g. from instrumentation and other systems/subsystems), operation history (e.g. tracking, performance, maintenance, etc.), communications (e.g. for UAV/craft, with operator, etc.) and payload and payload management (e.g. interacting with UAV/craft system to obtain data/information and determine and assess effects and charges for payload configuration/capability and carrying/delivery, etc.). See also FIGS. 5-7 and 27-29.

As shown schematically in FIG. 36, the UAV/craft may use and provide/maintain data and information sets for operation and interaction with the management system and other systems including flyway/zone/route designation, operating conditions (including traffic, etc.), environmental/other conditions (including weather, etc.), UAV/craft registration and licensing (e.g. contract terms, rates, charges, etc.) for transactions, payload data (e.g. including type, load, destination, type, effects, profile, characteristics, etc.), UAV/craft identifier and profile, UAV/craft identity and operator, UAV/craft route and duty (e.g. mission information, etc.), UAV/craft state and status and UAV/craft mission history and tracking (e.g. data and information from operation). See also FIGS. 1B-1D, 7, 25A and 26.

As shown schematically in FIG. 37, according to an exemplary embodiment the UAV/craft will be configured for interaction with the management system and other systems/subsystems in operation under the direction of an operator; as indicated, the operator will register and establish rights and rates (e.g. by contract) for the UAV/craft to perform the mission, plan and route the mission (e.g. to perform the duty such as payload delivery), manage/control and monitor operation of the UAV/craft and maintain and use associated data and information (including data interchange with the UAV/craft and other systems such as the management system for UAV/craft). As indicated schematically in FIG. 37, the UAV/craft will maintain and use associate data and information (including data interchange with the operator and other system such as the management system for UAV/craft) for operation including identification (e.g. profile), registration, condition, type/capability, state and status, operation mode (e.g. carrying payload, available for duty, etc.), payload (e.g. related information as to payload carried or to be carried or delivered), operation history (e.g. tracking, performance, maintenance, schedule, etc.), etc. See also FIGS. 1B-1D, 29, 35-36. As indicated, according to an exemplary embodiment the UAV/craft and UAV operator are configured to interchange data with the management system before and during and after operation of the UAV/craft on a mission (e.g. by data link, interface, connector, etc.). See e.g. FIGS. 1B-1D, 25A-25B and 26.

Referring to FIG. 38, the system (indicated as base system) with subsystems including administration system as and management system MS and monitoring system NS and the payload management system with connectivity to a network (or set of networks) and a UAV/craft system by an interface IF is shown schematically according to an exemplary embodiment. As indicated schematically, the UAV/craft system (indicated as UAV) comprises subsystems including a control system CS and (or with or connected to) the payload management system (e.g. to manage and interact/monitor payload on the UAV/craft) along with an identifier/profile ID (e.g. data set). According to an exemplary embodiment, the base system and UAV/craft system and network are connected and interconnected to data sources DS (e.g. internal data sources, external data source, network storage, instrumentation/sensors, internet, etc.). See also FIGS. 5, 6, 7, 25A, 27, 28, 29 and 30.

### Administration/Management System

As shown schematically and representationally in the FIGURES, according to an exemplary embodiment, an administration/management system (AS/MS) for UAV/craft is provided to interact with UAV/craft and to implement system functions including but not limited to the payload management system. See for example FIGS. 27-30 and 39-47. (As indicated schematically, the system and method may be configured to interact and operate with UAS and UAV/craft according to a wide variety of arrangements.)

According to an exemplary embodiment, the system provides an administration system. See for example FIG. 27. According to an exemplary embodiment, the administration system provides administration for system and UAV/craft performed by an administration system. According to an exemplary embodiment, administration may comprise administration of the interface, administration of the aircraft, administration of coupling the aircraft to the system, administration of the system, administration of a transaction with the aircraft.

Referring to FIGS. 27-30, system and subsystem configurations and arrangements for a system to administrate and manage UAV/craft are shown schematically and representationally according to an exemplary embodiment.

Referring to FIGS. 27-30, the system may provide or comprise an administration system (AS), management system (MS) and monitoring system (NS) with detector/detector system (D) as shown schematically and representationally. The UAV/craft as shown schematically and representationally according to an exemplary embodiment, may comprise a propulsion system PR and energy storage system ES with control system UCS and identifier system ID and monitoring system NS/detector system D. See FIGS. 25A-38. As also shown schematically and representationally, according to an exemplary embodiment is a network (e.g. which may comprise multiple networks) and data storage/sources DS on the network as well as associated with the system and with the UAV/craft. See FIGS. 25A, 27-30 and 38. As indicated schematically, the system and UAV/craft can be configured to share information by data communications over the network system or by other types of data link. See for example FIGS. 25A-38. According to an exemplary embodiment, the system and aircraft can be adapted to facilitate the management of aircraft by implementation of technology and components for management, administration, payload management, data communication, monitoring and detection, interfacing, interactions, transactions according to the various inventive concepts, systems and methods. See FIGS. 25A-38 and 39-47.

As shown schematically and representationally according to an exemplary embodiment, a UAV/craft may be configured to provide a control system CS with propulsion system and energy storage/system (e.g. in a base or body) with a connector C that can be deployed or otherwise used to establish the interface IF (e.g. data link DL with the system). See also FIGS. 25A-25B and 38.

Referring to FIGS. 28A through 38, according to an exemplary embodiment the system and subsystems for management and operation of UAV may be configured to share and communicate data/information.

According to an exemplary embodiment, administration for UAV/craft comprise administration of at least one of (a) identification of the aircraft; (b) registration of the aircraft; (c) reservation of charging by the aircraft; (d) authorization of the aircraft; (e) licensing of the aircraft; (f) directing of the aircraft; (g) positioning of the aircraft; (h) transacting of the aircraft; (i) policing the airspace.

According to an exemplary embodiment, as the indicated administration system is configured to send a request for identification to the aircraft. According to an exemplary embodiment, the administration system is configured to use data from the monitoring system to identify the aircraft. See for example FIGS. 1B-1D and 26.

Administration for the power source may comprise administration of coupling the aircraft to the system, administration of the payload management system and administration of a transaction with the aircraft. Administration of a transaction with the aircraft (e.g. operator of the aircraft) may be performed by the administration system. Administration may comprise administration of the interface between the UAV/craft and the system. According to an exemplary embodiment as shown schematically and representationally, the administration system may be implemented by a computing system (e.g. accessible on a network). See for example FIGS. 27-31.

Management for the system may be performed by a management system. See for example FIGS. 27-30. Management may comprise management of the connectivity of the aircraft to the system. According to an exemplary embodiment, the management system is accessible on a network and/or provided at an apparatus or system along a flyway. See for example FIGS. 5-8.

According to an exemplary embodiment, management of an aircraft is performed by the management system. According to an exemplary embodiment, management may comprise management of at least one of (a) interacting with the aircraft; (b) monitoring the aircraft; (c) rate-setting for payment by the aircraft; (d) charging an amount to be paid by the aircraft for power; (e) contracting with the aircraft; (f) transacting with the aircraft; (g) billing the aircraft by providing an invoice; (h) reporting data to the aircraft; (i) providing a receipt.

According to an exemplary embodiment, management may comprise management of the interface and/or of a transaction with the UAV/craft. See for example FIGS. 27-30, 38 and 39-47. Management of the payload management system may be performed by a management system. According to an exemplary embodiment, management for the of the payload management system may comprise management of the UAV/craft carrying payload. See for example FIGS. 37-38 and 39-47.

According to an exemplary embodiment as shown schematically and representationally, the management system may be implemented by a computing system (e.g. accessible on a network). See for example FIGS. 27-30 and 31.

According to an exemplary embodiment, the administration system is configured to interact with a UAV/craft and the management system is configured to process data and transact with the UAV/craft including for payload management (e.g. to implement system functionality). See FIGS. 25A, 27-30, 38 and 39-47.

According to an exemplary embodiment, the system can be implemented as shown schematically and representationally. As indicated in FIGS. 25A and 38, the system can be provided so that the administration/management system (DS/MS) is provided data from a monitoring system/data sources that can comprise detection, tracking, communication, telemetry as well as network data and other data (see also FIGS. 27-30); the UAV/craft may provide data to the system (including license/contract information, identity/profile, status/condition, payment/authorization, etc.). See also FIGS. 34-38. As also indicated in FIG. 28, according to an exemplary embodiment the system is configured to monitor UAV/craft at the interface (e.g. by measure/metered and/or calculated/estimated and/or reported data). As indicated in FIGS. 39-47, according to an exemplary embodiment the system is configured to interact and transact with a variety of UAV/craft and to share and/or exchange data from and with data sources including over a network (such as the internet); data operations including data storage and data analytics may be provided by the system. See also FIGS. 27, 38 and 44A-47.

Referring to FIGS. 39-47, the method that can be implemented and operated for the system according to an exemplary embodiment is shown schematically and representationally according to an exemplary embodiment (e.g. in simplified and general form). As indicated, according to an exemplary embodiment the system uses data available from data sources (see for example FIGS. 25A and 38).

Referring to FIG. 25A, according to an exemplary embodiment the system facilitates an interaction with the UAV by providing for an interface at which the payload for UAV/craft can be loaded and configured; the system may be configured to perform a transaction with the UAV in which payment for payload that has been carried by the UAV; as indicated data is shared and exchanged with various data sources (see also FIGS. 25A, 27-30 and 38) to complete the interaction and transaction for the UAV and originator entity or destination entity for the payload.

Before or during the interaction the rate or fee to be charged for the UAV carrying payload determined; communications are made to the UAV to facilitate the enablement and approval of the UAV to carry and deliver the payload. Upon completion of delivery a payment transaction is completed (e.g. entity is billed for charge for use of UAV); a payment communication is established (e.g. transmitting a bill or invoice for payment and/or receipt for payment) in order to complete the transaction.

According to an exemplary embodiment, an entity may register or contract with the payload management system to carry payload at a present or future time; the entity may reserve or request a particular time or place (e.g. charge location) for delivery; the system will approve and designate a UAV a to carry the payload (e.g. and to require registration, identification, payment, etc.). As indicated, the entity may obtain a general approval for payload delivery by a UAV at a variety of places or times or may reserve a specific time and place for payload delivery by a UAV. A rate and fee from the UAV will be determined and communicated to the entity to enable (with approval) the UAV to charge for payload delivery. A billing/payment transaction will be conducted upon completion of payload delivery with a communication to the entity (e.g. invoice/receipt for payment for payload delivery to the UAV).

According to an exemplary embodiment, the system or UAV or entity may initiate or exchange communication. If the entity is identified to the system, the system may determine whether the entity is registered (e.g. in good standing with an account or credit to transact) instructions may be provided and exchanged by communications between the system and entity and authorization to charge will be established; monitoring will continuing as to the time and and delivery. According to an exemplary embodiment, the UAV (with payload for the entity) may be monitored by any of a wide variety of means including metering/measurement, instrumentation, estimation calculation, electronic circuit/system, time monitoring, data measurement, reporting from the UAV/operator and/or redundant/verification methods. See for example FIGS. 27-30 and 38.

As indicated in FIGS. 39-47, the entity (e.g. originator, destination, etc.) may register at the start of a mission. The system may report or verify the location to the entity and the entity may accept and select a delivery location and transaction terms (e.g. contract terms under an existing short-term or long-term contract or spot contracting/agreement at the time of loading or delivery of payload). According to an exemplary embodiment, an operator of a fleet of UAVs may contract with the system to carry and deliver payload, see for example FIGS. 27-30. As indicated, transaction terms may be based on a number of considerations including aerodynamic profile, effects and cost for energy, time of delivery, location, time of day/day of week, priority, etc. At completion of loading or delivery, the system may execute with the entity a transaction including billing and payment. The UAV will carry out the mission with completion of delivery. As indicated, according to an exemplary embodiment the system can be configured to use data available from data sources to monitor and track and manage and confirm delivery of payload for the entity.

According to an exemplary embodiment, a communication is established with the payload management system to confirm billing/invoice for payment by or on behalf of the UAV (e.g. to complete and communicate the transaction).

According to other exemplary embodiments, other implementations of the system and method of payload management for a UAV can be implemented.

### Data Communications

According to an exemplary embodiment as shown schematically and representationally, the system is configured for data communications between the system and entity and aircraft (e.g. the administration/management system and monitoring system share data with the entity and aircraft).

According to an exemplary embodiment, data communications with the entity and payload management system may comprise at least one of (a) interaction between the UAV/craft and the system; (b) detection of the UAV/craft by the monitoring system; (c) transaction between the UAV/craft and the management system. See for example FIGS. 27-30 and 39-47. According to an exemplary embodiment, the system for data communications may comprise at least one of (a) a data link; (b) a wireless data link; (c) a data link to an operator of the UAV/craft remote from the UAV/craft; (d) a data link between multiple UAV/craft; (e) a data link to the entity (e.g. over the network); (f) a transaction with the entity and management system; (g) registration of an entity or UAV/craft with the system; (h) approval or denial of a request by the entity for payload delivery; (i) information relating to rates/charges for payload delivery (including profiles, unit reference points and factors); (j) information relating to availability of UAV/craft for payload delivery.

According to an exemplary embodiment, the interaction with the system may comprise transmitting a report, transmitting a receipt, transmitting an invoice, billing, etc. See for example FIGS. 39-47. According to an exemplary embodiment, data communications may comprise a transaction; the transaction may comprise billing for the UAV/craft, payment, an interaction. According to an exemplary embodiment, the data communication may be by wireless data transfer. See FIGS. 25A-25B and 37-30.

Data communication may be over a network (e.g. by Wi-Fi). According to an exemplary embodiment, data communication comprises at least one of (a) an interaction between the entity and the system; (b) detection of the aircraft by a monitoring system; (c) transaction between the entity and the system; (d) a communication by the aircraft to the system; (e) a communication by the system to the aircraft; (f) a communication between the system and an operator of the aircraft; (g) data transfer with a data source; (h) data transfer and/or transaction with the system and entity. See for example FIGS. 27-30. According to an exemplary embodiment, information used by the system comprises information transferred over a network. See for example FIGS. 27-30.

### Computing System/Data Sources

According to an exemplary embodiment, the aircraft system may comprise a computing system, a computing device and a network connection (e.g. to data sources and computing systems). See e.g. FIGS. 1B-1D, 25A-25B, 26, 27, 28, 29, 30, 36, 38, 42A, 43A-43C, 45A-45B, 46A-46B and 47. According to an exemplary embodiment, the data sources are available on the network; the network may comprise the internet; the network may comprise access to the data sources. The data sources comprise data internal to the aircraft system and data external to the aircraft system. See e.g. FIGS. 1B-1D, 25A-25B, 27 and 38.

The aircraft system may comprise instrumentation. Instrumentation may be coupled to the payload; instrumentation may be connected to the network. The aircraft system may be configured to calculate aerodynamic profile. Instrumentation may be configured to provide data to a data source; instrumentation may provide data to the aircraft system to determine aerodynamic profile; flight characteristics may be used to determine aerodynamic profile. See e.g. FIGS. 1B-1D, 15D, 24, 26 and 47. Data and measurements may be used to determine aerodynamic profile. According to an exemplary embodiment, with use of data from data sources the aircraft system may be configured to determine drag effect to plan a route for the mission; the aircraft system may be configured to use aerodynamic profile to determine a route for the mission, to assess freight charge after the mission and to assess freight charge before the mission. See also FIGS. 46A and 46B.

According to an exemplary embodiment, the system may comprise a computing system and data storage on the aircraft and/or remote from the aircraft. See e.g. FIGS. 25A, 27, 28, 29, 30 and 38. According to an exemplary embodiment, with use of data from data sources the system is connected to a network; the network may comprise the internet. The system may be connected to data sources; data sources comprise internal data sources; data sources comprise external data sources. See e.g. FIGS. 1B-1D, 25A-25B, 26, 27, 28, 29, 30, 36, 38, 42A, 43A-43C, 45A-45B, 46A-46B and 47.

According to an exemplary embodiment, the administration system, the monitoring system, and the management system share data and data sources. According to an exemplary embodiment, the management system and entity and the UAV/craft share data sources. According to an exemplary embodiment, data sources may comprise data stored on the UAV/craft and/or data available on a network or at the system. The network may comprise a private network for UAV/craft and/or for operators of UAV/craft; the network may comprise the internet. See for example FIGS. 25A, 30 and 38.

Data sources may comprise a network, the aircraft, the internet, an operator of the aircraft, a computing system, data storage. According to an exemplary embodiment, the data may comprise identification of the aircraft, aerodynamic performance by the aircraft, etc. to facilitate an interaction or transaction between the system and the entity. See for example FIGS. 39, 45A-45B, 46A-46B and 47.

According to an exemplary embodiment, the data source (DS) comprises at least one of (a) data stored by the system, (b) data from the aircraft, or (c) data from a remote entity.

### UAV/Craft—Control/Computing Systems

According to an exemplary embodiment as shown representationally and schematically in FIGS. 27-30 and 31-34, the system and method can be implemented using a computing system programmed or otherwise configured to manage the operations, functions and associated data/network communications. Referring to FIGS. 27-30 according to an exemplary embodiment shown representationally and schematically, a control system is provided to manage, configure and operate the UAV/craft.

Referring to FIG. 31, a computing system is shown schematically according to an exemplary embodiment, to comprise a processor and memory/storage for data/programs as well as network/communication interfaces and input/output (I/O) system (e.g. allowing interaction through a user interface, etc.).

As shown schematically according to an exemplary embodiment in FIGS. 35-37, the UAV/craft system comprises multiple functional subsystems (which may be independent or combined in implementation) including a master control system, monitoring/communication system, flight/operation control system, configuration control system, energy/power control system (and other associated subsystems).

As shown schematically according to an exemplary embodiment in FIGS. 32-34, functional modules may be associated with a computing system to manage and operate the UAV/craft, including for the management systems, administration, status/condition monitoring, mission control, configuration management, etc.

Systems/modules (e.g. individually and/or collectively) for control, operation, management, administration, data/networking, communications, telemetry, payload management, power, energy, configuration, monitoring, etc. that may be installed on or associated with the UAV/craft according to an exemplary embodiment are indicated representationally and schematically in FIGS. 32-34.

As shown schematically according to an exemplary embodiment in FIGS. 35-37, UAV/craft status monitoring comprises management of the configuration and mission (e.g. plan/route) for the UAV/craft as well as monitoring of configuration options, conditions (e.g. operating conditions), capability/mode of operation, state/status of systems, etc.; monitoring may comprise tracking of operation history (e.g. data available to assess status/state of health/operating condition such as to facilitate predictive/advance identification of potential system issues, e.g. rotor failures/malfunctions, etc.).

As shown schematically according to an exemplary embodiment in FIGS. 27-30, data and data management for the system and method may comprise collection/monitoring and use of data from a variety of data sources (e.g. internal/network or external/internet/etc.) related to a variety of UAV/craft systems and functions, including conditions, UAV profile, configuration, status, instrumentation, energy/power systems, etc.

### Payload Management System/Aircraft System

According to an exemplary embodiment shown schematically and representationally, a payload management system for the UAV/craft system is configured to assess and use data/information relating to payload to be carried on mission comprising delivery of payload/payload segments from originator to destination on a route in operating conditions and to determine freight charge for use of the UAV/craft system. See e.g. FIGS. 28, 29, 30, 32-37 and 39-47. As shown schematically and representationally, the UAV/craft (e.g. unmanned aircraft) system provides an aircraft configured to carry a payload with an aerodynamically-exposed portion on a mission from an originator by a carrier to a destination in operating conditions. See e.g. FIGS. 24, 25A, 28-30. The system may comprise an aerodynamic profile determined for the aircraft with and without the payload; the aerodynamic profile for the aircraft may comprise consideration of an effect of the payload on the flight characteristics of the aircraft. See e.g. FIGS. 24 and 26. The freight charge for carrying the payload as freight on the mission to the destination is based on considerations including the aerodynamic profile of the aircraft with the payload. See e.g. FIGS. 39 and 47. According to an exemplary embodiment, the payload management system may also comprise connection to data sources for the system to determine the aerodynamic profile (among other data). See e.g. FIGS. 25A, 30, 38, 40A-40B, 42A-42B, 43A-43C and 47.

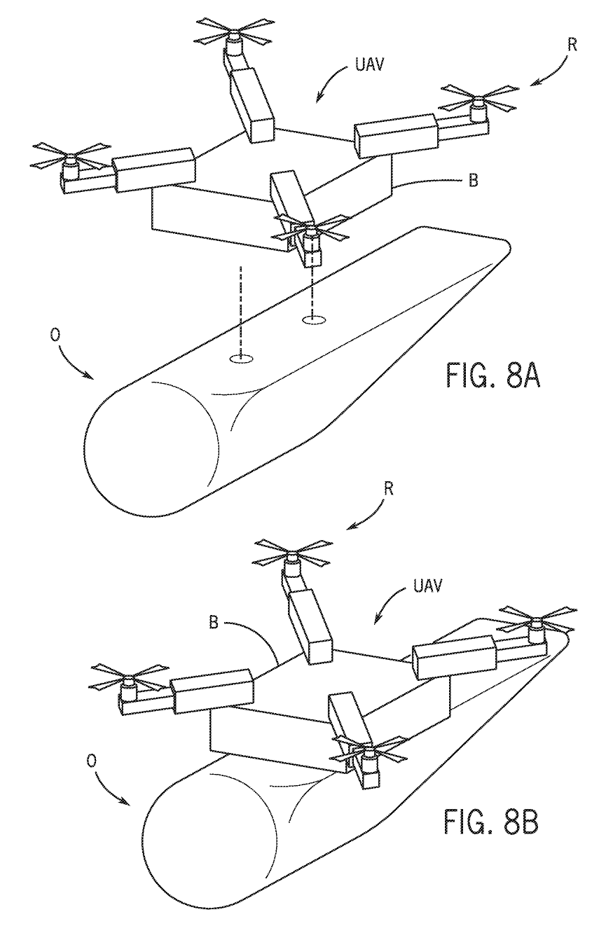

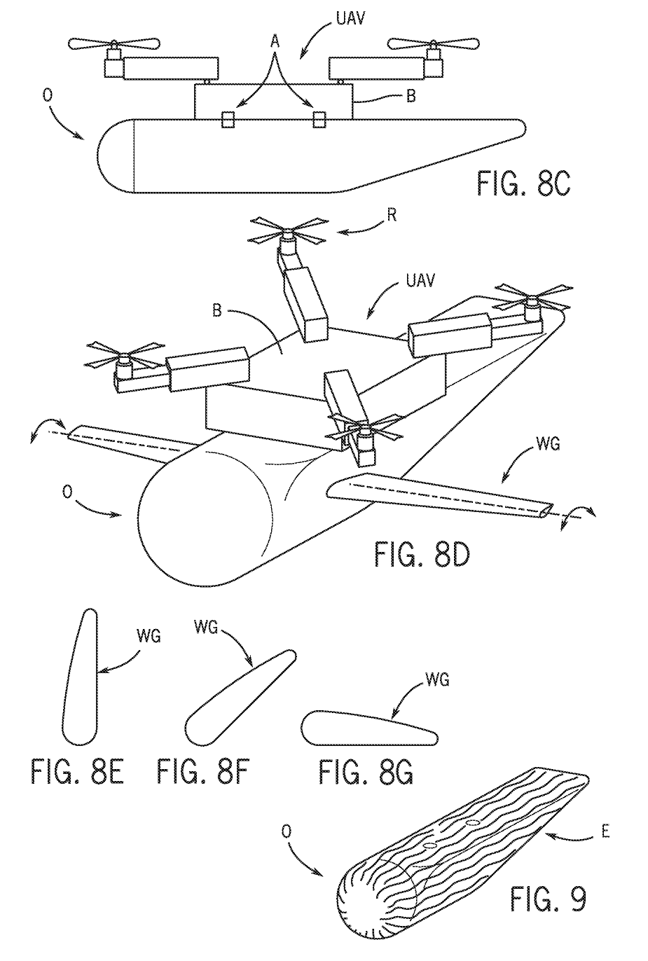

According to an exemplary embodiment, the aircraft may be provided in a variety of configurations that provide variations of aerodynamic profile and flight (characteristics) and flight characteristics (and other data/information) for the system (as well as variations in payload carrying arrangements). See e.g. FIGS. 1C, 1D, 2A-2B, 2C-2D, 3A-3F, 8A-8D, 10, 11A-11B, 12B, 13C, 15C-15D, 16A-16B, 17A-17B, 18A-18B, 19, 20, 21A-21B, 22A-22B, 23A-23B, 24. For example, the UAV/craft (e.g. aircraft) may comprise a base and lift surfaces connected to the base; the aircraft may comprise a rotor system attached to the base. See e.g. FIGS. 1C, 2B, 8D. The lift surfaces may comprise wings; the lift surfaces may comprise airfoils. See e.g. FIGS. 8D-8F. The aircraft may comprise a helicopter with a rotor system. See e.g. FIG. 1C. The rotor system may comprise at least two rotors; the rotor system may comprise at least four rotors. See e.g. FIGS. 1C and 2A. According to an exemplary embodiment, the type and configuration of the UAV/craft is a consideration for the system to determine aerodynamic effects/performance and profile. See FIG. 47.

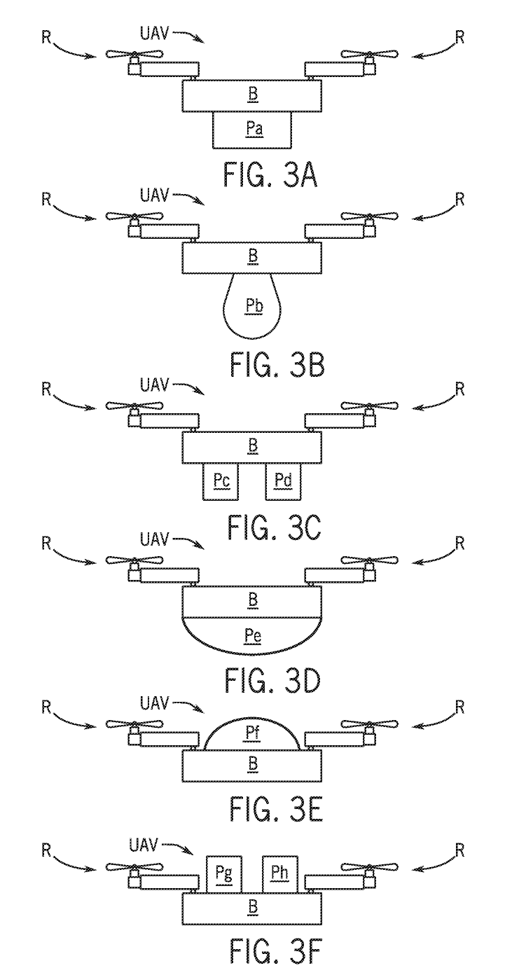

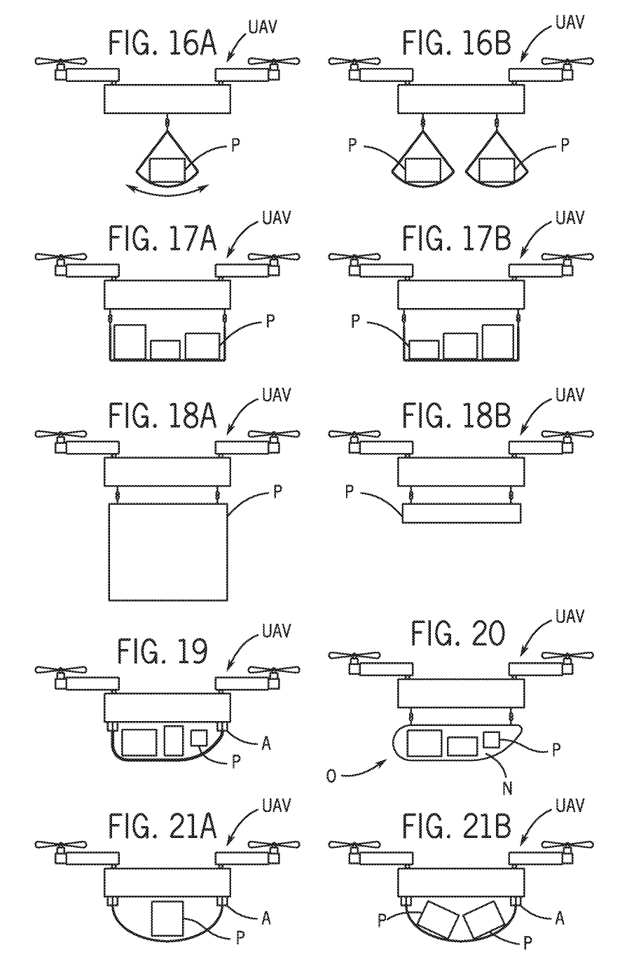

According to an exemplary embodiment, the aircraft carries the payload externally to a base of the aircraft (e.g. aerodynamically exposed). See e.g. FIG. 24. The aircraft may carry a portion of the payload inside a base of the aircraft. According to an exemplary embodiment, the aircraft may carry a portion of the payload inside a container; the aircraft may carry a portion of the payload inside a pod. See e.g. FIGS. 2B, 2D, 8A-9, 10, 11A-11B, 12A-12B, 13A-13D, 15C-15D, 22B and 24. The container or pod may comprise the aerodynamically-exposed portion. See e.g. FIGS. 15 and 24. The aerodynamically-exposed portion of the payload may comprise a pod attached to the base of the aircraft, at least one payload segment may be attached under the aircraft or on top of the aircraft; payload may be carried under the aircraft and/or carried on top of the aircraft. See e.g. FIGS. 3A-3F. The payload may comprise one payload segment or multiple payload segments. See e.g. FIGS. 3A-3F, 16A-16B, 23A-23B. According to an exemplary embodiment shown schematically and representationally, position of a payload segment may be adjusted relative to position of other payload segments; the payload may be positioned to reduce the drag coefficient; the payload segments are positioned to minimize drag effect. See e.g. FIGS. 2A-2B, 2C-2D, 17A-17B and 24. According to an exemplary embodiment, the configuration of the payload (e.g. pod/container, module, etc.) on the UAV/craft is a consideration for the system to determine aerodynamic effect/performance and profile. See FIG. 47.

According to an exemplary embodiment, the payload may be externally attached to the aircraft; the payload may be carried in a sling attached to the aircraft; the payload may be attached to the base of the aircraft; the payload may be attached to an upper surface of the aircraft. See e.g. FIGS. 3A-3F. According to an exemplary embodiment, the payload can be attached (e.g. latched to the exterior of the aircraft) and/or mounted on a sling and suspended on a sling. See e.g. FIGS. 16A-16B. The payload may oscillate relative to the aircraft and may produce aerodynamic torque effect in flight on the mission. See e.g. FIGS. 16A and 23A.

According to an exemplary embodiment, the payload position may be configured, reconfigured and/or adjusted for the mission; the payload position may be adjusted to reduce movement, modify aerodynamic torque effect, reduce oscillation and modify aerodynamic torque effect. See e.g. FIGS. 2A-2B, 2C-2D, 10, 15D, 17A-17B, 22A-22B and 24. For example, the payload position may be configured and/or adjusted to reduce at least one of drag effect, lift effect and torque effect (e.g. when attached to the aircraft, latched to the aircraft or attached to a base of the aircraft). See e.g. FIGS. 15D and 24, 45A-45B, 46 and 47.

According to an exemplary embodiment shown schematically and representationally, a method of managing an unmanned aircraft system (e.g. with the payload management system) may comprise an aircraft configured to carry a payload with an aerodynamically-exposed portion on a mission. According to an exemplary embodiment shown schematically and representationally, the method comprises steps of associating the payload with the aircraft and determining aerodynamic profile of the aircraft with payload; an effect of the payload on the flight characteristics of the aircraft is determined; flight characteristics comprise at least one of mass properties, center of mass, moment of inertia, oscillatory effect of movement and/or oscillation of the payload and drag effect of aircraft carrying the payload. See e.g. FIGS. 3A-3F, 15C-15D, 16A-16B, 22A-22B, 23A-23B and 24.

According to an exemplary embodiment shown schematically and representationally, a payload management system for an unmanned aircraft system may provide an aircraft configured to carry a payload with an aerodynamically-exposed portion on a mission from an originator by a carrier to a destination to determine a charge for carrying the payload as freight in operating conditions. See generally FIGS. 15D and 24. According to an exemplary embodiment, the system comprises a container for the payload to be associated with the aircraft and an aerodynamic profile for the aircraft with the payload; the aerodynamic profile for the aircraft comprises consideration of an effect of the payload on the flight characteristics of the aircraft; the charge for carrying the payload as freight is based on the aerodynamic profile of the aircraft with the payload. See e.g. FIGS. 39 and 47.

According to an exemplary embodiment shown schematically and representationally, a method of managing an unmanned aircraft system may comprise an aircraft configured to carry a payload with an aerodynamically-exposed portion on a mission to a destination. The method comprises the steps of associating the payload with the aircraft and determining aerodynamic profile of the aircraft with payload. See e.g. FIGS. 3A-3F, 13A-13D, 15A-15D. An effect of the payload on the flight characteristics of the aircraft is determined; flight characteristics comprise at least one of mass properties, center of mass, moment of inertia, oscillatory effect of movement and/or oscillation of the payload and drag effect of aircraft carrying the payload. The freight charge for carrying the payload as freight on the mission to the destination is based on the aerodynamic profile of the aircraft with the payload. See e.g. FIGS. 26, 33, 39 and 47.

According to an exemplary embodiment shown schematically and representationally, a payload management system to determine freight charge for an unmanned aircraft system may provide an aircraft configured to carry a payload with an aerodynamically-exposed portion on a mission from an originator by a carrier to a destination in operating conditions. The system may comprise an aerodynamic profile for the aircraft with the payload; the aerodynamic profile for the aircraft comprises consideration of an effect of the payload on the flight characteristics of the aircraft; the freight charge for carrying the payload as freight on the mission to the destination are based on the aerodynamic profile of the aircraft with the payload. See e.g. FIGS. 26, 37, 38, 39, 40A-40B, 41A-41C and 47.

The aircraft system may comprise a computing system, a computing device and a network connection. The data sources are available on the network; the network may comprise the internet; the network may comprise access to the data sources; the data sources comprise data internal to the aircraft system; the data sources comprise data external to the aircraft system. According to an exemplary embodiment, the aircraft system may comprise instrumentation; instrumentation is coupled to the payload; instrumentation is connected to the network. The aircraft system is configured to calculate aerodynamic profile. According to an exemplary embodiment, instrumentation is configured to provide data to a data source; instrumentation may provide data to the aircraft system to determine aerodynamic profile. See e.g. FIGS. 7, 27, 28, 32, 35, 37 and 47.

According to an exemplary embodiment, the aerodynamic profile is a data set/information relating to the UAV/craft and/or payload carried by the UAV/craft used to estimate/determine aerodynamic performance (e.g. considerations such as flight characteristics, size, mass, drag/lift effects, drag/lift coefficient, operation in operating conditions, etc.). Considerations of the base/loaded aerodynamic profile for a UAV/craft on a mission facilitates the assessment/transaction of a freight charge for use of the UAV/craft to deliver the payload on the mission.

According to an exemplary embodiment, the system conducts an intersection/transaction with the entity (e.g. originator, destination, agent, etc.) using the UAV to carry the payload. See e.g. FIGS. 27-30, 34, 35, 37 and 47. According to an exemplary embodiment, the transaction comprises payment for use of the UAV/craft. A payment is made for use of the aircraft by the entity in a transaction with the management system. The payment by the entity for the aircraft is for use at the aircraft; the payment on behalf for the aircraft can be based on energy extracted, per unit of energy, etc. and may vary based on time of day. According to an exemplary embodiment, the aircraft can determine an operator of the management system and make a payment for payload delivery by transaction with management system. Payment is made to the management system. According to an exemplary embodiment, the payment or freight charge is at a price; the price of payment can be set by a long term contract, based on aerodynamic performance, time of connection, market price of energy, set by a spot market, or based on an auction.

According to an exemplary embodiment, a contract is made for the entity with the payload management system for payload delivery by the aircraft for the entity; the entity may contract for use of a predetermined UAV or flyway, for access to a predetermined set of routes, for priority access to a route or UAV, etc. See e.g. FIGS. 34, 35 and 37.

According to an exemplary embodiment, the entity transacts a contract with a common operator (carrier) through the management system; according to an exemplary embodiment, the common operator is an operator of a UAV or set of UAVs. The contract may specify which aircraft may use and/or may specify a predetermined route. The payment by the entity for delivery can be based on aerodynamic performance and/or time of the aircraft spent on the mission, etc., based on data monitored by the monitoring system. Data may be reported by the aircraft. The payment for use of the aircraft is made at a payment rate; the payment rate varies based on a number of considerations including aerodynamic performance of the aircraft. The contract for use of the aircraft may be a time-based contract, a short term contract, a long term contract. The contract may comprise actual times or locations of allowed access to the aircraft. A long term contract to use the aircraft may comprise a grant of exclusive use of the aircraft; the long term contract to use the aircraft may comprise allocation of a specified amount of time of use of the aircraft.

As indicated schematically according to an exemplary embodiment, the system and method may be configured to transact with an entity (e.g. by contract, prepayment/postpayment, electronic funds transfer/EFT, debit/credit card, ACH/banking, etc. or any other available financial or commercial arrangement) for use of a UAV/craft to deliver payload on a mission in any of a wide variety of forms and arrangements to provide for payment by the entity of a freight charge. See e.g. FIGS. 27-30, 34-38 and 39-47.

### Aerodynamic Profile

According to an exemplary embodiment shown schematically and representationally, the system may comprise use and determination of a profile including an aerodynamic profile (e.g. consideration of data/information such as flight characteristics, effects, etc.) for the UAV/craft to carry payload. See e.g. FIGS. 1B, 26, 37, 41B-41C, 44B-44C, 47. The aerodynamic profile may comprise data of a variety of types configured to provide for consideration of aerodynamic performance and flight characteristics and other information relating to use of an UAV/craft and carrying of payload; according to an exemplary embodiment, data/information comprising aerodynamic profile may be arranged to provide a factor or other relationship that can be used to determine a charge for a UAV/craft used to carry payload on a mission.

According to an exemplary embodiment, for determining aerodynamic profile the effect of the payload (e.g. including aerodynamically exposed payload/payload segments) to be carried by a UAV/craft may comprise at least one aerodynamic effect (e.g. on aerodynamic performance of the UAV/craft); flight characteristics may comprise consideration such as a combined effect of UAV/craft with payload (e.g. position or orientation, effect of movement of the payload in flight and oscillation of the payload in flight). According to an exemplary embodiment, the flight characteristics for determining aerodynamic profile of a UAV/craft (including a UAV/craft carrying payload) may comprise at least one of (a) mass properties; (b) center of mass; (c) moment of inertia; (d) oscillatory effect of the payload; (e) drag effect of aircraft carrying the payload; (f) lift effect of the aircraft carrying the payload; (g) torque effect of the aircraft carrying the payload.

As indicated schematically, the aerodynamic profile for the UAV/craft may comprise (e.g. for aerodynamic profile) a base aerodynamic profile (e.g. without payload) and a loaded aerodynamic profile (e.g. with payload). See e.g. FIGS. 41B and 41C. According to an exemplary embodiment, the aerodynamic profile of a UAV/craft for a mission may comprise consideration of the base aerodynamic profile and the loaded aerodynamic profile; the aerodynamic profile may comprise consideration of a difference between the base aerodynamic profile and the loaded aerodynamic profile; the base aerodynamic profile may comprise a lift/drag coefficient of the aircraft (without payload). See e.g. FIG. 47.

The aerodynamic profile for the aircraft may comprise consideration of an effect of the payload on the flight characteristics of the aircraft; the aerodynamically-exposed portion of the payload (e.g. creating effects) may provide the loaded aerodynamic profile; the loaded aerodynamic profile may comprise a drag coefficient of the aircraft with the payload. See e.g. FIGS. 15D and 25.

The aerodynamically-exposed portion of the payload (e.g. for determination of profile) may comprise a pod attached to the aircraft, at least one payload segment, payload attached under the aircraft, payload attached on top of the aircraft, payload carried under the aircraft and payload carried on top of the aircraft. See e.g. FIGS. 3A-3F, 15D and 24. According to an exemplary embodiment shown schematically and representationally, the aircraft carries the payload externally to a base of the aircraft; a pod or a container may comprise the aerodynamically-exposed portion; payload attached under the aircraft, payload attached on top of the aircraft, payload carried under the aircraft and payload carried on top of the aircraft. See e.g. FIGS. 3A-3F.

According to an exemplary embodiment, the base aerodynamic profile of a UAV/craft without payload may comprise consideration of at least one of (a) shape of the aircraft; (b) mass of the aircraft; (c) surface effect of the aircraft; (d) form of the aircraft; (e) drag coefficient of the aircraft; (f) aerodynamic torque coefficient of the aircraft; (g) lift coefficient of the aircraft; (h) drag effect of the aircraft without payload; (i) lift effect of the aircraft without payload; (j) torque effect of the aircraft without payload. (Data may be considered in combination to determine a profile.)

According to an exemplary embodiment, the loaded aerodynamic profile of a UAV/craft with payload may comprise consideration of at least one of (a) shape of the aircraft with the payload; (b) shape of the payload as carried; (c) mass of the aircraft with payload; (d) mass of the payload as carried; (e) surface effect of the aircraft with the payload; (f) surface effect of the payload as carried; (g) form of the aircraft with the payload; (h) form of the payload as carried; (i) payload-induced drag; (j) drag coefficient of the payload; (k) aerodynamic torque coefficient of the payload; (l) lift coefficient of the aircraft; (m) differential aerodynamic force between the payload and the aircraft; (n) differential aerodynamic torque between the payload and the aircraft; (o) lift effect of the aircraft with payload; (p) lift coefficient of the aircraft with payload; (q) drag effect of the aircraft with payload; (r) drag coefficient of the aircraft with payload; (s) torque effect of the aircraft with payload; (t) torque coefficient of the aircraft with payload. The method comprises data sources for the system to determine the aerodynamic profile. (Data may be obtained and assessed and compiled in combinations to determine a profile.)

According to an exemplary embodiment, the aerodynamic profile for the UAV/craft on the mission to deliver payload is determined by at least one of (a) estimation of the effect of the payload; (b) calculation of the effect of the payload; (c) a data source external to the aircraft; (d) a data source associated with the aircraft; (e) data from the mission; (f) measurement of data from the aircraft; (g) assessment of the base aerodynamic profile; (h) assessment of the loaded aerodynamic profile. The aerodynamic profile may comprise consideration of any extra drag effect from the payload; drag effect from the payload may comprise additional drag produced by the payload; the aerodynamic profile may comprise reduced lift effect resulting from the payload; the aerodynamically-exposed portion of the payload may comprise a pod attached to the aircraft, at least one payload segment, payload attached under the aircraft, payload attached on top of the aircraft, payload carried under the aircraft and payload carried on top of the aircraft. According to an exemplary embodiment, the method is configured to determine aerodynamic profile from payload-dependent drag effect characteristics of (a) the aircraft and/or (b) the payload and/or (c) the aircraft with the payload. The aerodynamic profile may comprise payload-induced drag effect (a) as measured and/or (b) as estimated; the aerodynamic profile may comprise a payload-induced lift effect (a) as measured and/or (b) as estimated. See e.g. FIGS. 27-30 and 47.

According to an exemplary embodiment, flight characteristics are used to determine aerodynamic profile; flight characteristics may also be used to plan the route for the mission. According to an exemplary embodiment, data is used to determine aerodynamic profile. See e.g. FIGS. 25A, 26 and 47. Measurements may be used to determine aerodynamic profile. See e.g. FIGS. 27-30 and 47. The aircraft system is configured to determine drag effect to plan a route for the mission; the aircraft system is configured to use aerodynamic profile to determine a route for the mission; the aircraft system is configured to use aerodynamic profile to assess freight charge after the mission; the aircraft system is configured to use aerodynamic profile to assess freight charge before the mission. See e.g. FIGS. 4, 26, 27 and 47. (According to an exemplary embodiment, mission parameters such as speed/drag interaction, scheduling/time, energy/fuel, use, weather, traffic, etc. may be used to assess aerodynamic profile/effects.)

The aerodynamic profile may comprise extra drag effect from the payload; drag effect from the payload comprise additional drag produced by the payload; the aerodynamic profile may comprise reduced lift effect from the payload. See e.g. FIGS. 8A-8G, 15C-15D, 24. The aerodynamically-exposed portion of the payload may comprise a pod attached to the aircraft, at least one payload segment, payload attached under the aircraft, payload attached on top of the aircraft, payload carried under the aircraft and payload carried on top of the aircraft. See e.g. FIGS. 8A-8G. According to an exemplary embodiment, the system may be configured to determine aerodynamic profile from payload-dependent drag effect characteristics of (a) the aircraft and/or (b) the payload and/or (c) the aircraft with the payload. See e.g. FIG. 47.

According to an exemplary embodiment, the aerodynamic profile of UAV/craft for a mission can be based on various combinations of mission parameters and may be determined by at least one of (a) estimation of the effect of the payload; (b) calculation of the effect of the payload; (c) a data source external to the aircraft; (d) a data source associated with the aircraft; (e) data from the mission; (f) measurement of data from the aircraft; (g) assessment of the base aerodynamic profile; (h) assessment of the loaded aerodynamic profile. The charge for use of UAV/craft on a mission carrying the payload as freight may be based on at least one of (a) the operating conditions of the mission; (b) energy use on the mission; (c) data from data sources; (d) flight characteristics of the aircraft; (e) the destination; (f) the mission; (g) a difference between the base aerodynamic profile and loaded aerodynamic profile; (h) increased fuel consumption by the aircraft; (i) increased energy use by the aircraft; (j) increased mission time; (k) fuel use on the mission; (l) anticipated energy use; (m) anticipated fuel use. See generally FIGS. 26, 27 and 47.

### Aerodynamic Effect

According to an exemplary embodiment, an aerodynamic effect for a UAV/craft configured for a mission to deliver payload may comprise at least one of (a) lift effect; (b) drag effect; (c) torque effect; (d) inertia effect; (e) mass effect; an aerodynamic effect may comprise (a) base aerodynamic effect attributable to the aircraft and (b) payload aerodynamic effect attributable to payload carried by the aircraft. Payload aerodynamic effect may comprise aerodynamic effect attributable to the aerodynamically-exposed portion of the payload; aerodynamic effect may comprise at least one aerodynamic effect. (According to an exemplary embodiment, payload may be adjusted to modify aerodynamic effect; freight charge may be adjusted based on aerodynamic effect; freight charge may be based on consideration of base aerodynamic effect and loaded aerodynamic effect. See e.g. FIG. 47.)

According to an exemplary embodiment, the aerodynamic profile of the aircraft with payload may be based on the aerodynamic effect through the determination of aerodynamic profile (e.g. base aerodynamic profile and a loaded aerodynamic profile).

According to an exemplary embodiment, the system and method may also comprise data sources for the system to determine the aerodynamic effects for a UAV/craft configured for a mission to deliver payload. See generally FIGS. 25A, 27, 28, 29, 36, 37 and 47. The aerodynamic effects on the use of UAV/craft may be determined by at least one of (a) estimation of the effect of the payload; (b) calculation of the effect of the payload; (c) a data source external to the aircraft; (d) a data source associated with the aircraft; (e) data from the mission; (f) measurement of data from the aircraft; (g) assessment of the base aerodynamic profile; (h) assessment of the loaded aerodynamic profile. See generally FIGS. 27 and 47. According to an exemplary embodiment, an aerodynamic effect for a loaded UAV/craft configured for a mission to carry payload that is aerodynamically exposed may comprise at least one of (a) lift effect; (b) drag effect; (c) torque effect; (d) inertia effect; (e) mass effect. An aerodynamic effect may also comprise (a) base aerodynamic effect attributable to the aircraft and (b) payload aerodynamic effect attributable to payload carried by the aircraft; payload aerodynamic effect comprise aerodynamic effect attributable to the aerodynamically-exposed portion of the payload; aerodynamic effect comprise at least one aerodynamic effect; payload is adjusted to modify aerodynamic effect. According to an exemplary embodiment, consideration of aerodynamic effects may comprise consideration of mass properties (e.g. mass and inertia effect of the aircraft) oscillatory effect of the aerodynamically exposed payload comprise movement of payload during flight; drag effect of aircraft carrying the payload comprise the effect of drag coefficient and speed and wind effect. See e.g. FIGS. 15D, 24 and 39-47.

According to an exemplary embodiment, operating conditions for a mission or a route may comprise at least one of flight speed, wind speed and direction; aerodynamic profile may comprise drag characteristics; drag characteristics produce drag effect; drag effect may depend on the payload form, flight speed, flight direction, wind speed and wind direction; drag effect may comprise effect of oscillations of payload. See e.g. FIGS. 3A-3F and 4. Drag effect of the aircraft with aerodynamic profile are calculated based on at least one of (a) changes in aspect ratio; (b) speed; (c) relative speed; (d) air speed; (e) turn limitations due to avoiding excitation of oscillations; the aerodynamic profile can be measured by testing the aircraft; drag effect are calculated based on a difference between the base aerodynamic profile and the loaded aerodynamic profile. See e.g. FIGS. 27 and 47.

According to an exemplary embodiment, the aerodynamic profile for a mission of the UAV/craft can be calculated based on at least one of (a) planform of a component of the aircraft and (b) payload form; planform of the component may comprise planform area of a component. According to an exemplary embodiment, consideration of effects based on consideration of the aircraft may comprise at least one of (a) base; (b) space frame; (c) propulsion system; (d) payload carried; the loaded aerodynamic profile may comprise the aerodynamic profile of the payload to be carried by the aircraft.

### Mission Parameters/Configuration

According to an exemplary embodiment, mission parameters for a UAV/craft on the mission may comprise at least one of (a) speed of the aircraft on the mission; (b) elevation of the aircraft on the mission; (c) distance of the mission; (d) energy use of the aircraft; (e) configuration of the payload for the mission; (f) number of missions to be completed; (g) drag coefficient of the aircraft with the payload for the mission; (h) route of the mission; (i) numbers of mission segments; (j) duration of the mission; (k) departure time of the mission; (1) lift coefficient of the aircraft with payload for the mission. See generally FIGS. 1B-1D, 2A-2D, 3A-3F, 4, 13A-13D, 15A-15D, 27, 28, 29, 30, 32, 36, 37, 38 and 47. (According to an exemplary embodiment, the mission parameters include drag/speed interaction as a combined consideration.)

According to an exemplary embodiment, the mission may comprise a route. The method further comprises the step of assessing effect of the route. Each mission segment may comprise a flight.

According to an exemplary embodiment, the system and method may comprise consideration of mission parameters as relating to estimated drag effect of the aircraft on the mission and optimization of the aerodynamic profile of the aircraft with the payload based on considerations; optimization may comprise packaging of the payload; optimization may comprise reconfiguration of the payload and/or route in the operating conditions (e.g. weather); considerations for optimization may comprise adjustment and at least one tradeoff of mission parameters (as well as delivery sequencing/scheduling and energy/fuel consumption, etc.).

### Payload Configuration/Reconfiguration

According to an exemplary embodiment, payload (e.g. one payload segment or multiple payload segments) can be loaded and configured/reconfigured on the UAV/craft before the mission and assessed by the system. See e.g. FIGS. 13A-13D, 15A-15D, 16A-16B, 17A-17B and 24.

According to an exemplary embodiment, the payload position can be adjusted for the mission, to reduce movement and to modify aerodynamic torque effect. The payload position may be configured/reconfigured and adjusted to reduce oscillation, modify aerodynamic torque effect and reduce at least one of drag effect, lift effect and torque effect, etc. The payload may be attached to the aircraft; the payload may be latched to the aircraft; the payload may be attached to a base of the aircraft; the payload may comprise payload segments. Position of a payload segment can be adjusted relative to position of other payload segments; the payload segments are positioned to minimize drag effect; the payload may be positioned to reduce the drag coefficient. Aerodynamic profile may comprise consideration of estimated drag effect of the aircraft on the mission for the payload configuration. See e.g. FIGS. 15D and 24.

According to an exemplary embodiment, the system may be configured to use payload-dependent drag characteristics to determine route details or to determine freight charges. According to an exemplary embodiment, the payload may be mounted on a sling, attached to the exterior of the aircraft and/or latched to the exterior of the aircraft. See e.g. FIGS. 16A-16B. The payload may be carried in a pod; the loaded aerodynamic profile may be based on the pod rather than the payload. See e.g. FIGS. 15A-15D. The payload may comprise payload segments; the payload position can be adjusted relative to payload segments to minimize drag effect; drag effect can be measured by the aircraft and/or instrumentation associated with the aircraft. According to an exemplary embodiment, the system may also comprise the step of drag effect with the payload and without the payload; drag effect can be calculated based on planform area and payload shape; drag effect can be calculated for the aircraft; drag effect can be calculated based on aerodynamic profile. According to an exemplary embodiment, the aircraft may provide the base aerodynamic profile without the payload; the aircraft with the payload may provide the loaded aerodynamic profile. The aerodynamically-exposed portion of the payload may provide the loaded aerodynamic profile; the loaded aerodynamic profile may comprise a drag coefficient of the aircraft with the payload.

According to an exemplary embodiment, flight characteristics of the payload comprise data for an aerodynamic profile of the payload; characteristics of packaging of the payload comprise an aerodynamic profile of the payload; effect of the characteristics of the payload comprises an aerodynamic profile of the payload.

According to an exemplary embodiment, as shown representationally and schematically in FIGS. 3A-3F, the UAV/craft is configured to carry a payload P (e.g. in or on or under or within or attached to the base). See also FIGS. 2A-2D, 8A-8D, 10, 11A-11B, 12A-12B, 15A-15D, 16A-16B, 17A-17B, 18A-18B, 19, 20, 21A-21B, 22A-22B, 23A-23B, 24.

Payload configurations (and reconfigurations) for UAV/craft are shown schematically and representationally in FIGS. 3A through 3F. As indicated schematically, payload segments can be attached to a base B of the UAV/craft (shown with rotor system R for propulsion); as indicated, the relative size (and mass) and shape and positioning of payload segments to the UAV/craft (and base) may be vary according to mission requirements and parameters and UAV/craft capability. As shown schematically in FIGS. 3A through 3D, aerodynamically-exposed payload segments may be carried below the base B of the UAV/craft, for example, such as segment Pa (in generally orthogonal arrangement), segment Pb (in a rounded/sling form arrangement), segments Pc and Pd (in separated attachment arrangement), segments Pe (in a form intended to reduce aerodynamic drag). As shown schematically in FIGS. 3E and 3F, aerodynamically-exposed payload segments maybe carried above the base B of the UAV/craft, for example, segment Pf (in a form intended to reduce aerodynamic drag) and segments Pg and Ph (in separated attachment arrangement). As indicated, multiple other forms of payload configuration may be provided according to exemplary embodiments.

Referring to FIGS. 8A through 8G and 9, as shown schematically payload (including payload segments) may be carried in a container shown as pod O that is attachable to base B of the UAV/craft; pod O is aerodynamically exposed after attachment to the UAV/craft. As shown schematically and representationally the pod O may be provided in a form intended to provide enhanced aerodynamic performance (e.g. reduced drag profile/planform, matching form with UAV, etc.). See FIGS. 8A through 8C. As shown schematically in FIGS. 8D through 8G, the pod O may be provided with aerodynamic surfaces (shown as wings WG); as indicated, according to an exemplary embodiment, wings WG may be configured to be adjusted in position/form (e.g. as control surfaces) to adapt aerodynamic performance. As shown schematically in FIG. 9, the pod O maybe provided with features E on the surface in a form intended to enhance aerodynamic performance (e.g. reduce drag effects, etc.).

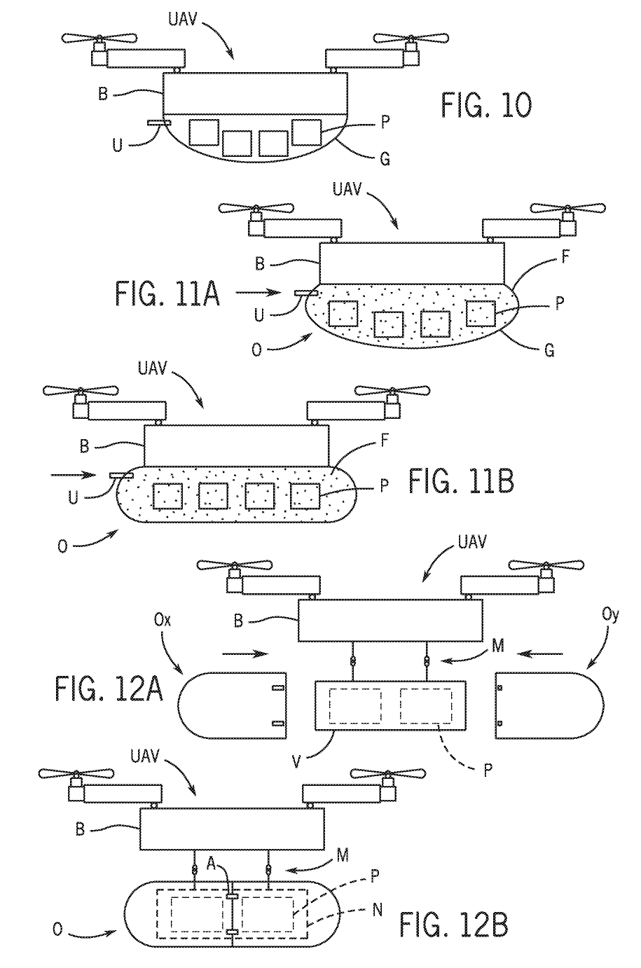

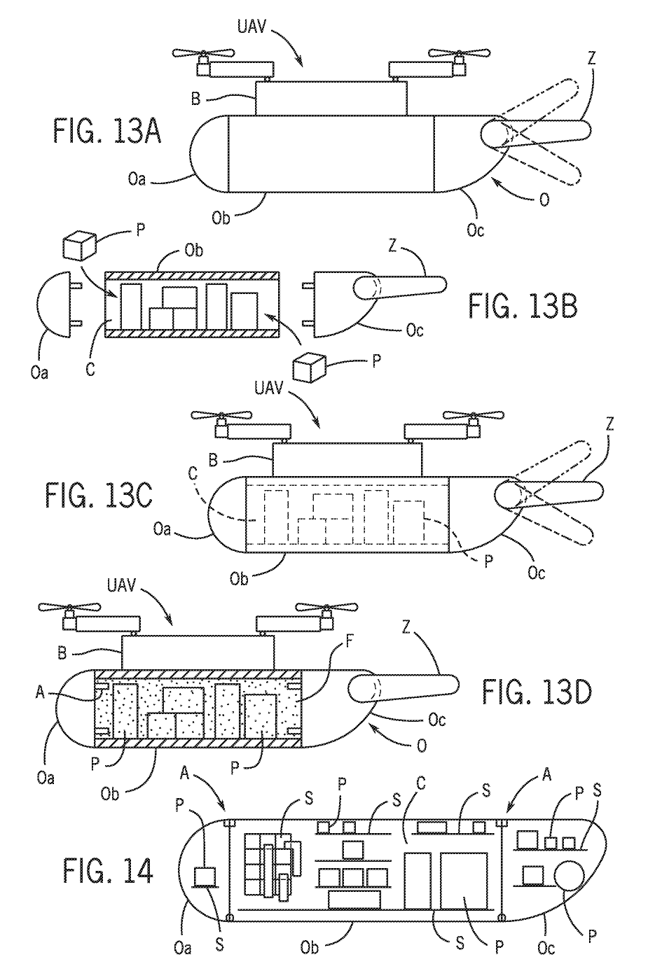

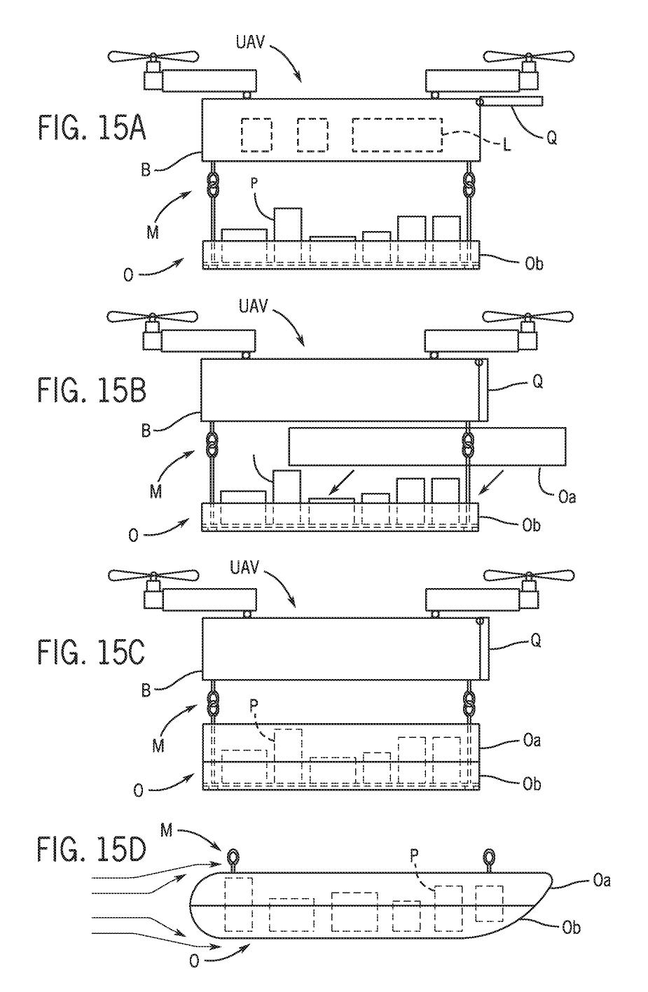

As indicated schematically in FIGS. 10 and 11A-11B the payload segments P may be carried UAV/craft (e.g. attached to base B) in a pod O that comprises a body or base G that can be filled with a fluid F (e.g. air, gas, foam, etc.) through a port U; when filled the pod may take an altered form that may provide enhanced/different aerodynamic performance and/or may provide protection for the payload segments. See FIGS. 11A and 11B.

As indicated schematically in FIGS. 12A and 12B, payload may be provided in a pod O attached to the base B of the UAV/craft at attachment point M (shown schematically as a hanger/hook); pod O comprises pod sections Ox and Oy that fit together at attachment points A (e.g. shown schematically as a latch) around payload segments P (shown as in a container V).

As indicated schematically in FIGS. 13A through 13D, a pod O may be provided in sections that can be assembled together, for example, front/nose section Oa, mid/base section Ob and tail/end section Oc. Payload segments P may be stored or stowed in a container volume C and the sections attached to form pod O which can be attached to the base B of UAV/craft. See FIGS. 13A to 13C. As shown schematically in FIG. 13D, the container volume may be filled (e.g. wholly or partially) with a protection or fill material F (e.g. a foam material, foam pads, wrapping, etc.). As indicated schematically in FIG. 14, according to an exemplary embodiment, payload segments P may be supported or attached to structure S (e.g. shelving, racks, etc.) in the container volume C of pod O. As indicated schematically in FIGS. 13A-13D, according to an exemplary embodiment, pod O may be provided with aerodynamic surface such as tail Z (e.g. a fixed surface or movable surface such as a control surface that may be adjusted to alter aerodynamic performance).

As indicated in schematically and representationally according to an exemplary embodiment in FIGS. 9 and 15D and 20 and 24, the pod O may be provided in an aerodynamic form intended to enhance aerodynamic performance in airflow AF (e.g. as would induce drag effects when the pod is carried by a UAV/craft in transit at a speed/velocity). As indicated schematically in FIG. 15D, payload segments P are carried in a pod O formed from sections Oa (top) and Ob (bottom); pod O can be attached at mechanism M (shown schematically) to a UAV/craft for a mission to deliver the payload; as shown schematically in FIG. 24, payload segments P are carried in space N of pod O that is attached to a UAV/craft (e.g. at base B). See also FIG. 20.

As shown schematically in FIGS. 15A to 15C, payload segments P may be carried in a pod O that is attached to UAV/craft (e.g. to base B at attachment points M); payload segments P may be carried in a base section Ob of pod O; payload segments may be carried in a pod O comprising a base section Ob and a cover section Oa. As indicated schematically according to an exemplary embodiment the pod O provided an enclosure for payload segments P.

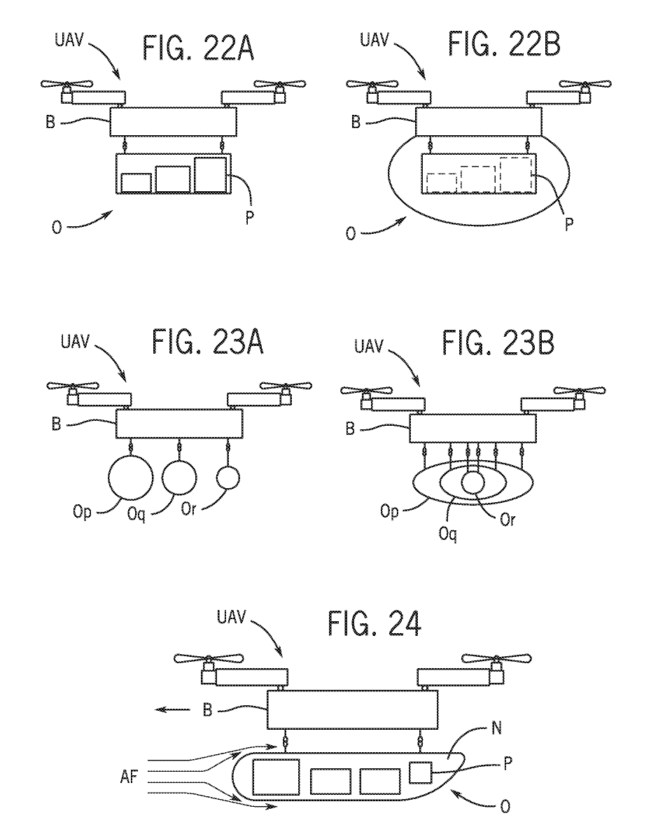

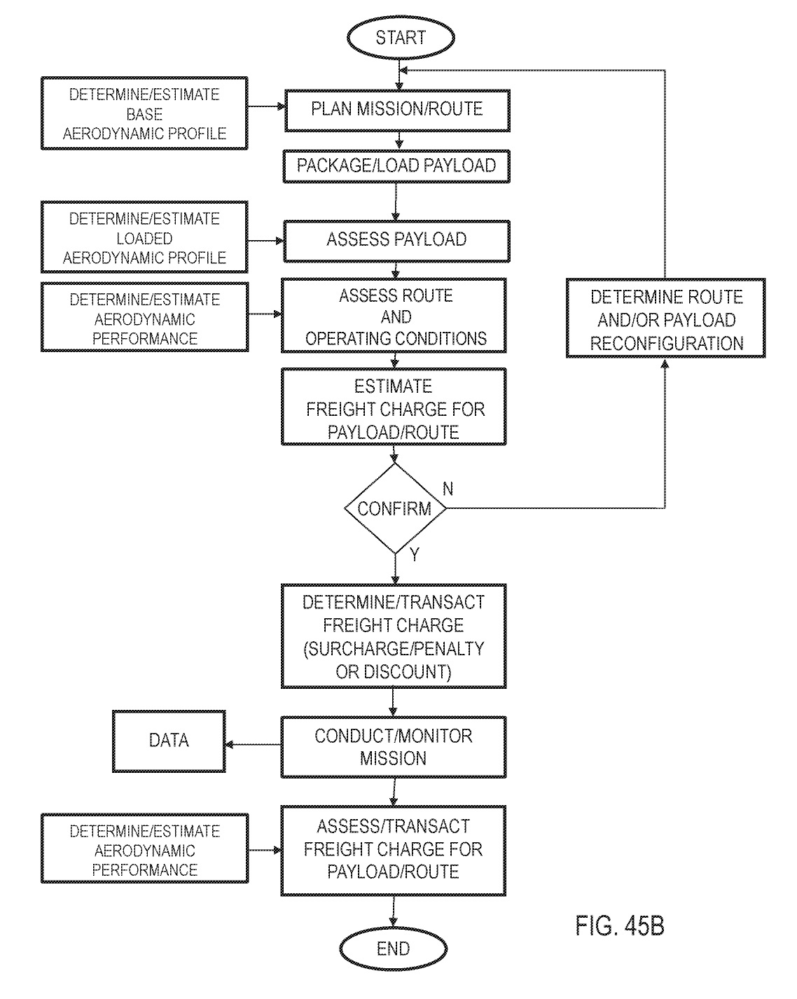

Referring to FIGS. 16A through 23B as shown schematically and representationally according to exemplary embodiments, payload segments P of a variety of types and forms may be carried by UAV/craft in an aerodynamically-exposed arrangement. As shown schematically in FIGS. 16A and 16B, payload may be carried in a sling arrangement; as indicated sling may move relative to the UAV/craft during a mission. As shown schematically in FIGS. 17A and 17B, payload segments carried by the UAV/craft may be altered in configuration (e.g. position, form, etc.) such as for balancing, optimization, etc. See also for example FIGS. 45A and 46A. As shown schematically in FIGS. 18A and 18B, payload segments and/or containers may be provided in a variety of forms and profiles (e.g. relatively large form as in FIG. 18A or relatively thin form as in FIG. 18B); payload segments may be carried individually (see e.g. FIGS. 21A and 18A-18B) or in groups (see e.g. FIGS. 19 and 20 and 21B). As indicated, payload delivery may require multiple deliveries of individual or grouped payload (e.g. for which a mission may require multiple flight segments for each individual delivery). As indicated in FIGS. 22A and 22B, payload may be in a base container that is aerodynamically exposed (e.g. FIG. 22A) or with an encapsulation O around the base container (e.g. intended to protect payload segments or to enhance aerodynamic performance). As indicated schematically in FIGS. 23A and 23B, multiple pods/payload segments may be carried by UAV/craft; as shown schematically, segment Op is larger than segment Oq which is larger segment; attachment of the pod to base maybe provided in various arrangements (e.g. to balance loading, manage oscillatory effects, to improve efficiency, to enhance aerodynamic performance).

As indicated schematically according to an exemplary embodiment of the system and method of payload management, payload/payload segments of a wide variety of types (e.g. size, quantity, mass, etc.) may be associated with UAV/craft to be carried on a mission to deliver payload/payload segments in any of a wide variety of configurations/reconfigurations and arrangements (e.g. forms of attachment, containment/pod types or use/non-use, orientation/positioning, etc.); the system and method of payload management may associate/carry and configure/reconfigure payload for purposes of use of the UAV/craft on a mission to deliver payload according to any of a wide variety of considerations (e.g. aircraft capability/capacity, range, logistics/scheduling, priority, energy efficiency, aerodynamic effects/performance, etc.).

### Flyway—Route Planning

According to an exemplary embodiment, the UAV/craft may operate in an airspace with a set of flyway segments (e.g. for UAV/craft mission/duty/route planning.) According to an exemplary embodiment as shown schematically and representationally, the route of the UAV/craft can be configured in advance of a mission; route/mission planning of the aircraft can be undertaken in conjunction with considerations such as multiple payload segments delivery, operating conditions, etc., registration/access planning for repowering of the aircraft with the power system (e.g. at times and locations selected with the route/mission plan).

According to an exemplary embodiment, the aircraft operates on a mission comprising a planned route in an airspace with flyways; the route of the aircraft can be planned by the system and method; the route/mission can be revised when or if it is determined that the aircraft should have a reconfigured route (e.g. for some anticipated/planned or unanticipated/unplanned reason) or the route is otherwise required or advisable (e.g. for optimization, scheduling/logistics, traffic, etc.). See e.g. FIGS. 4-7 and 44A-44C, 45A-45B and 47.

### Freight Charge

The system and method is configured to estimate/determine and assess/transact a charge for the UAV/craft to conduct the mission to carry/deliver the payload from the originator to the destination on the route in operating conditions. According to an exemplary embodiment, the charge is by the entity functioning as operator and/or manager of the UAV/craft to the entity designated to pay the charge (e.g. the originator or destination entity or other entity); each involved entity may have an account and/or commercial relationship as well as a communications (e.g. data communications including over a network) to complete a transaction for the charge.

As indicated schematically, the charge (e.g. freight charge) may be based on multiple considerations including aerodynamic performance of the UAV/craft and energy/fuel consumption (e.g. including effects such as drag which is based on velocity, routing, scheduling, payload characteristics/configuration, etc.). The charge may comprise a surcharge or penalty when determined (e.g. the mission required or consumed excess resources/energy/time/etc. as estimated/determined); the charge may comprise a discount when determined (e.g. the mission required less resources/energy/time/etc. as estimated/determined). According to an exemplary embodiment, the mission may comprise a fuel/energy budget (e.g. as part of a mission plan). The charge may comprise freight charge and a surcharge; the surcharge may comprise a propulsive penalty. (A discount may be applied with the freight charge.)

According to an exemplary embodiment shown schematically and representationally in FIGS. 5-7, 25A-38 and 39-47, the system with payload management system is configured to estimate/determine and assess/transact freight charge for a UAV/craft carrying payload on the mission on a route in operating conditions.

According to an exemplary embodiment, the system will operate with a method for assessing a charge for carrying a payload in an unmanned aircraft based on effect of the payload with an aerodynamically-exposed portion. According to an exemplary embodiment, the method comprises the steps of (a) assessing characteristics of the payload on a mission; (b) assessing packaging of the payload on a mission; (c) assessing effect of characteristics of the payload on a mission; (d) assessing effect of packaging of the payload on a mission; (e) determining the charge based on effect of the payload carried on a mission. According to an exemplary embodiment, the payload is carried on the mission by a UAV/craft operated by or for a carrier entity from an originator entity to a destination entity; the mission may comprise a route; the mission is conducted in operating conditions (e.g. weather). According to an exemplary embodiment, a surcharge may be imposed for operating conditions (e.g. a factor of 2 for headwind). The payload is provided by an originator; the aircraft is operated by an operator; the payload is delivered to a destination. According to an exemplary embodiment, the mission may comprise mission segments (e.g. multiple payload segment delivery and/or route segments).

According to an exemplary embodiment, the freight charge as determined/transacted through the payload management system is paid by an originator or destination of the mission (or allocated between originator/destination entities); the freight charge may be billed by the payload management system for or by the carrier of the payload.

According to an exemplary embodiment, the base aerodynamic profile of the aircraft is used to determine freight charge; the loaded aerodynamic profile with payload is used to determine freight charge; the freight charge is based on (among other considerations) a relationship between base aerodynamic profile and loaded aerodynamic profile. See e.g. FIG. 47.

The aerodynamic profile for a UAV/craft in use to deliver payload may comprise considerations including a payload-induced drag effect (a) as measured and/or (b) as estimated; the aerodynamic profile may comprise a payload-induced lift effect (a) as measured and/or (b) as estimated. According to an exemplary embodiment, flight characteristics may be used to plan the mission (e.g. including route and logistics schedule sequence, etc.) in the operating conditions. According to an exemplary embodiment, freight charge is based on aerodynamic performance of the aircraft as configured (or reconfigured) for the mission with the payload; aerodynamic performance may comprise consideration of aerodynamic profile and operating conditions; the payload form may comprise dimensions, shape and orientation as configured (or reconfigured) for the mission. See generally FIGS. 15D, 24 and 47. Freight charges can be based on costs (e.g. energy fuel costs, asset cost for UAV/craft, other operating costs, etc.)

Freight charge may be adjusted based on aerodynamic effect; freight charge may be based on consideration of base aerodynamic effect and loaded aerodynamic effect (e.g. as affected by combination/association of payload/payload segments with UAV/craft). According to an exemplary embodiment, freight charge is adjusted based on aerodynamic effect; freight charge is based on consideration of base aerodynamic effect and loaded aerodynamic effect of UAV/craft with payload as configured for the mission (including on route in operating conditions). See generally FIGS. 27, 37, 38 and 47.

According to an exemplary embodiment, drag effect can be provided by the aircraft operator (e.g. with the identifier data). The loaded aerodynamic profile can be provided by the originator (e.g. as data); the loaded aerodynamic profile may comprise drag coefficient of the aircraft and the payload as measured during the mission.

According to an exemplary embodiment, freight charge can be based on the drag coefficient of the (aerodynamically-exposed) payload; freight charge can be based on planform area of the payload. According to an exemplary embodiment, freight charge can be a penalty; the penalty may comprise a propulsive penalty; the propulsive penalty may comprise an effect (a) due to drag effect based on drag coefficient of the aircraft with the payload and/or (b) the loaded aerodynamic profile; the propulsive penalty is based on (a) the speed on the mission and/or (b) effect of operating conditions on the mission. According to an exemplary embodiment, the operating conditions comprise effect of wind on the route of the mission (e.g. net wind effect based upon mission speed or velocity for the UAV). According to an exemplary embodiment, for use of the UAV/craft on the mission, freight charge may comprise (a) a base charge and (b) a surcharge; the surcharge may comprise a penalty charge; the penalty charge may comprise a propulsive penalty charge; the anticipated fuel use is determined for the mission; the anticipated energy use is determined for the mission; determination of the propulsive penalty charge is used to set freight charge. The propulsive penalty charge may comprise a penalty; (e.g. surcharge) based on anticipated fuel use, anticipated energy use, anticipated energy use for the base aerodynamic profile, anticipated energy use for the loaded aerodynamic profile and actual energy use for the loaded aerodynamic profile. The penalty may be based on extra fuel used for the route of the mission and/or extra energy used on the mission; the penalty may be based on energy used for a given route. Each mission may comprise a fuel/energy budget. According to an exemplary embodiment, consideration of potential propulsive penalty can be used to reconfigure payload or logistics (e.g. time, speed, schedule, sequence, etc.) or otherwise to select or adjust the mission (e.g. route or time) for a given fuel/energy budget; penalty for a mission can be adjusted by the aircraft (a) traveling at a slower speed or (b) choosing a route to lower wind-induced drag; or (c) reducing the payload.

According to an exemplary embodiment, the freight charge can be based on the payload form; the payload form is determined before the mission; the payload form may comprise shape and dimensions of the payload as carried on the aircraft. The loaded aerodynamic profile may comprise consideration of the aerodynamic profile of the payload to be carried by the aircraft on the mission. According to an exemplary embodiment, the payload may be supplied by the originator; the aerodynamic profile of the payload may be measured by the originator; the payload may be supplied by the originator before the mission. According to an exemplary embodiment, the aerodynamic profile of the payload may be measurable by the carrier; the aerodynamic profile of the payload is determined by the carrier before the mission; the aerodynamic profile of the payload may be determined by testing. According to an exemplary embodiment, the aerodynamic profile of the payload may be estimated from data sources; the loaded aerodynamic profile of the aircraft may be determined by the carrier; the loaded aerodynamic profile of the aircraft may be calculated from data sources (including instrumentation, detectors, etc.).

According to an exemplary embodiment, as indicated schematically the system and method may provide for charge for use of UAV/craft to carry and delivery payload according to any of a wide variety of arrangements based on a wide variety of considerations (e.g. including commercial/relationship considerations, functional/operational considerations, logistic/scheduling considerations, aerodynamic considerations, energy/efficiency considerations, operating condition considerations, etc.) as reference points and/or factors for calculation and transaction with the entity (e.g. the entity to pay the charge). For example, the portion of the total cost of the UAV/craft allocated for a time/time of day use may be assessed at a unit reference point (e.g. as for vehicle rental); the cost of energy for the UAV/craft to complete the mission may assessed at a unit reference point; the base aerodynamic profile of the UAV/craft may provide a reference point (however determined); the loaded aerodynamic profile may provide a reference point (however determined); aerodynamic performance for the mission may provide a reference point. According to an exemplary embodiment of the system and method, freight charge can use reference points and considerations (e.g. variations from unit reference point) to determine a freight charge for transaction with the entity. Considerations may comprise at least one of one or combined factors relating to (a) base aerodynamic profile; (b) loaded aerodynamic profile; (c) operating conditions of the mission; (d) route of the mission; (e) energy use/efficiency; as indicated, freight charge may be based on consideration of planned route and anticipated weather effect. See e.g. FIGS. 27, 28, 29, 37, 38, 45A-45B, 46A-46B and 47. According to an exemplary embodiment, the system and method may provide a surcharge or discount to an entity (e.g. originator) that is based on the commercial relationship with the entity, for example volume pricing discount, urgent delivery surcharge, optimized packaging discount, irregular packaging surcharge, etc. See FIGS. 3A-3F and 39-47.

According to an exemplary embodiment in consideration of operating conditions for the mission, weather effect may be measured; weather effect comprises wind characteristics; as shown schematically and representationally, weather effect is provided from data sources; the wind characteristics comprise (a) wind speed; (b) wind direction; (c) wind variations; the wind characteristics are measured by instrumentation or monitoring (or provided from data sources). See generally FIGS. 25A, 27, 28, 29 and 47. Freight charge can be based on estimated fuel/energy use and measured fuel/energy use; fuel/energy use may comprise at least one of (a) fuel consumption by the aircraft on the mission and (b) energy consumption by the aircraft on the mission in the conditions. See generally FIGS. 25A, 27, 28, 29 and 47.

As indicated schematically, according to an exemplary embodiment of the system and method the freight charge for use of the UAV/craft to carry and delivery payload on a mission may be based on the unit reference points and factors as affecting aerodynamic performance for particular UAV/craft and payload configurations on a particular mission with route and operating conditions (and logistics/scheduling, etc.). For example, a payload configuration that has an adverse effect on aerodynamic performance (e.g. increased drag effects, larger mass effects, oscillatory effects, etc.) will have a loaded aerodynamic profile that increases the factor applied to the unit reference for determination of freight charge (e.g. which will be increased and/or including a surcharge); a payload configuration that is provided for better aerodynamic performance (e.g. less adverse drag effect, etc.) will have a loaded aerodynamic profile that when applied to unit reference points is less of an increase in freight charge. Other considerations such as urgency, sequencing/logistics, routing and operating conditions will have a factor that may be applied to unit reference points to increase freight charge. A mission conducted on a longer route (e.g. due to traffic or other considerations) or in non-standard operating conditions (e.g. adverse weather, headwinds, etc.) will have a factor that may be applied to unit reference points to increase freight charge. As indicated, the specific financial/mathematical relationships between considerations and unit reference points (e.g. quantification of points and factors) may be determined for a specific implementation of the system and method for payload management as may be suitable in the circumstances/situation (e.g. including UAV/craft and payload and location and etc.) according to exemplary embodiments. As indicated, data/information (e.g. including data sharing/analysis and data analytics) may be used in a particular implementation of the system and method for payload management to determine unit reference points and factors as affecting considerations/profile.

The route and freight charge for the mission can be optimized by adjusting the route based on aerodynamic profile and anticipated operating conditions. See generally FIGS. 45A-45B and 46A-46B. The freight charge for a mission is charged to the originator before a subsequent mission with the carrier; the freight charge for a mission is debited from a financial account associated with the originator and the carrier.

According to an exemplary embodiment, the freight charge is paid by an originator of the mission; the freight charge is billed by the carrier of the payload (e.g. in a transaction executed by the system with the entity to pay). The base aerodynamic profile of the aircraft is used to determine freight charge; the loaded aerodynamic profile is used to determine freight charge; the freight charge is based on a comparison of base aerodynamic profile and loaded aerodynamic profile. The aerodynamic profile may comprise a payload-induced drag effect (a) as measured and/or (b) as estimated; the aerodynamic profile may comprise a payload-induced lift effect (a) as measured and/or (b) as estimated. Flight characteristics are used to plan the route; the route plan will be used to determine effects such as wind and distance as affect aerodynamic performance and operating cost.

According to an exemplary embodiment, the charge for carrying the payload as freight is based on at least one data set from a data source for the UAV/craft including data of (a) the operating conditions of the mission; (b) energy use on the mission; (c) data from data sources; (d) flight characteristics of the aircraft; (e) the destination; (f) the mission; (g) a difference between the base aerodynamic profile and loaded aerodynamic profile; (h) increased fuel consumption by the aircraft; (i) increased energy use by the aircraft; (j) increased mission time; (k) fuel use on the mission; (l) anticipated energy use; (m) anticipated fuel use.

According to an exemplary embodiment, freight charge is based on effect of the route on cost. Freight charge assessment may further comprise the step of optimizing packaging to reduce effect or the step of optimizing routing to reduce effect. Re-configuring the route may alter the freight charge (e.g. a reduced route may consume fewer resources for a discount or reduced freight charge and an extended route may consume greater resource for a surcharge/propulsive penalty added to the freight charge). A mission that requires flight/transit of the UAV/craft at higher speed (e.g. incurring greater drag losses) may incur a surcharge/propulsive penalty; a mission that is conducted at a lower speed or otherwise with improved aerodynamic efficiency may incur no surcharge (or may obtain a discount) to the freight charge. According to an exemplary embodiment, data (e.g. from data sources) to complete the mission and transact freight charge the payload is available when delivered at a destination.

A UAV/craft that carries payload that is aerodynamically exposed (e.g. on or below the base of the UAV/craft and/or otherwise externally to the base as in a sling, attached/latched to body, etc.) will experience aerodynamic effects such as drag that affect aerodynamic performance (e.g. flight characteristics). The aerodynamic effect/performance of a UAV/craft carrying payload will depend upon (among other considerations) the payload carrying configuration, payload form (e.g. dimensions, shape, orientation, etc.). The aerodynamic profile of the UAV/craft with payload will (among other factors) affect the flight performance and energy usage/speed of a UAV/craft with payload performing a mission (e.g. traveling on a route in operating conditions to deliver payload).

The UAV/craft will have an aerodynamic profile; the UAV/craft with aerodynamically-exposed payload will have an aerodynamic profile affected by the payload. The variation in the aerodynamic profile of the UAV/craft without payload and with payload may be used to estimate/determine and assess/transact a charge for carrying payload on a mission.

According to an exemplary embodiment, a UAV/craft will have an aerodynamic profile (e.g. characteristics that affect flight/aerodynamic performance); the aerodynamic profile of the UAV/craft will (among other factors) affect the flight performance and energy usage/speed of a UAV/craft performing a mission (e.g. traveling on a route in operating conditions).

According to an exemplary embodiment, the payload-induced effects (e.g. drag effects, etc.) can be assessed in an evaluation of UAV/craft performance; the effects can be assessed in an effort to decide a route for a mission and to assess/transact a charge for the mission (e.g. a cost for carrying/delivering payload at a destination). According to an exemplary embodiment, the charge may depend on the payload features (e.g. drag coefficient, planform area, etc.) based on the payload configuration, shape and dimensions (either supplied by the customer, or measured by the UAV/system). For example, a sling-carried payload may experience adverse performance because configuration and orientation can change due to oscillations (e.g. moments of inertia changes or effects) on the mission (e.g. drag characteristics can include effects of oscillations, i.e., changes in aspect ratio (and hence drag), speed and turn limitations due to avoiding excitation of oscillations, etc.). Mission drag losses will also depend on flight speed, wind speed and direction, etc.; such factors can be used to optimize the route. Optimizations can involve tradeoffs between faster speed to shorten trip time (allowing more missions) at the expense of higher drag (consuming more energy). According to an exemplary embodiment, payload dependent drag characteristics can be used to determine route details and to determine freight charges.

According to an exemplary embodiment, payloads carried in a pod have a drag effect based on the pod rather than the payload form. Payload segment position can be adjusted relative to other payload segments to minimize drag. See e.g. FIGS. 17A-17B and 23A-23B.

According to an exemplary embodiment, drag effects can be measured for the UAV/craft (i.e. difference between drag with and without payload); drag effects can be calculated based on planform area and payload shape; drag effects for a pod/container can be provided by payload owner/originator (e.g. based on the pod/container form).

According to an exemplary embodiment, propulsive penalty due to drag can be based on drag coefficients and/or larger payload form or mass and on the speed or wind associated with a given route; propulsive penalty can be used to set freight cost (i.e. based on extra fuel/energy incurred) for a given route. Freight charges can be precalculated based on planned route and anticipated winds on the route (e.g. based on measured fuel/energy difference).

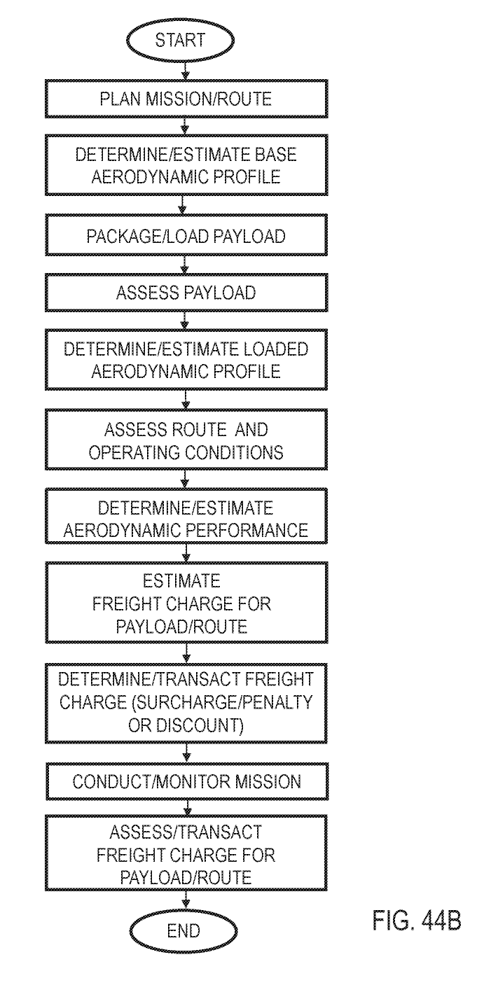

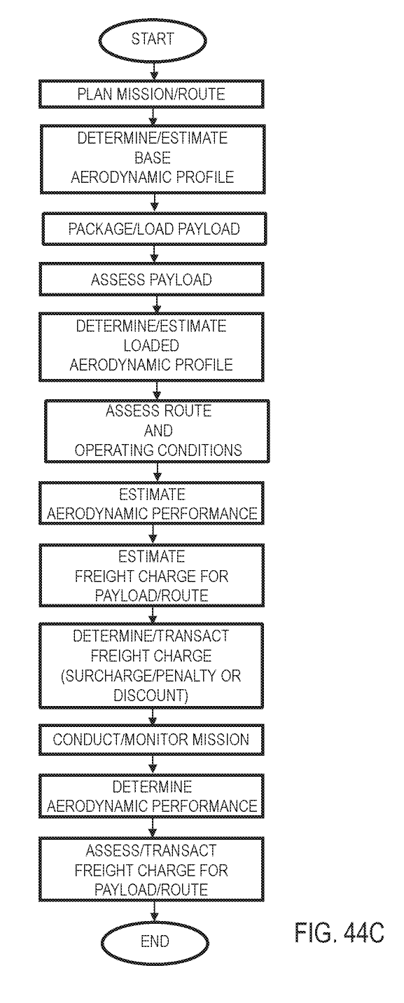

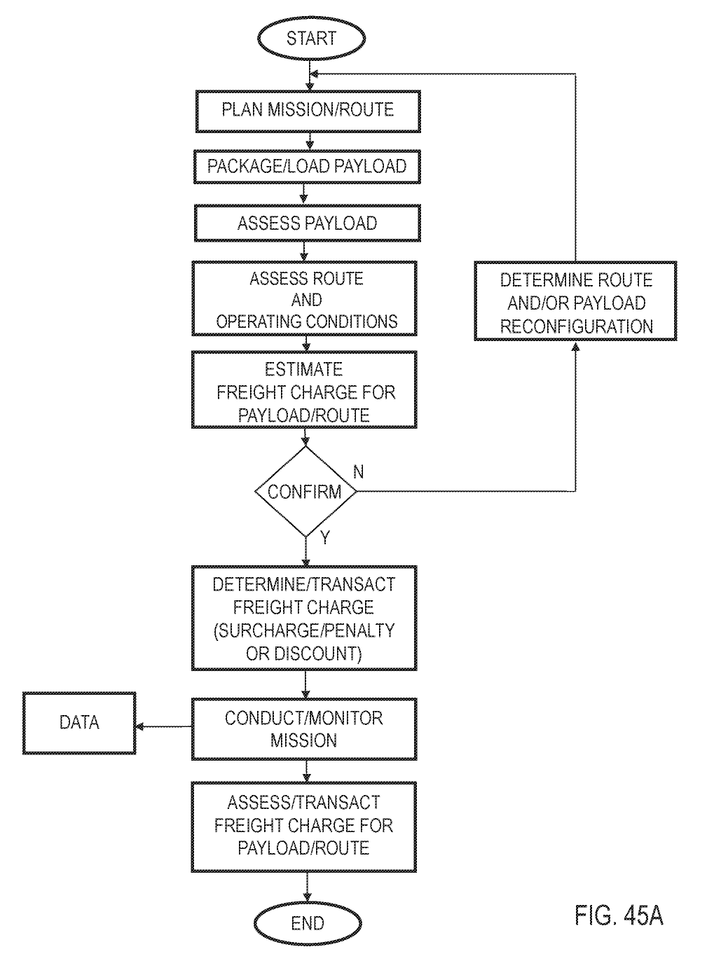

According to an exemplary embodiment, propulsive penalty can be used to select route or trip time for a given fuel/energy budget (e.g. traveling at slower speeds, choosing a route to lower wind-induced drag, etc.). See e.g. FIGS. 44A and 45A.

Route and freight costs can be jointly optimized (e.g. optimizations can involve tradeoffs between faster speed to shorten trip time (allowing more missions) at the expense of higher drag). See e.g. FIGS. 45A-45B.

According to an exemplary embodiment, if the mission is determined or considered to encounter adverse effects (e.g. due to payload configuration, mission parameters, route, time/urgency, sequence, schedule, logistics, conditions, additional energy use, etc.) a surcharge penalty (e.g. propulsive penalty) may be provided for freight charge by the system.

According to an exemplary embodiment, the surcharge (e.g. propulsive penalty) may be based on the loaded aerodynamic profile; the propulsive penalty is based on the loaded aerodynamic profile in comparison to the base aerodynamic profile; the loaded aerodynamic profile may comprise drag effect due to the payload; the propulsive penalty may be based on drag effect due to the payload; the propulsive penalty due to drag effect can be based on drag coefficient and on the speed or wind associated with a route. See generally FIGS. 41A-41C. The surcharge may comprise the propulsive penalty; propulsive penalty can be used to determine freight charge; surcharge is based on extra fuel/energy incurred for the route.

According to an exemplary embodiment, the freight charge may be precalculated based on planned route and anticipated wind effect on the mission; freight charge may be based on measured fuel/energy use; freight charge is based on estimated fuel/energy use. Determination of the propulsive penalty may be used to select route for the mission, time for the mission, and fuel/energy budget for the mission. (According to an exemplary embodiment, the method may comprise the step of traveling at slower speed or choosing a route to counteract drag effect.) According to an exemplary embodiment, a freight charge for a mission may comprise a fuel/energy budget. The surcharge may comprise a propulsive penalty (e.g. for exceeding budget). According to an exemplary embodiment, if the mission is performed as to reduce adverse effects (e.g. by reconfiguration of payload, mission, route, conditions, time, sequence, schedule, logistics, energy use, etc.) a discount may be provided for freight charge by the system. See e.g. FIGS. 31A-41C and 47.

According to an exemplary embodiment, the payload management system and method may be configured for optimization of the aerodynamic profile of the aircraft with the payload based on considerations. Optimization may comprise configuration, or reconfiguration and packaging of the payload; optimization may comprise carrying of the payload according to a configuration to reduce adverse effects. Considerations for optimization comprise at least one tradeoff of mission parameters (e.g. route, sequence, speed, etc.). As indicated schematically in FIGS. 45A-45-B and 46A-46B, the payload management system may be configured to optimize route and/or payload configuration (e.g. based on various considerations including but not limited to time, speed, freight charge, etc.); as indicate schematically in FIG. 7, the system and method may comprise a preparation of a mission plan (e.g. route, payload, payload configuration, etc. that reflects optimization according to selected parameters).

According to an exemplary embodiment, optimization may comprise tradeoff of mission parameters. According to an exemplary embodiment, the aircraft system performs the optimization; data from instrumentation is used for optimization; optimization may comprise variation of speed and energy use on the mission. Tradeoff of mission parameters may comprise at least one of reduction of distance of the mission to provide a shorter trip time, increase of duration of the mission to provide a slower speed or completing more mission segments in a mission; tradeoff of mission parameters may also comprise at least one of reduction of distance of the mission to provide a shorter trip time, increase of duration of the mission to provide a slower speed or reduction of drag coefficient of the aircraft with the payload for the mission to reduce energy use of the aircraft. See generally FIGS. 25A, 27, 28, 29, 37, 38, 45A-45B, 46A-46B and 47.

According to an exemplary embodiment, each mission segment may comprise a route; each route may comprise a distance; each mission may comprise a time. Optimization of flight characteristics may comprise tradeoff between lower speed and longer time; optimization may comprise tradeoff between higher speed and greater energy use on the mission. See generally FIGS. 45A-45B, 46A-46B and 47. According to an exemplary embodiment, tradeoff of mission parameters may comprise at least (a) reduction of the drag coefficient of the aircraft with the payload or (b) reduction of the distance of the route of the mission or (c) reduction of the speed of the aircraft on the mission or (d) reduction of the number of mission segments; or (e) reduction of the payload on the mission; (f) route of the mission. According to an exemplary embodiment, tradeoff of mission parameters may be determined by the aircraft system before the mission; freight charge may be based on tradeoff of mission parameters; freight charge may be reduced by optimization; freight charge is calculated by the aircraft system. According to an exemplary embodiment, aerodynamic profile is used to optimize the route; the aerodynamic profile may comprise estimated drag effect on the mission; the aerodynamic profile is based on at least one of the payload dimensions, shape, orientation. Tradeoff may comprise completing more missions against increased drag effect; mission drag effect can be used to optimize the route; tradeoff may comprise allowing more missions at the expense of increased drag effect; drag effect comprise drag losses.

Optimization may comprise reduction of drag effect; reduction of drag effect may comprise reduction of speed and/or modification of route and/or packaging of the payload to alter loaded aerodynamic profile. According to an exemplary embodiment, aerodynamic characteristics effecting freight charge to carry the payload comprise of at least one of (a) effect of oscillation; (b) changes in aspect ratio; (c) speed and turn limitations; (d) drag coefficients; (e) speed on the route; (f) wind effect on the route. The propulsive penalty is based on consideration of at least one of (a) delay; (b) mass; (c) drag effect; (d) energy use; (e) fuel use; freight charge is based on at least one of (a) time; (b) route; (c) mass; (d) speed; (e) packaging of the payload. The payload is carried in a pod attached to the aircraft; the payload oscillates relative to the payload; the pod is fixed in position relative to the aircraft. Freight charge is based on the configuration of the pod. The aircraft has the base aerodynamic profile and the aircraft with the payload has the loaded aerodynamic profile; freight charge is based on the difference between the base aerodynamic profile and the loaded aerodynamic profile.

According to an exemplary embodiment as shown schematically and representationally, the method may comprise the step of optimizing the speed to reduce freight charge and the step of optimizing the route to reduce freight charge. Route and freight charge may be optimized; route and time may be optimized; time and freight charge are optimized. Optimization may comprise tradeoff between speed and time and adding mission segments to the mission. (Each mission segment may comprise a flight.)

According to an exemplary embodiment, the system and method is configured to use and adjust payload configuration and mission parameters to optimize factors that affect freight charge (e.g. to allow adjustment to reduce freight charge before the mission).

As indicated, a system and method for payload management may be configured as an improvement of the current state of the art of known systems for UAV/craft operation. A payload management system and method can be configured to use data and information including but not limited to data from data sources relating to the UAV/craft and payload configuration to administrate/manage and assess/transact and configure/reconfigure and optimize/enhance operation of UAV/craft to carry/deliver payload to a destination. As indicated, among other functions the payload management system can be provided to estimate/determine and assess/transact a charge (e.g. freight charge, surcharge, delivery charge, penalty, discount, etc.) for carrying/delivering the payload based on considerations relating to the UAV/craft and payload and mission performed in the operating conditions (e.g. speed, drag effects, aerodynamic performance, route, time, etc.).

### Method of Operation

Referring to FIGS. 39 through 47 the method of operation of the payload management system is shown schematically according to exemplary embodiments. As indicated according to exemplary embodiments, the method of operation for payload management can be employed using the system and UAV/craft (e.g. as shown schematically and representationally in FIGS. 1A-1D, 2A-2D, 3A-3F, 4, 5, 6, 7, 37 and 38 or according to other exemplary embodiments with any other system arrangements and/or UAV/craft configured to perform the methods of operations and related combinations of steps for payload management).

As indicated schematically and representationally in FIGS. 39 through 47, according to an exemplary embodiment the methods of operation of the payload management system facilitate the use by a carrier of a UAV/craft to perform a mission to deliver payload provided by an originator to a destination and determination/allocation of a charge (e.g. freight charge, surcharge, penalty, etc.) by or on behalf of the carrier for carrying and delivery of the payload to the destination. As indicated schematically in FIGS. 39 through 47, the charge (e.g. freight charge) can be assessed to the originator or the destination or another person or entity; the charge may be paid in advance of the mission or at the start of the mission or during/after completion of the mission; as indicated, the amount of the charge may be based on a number of factors (e.g. profile, effects, conditions, logistics, etc.) and may be determined based on a number of considerations. As indicated, the carrier may comprise a single entity (e.g. operating UAV/craft) or a combination of persons/entities in an arrangement/relationship to ensure delivery of payload that is carried to a destination by UAV/craft.

As indicated generally (and schematically/representationally) in FIGS. 39 through 47, the mission will comprise the use of a UAV/craft on a route to deliver payload in operating conditions; as indicated, operating conditions (e.g. weather conditions, traffic, etc.) for the mission may vary and the effects of operating conditions may be evaluated and used for adjustments of a mission (e.g. before and during the mission). According to an exemplary embodiment, the system and method may be configured to use data analytics to determine and allocate/assess charge for the delivery of payload by the carrier from the originator to the destination; data may comprise relating to UAV/craft, aerodynamic performance, energy use, operating conditions, etc. from data sources (including but not limited to data assembled by use of data analytics based on prior missions of UAV/craft). See e.g. FIGS. 28 and 32.

As indicated schematically in FIGS. 25A and 38 according to an exemplary embodiment, the method of operation of a payload management system can be operated by a base system (see e.g. FIG. 27 and/or on a UAV/craft system (see e.g. FIG. 38 and/or over a network (see e.g. FIG. 28) using data communications.

According to an exemplary embodiment as indicated schematically in the FIGURES, assessment of a charge/billing and payment using the system may be made using conventional payments systems of any suitable type (e.g. including but not limited to credit card/debit card transactions, automatic withdrawal from financial accounts, invoicing, etc.).

According to an exemplary embodiment as shown schematically in the FIGURES, The network may comprise any of a wide variety of networks that may be available to the system and UAV/craft and UAV operators as well as other entities (such as at the originator, carrier, destination, etc.), including but not limited to the Internet, local/private networks, cellular networks, telephone/data networks (such as provided by wireless data carriers, etc.), etc. As indicated schematically in the FIGURES, data may be provided from any of a wide variety of data sources that can be made available to the system and/or UAV/craft (including over a data link, network, etc.).

As indicate schematically (e.g. in FIGS. 2A-2D, 3A-3F and 13A-13D, etc.) according to an exemplary embodiment of the system and method, payload may be prepared and packaged for carrying by a UAV/craft in any of a wide variety of configurations and arrangements (e.g. including connection to and/or attachment on or under the UAV/craft); payload may be prepared and packaged in a container or pod by an originator (or entity on behalf of the originator) or by the carrier (or entity on behalf of the carrier).

According to an exemplary embodiment, determination of a profile for a UAV/craft and payload for implementation of the system and method may be performed by any of a wide variety of methods/approaches from any of a wide variety of sources. According to an exemplary embodiment (as an example), determination of the aerodynamic effects and profile of the base UAV/craft configuration (e.g. the base profile for the UAV/craft without any payload) may be performed using information from measured data (e.g. test, historical or actual performance), estimated data, stored data (e.g. data tables), calculations, etc.; information/data for the profile may be based on the specific UAV/craft (e.g. as tested), the type/form of the UAV/craft (e.g. from data sources/analytics), etc.

According to an exemplary embodiment (as an example), determination of the aerodynamic effects and profile of the payload (e.g. the loaded profile for payload as packaged in a container/pod or otherwise to be attached to the UAV/craft) for implementation of the system/method may be performed using information from measured data (e.g. test, historical or actual performance), estimated data, stored data (e.g. data tables), calculations, etc. The profile may be based on any or a combination of data from data sources (according to a selected methodology).

As indicated, information/data for use by the system and method (including for determination of profiles) may be obtained from a variety of data sources including but not limited to data communication with UAV/craft and operators, data obtained by the system, monitoring systems/detectors, instrumentation, shared databases, data providers/entities, commercial data/data analytics, etc. The profile may be based on any or a combination of data from available data source (according to a selected methodology).

As indicated, for use of the system and method, certain data may be obtained in advance of a mission and certain data may be obtained during a mission (e.g. in or about real time) and certain data may be obtained after the mission (e.g. from the UAV/craft or other sources); information/data for the system and method may be subject to periodic validation and/or verification (e.g. calibration, accuracy testing, etc.).

According to an exemplary embodiment, a method for assessing a charge for carrying a payload in an unmanned aircraft based on effect of the payload with an aerodynamically-exposed portion. The method comprises the steps of (a) assessing characteristics of the payload on a mission; (b) assessing packaging of the payload on a mission; (c) assessing effect of characteristics of the payload on a mission; (d) assessing effect of packaging of the payload on a mission; (e) determining the charge based on effect of the payload carried on a mission. According to an exemplary embodiment, the payload is carried on the mission; the mission may comprise a route; the mission is conducted in operating conditions. The payload is provided by an originator; the aircraft is operated by an operator; the payload is delivered to a destination; the mission may comprise mission segments.

According to an exemplary embodiment, a method of managing payload for an unmanned aircraft system comprises an aircraft configured to carry a payload with an aerodynamically-exposed portion as freight on a mission from an originator by a carrier to a destination in operating conditions. See e.g. FIGS. 39-47. The method comprises associating the payload with the aircraft and determining an aerodynamic profile of the aircraft with payload. An effect of the payload on the flight characteristics of the aircraft is determined. A freight charge for carrying the payload as freight on the mission to the destination is based on the aerodynamic profile of the aircraft with payload. The flight characteristics may comprise at least one of (a) mass properties; (b) center of mass; (c) moment of inertia; (d) oscillatory effect of the payload; (e) drag effect of aircraft carrying the payload; (f) lift effect of the aircraft carrying the payload; (g) torque effect of the aircraft carrying the payload. The effect may comprise at least one aerodynamic effect; an aerodynamic effect may comprise at least one of (a) lift effect; (b) drag effect; (c) torque effect; (d) inertia effect; (e) mass effect. An aerodynamic effect may comprise (a) base aerodynamic effect attributable to the aircraft and (b) payload aerodynamic effect attributable to payload carried by the aircraft. Payload aerodynamic effect may comprise aerodynamic effect attributable to the aerodynamically-exposed portion of the payload; aerodynamic effect may comprise at least one aerodynamic effect; payload is adjusted to modify aerodynamic effect.

A method of operation of a payload management system for a UAV/craft carrying a payload on a mission from an originator by a carrier to a destination is shown according to an exemplary embodiment. See e.g. FIGS. 39-47. According to an exemplary embodiment, the payload management system may be configured to assess/determine and transact a freight charge including a base charge and surcharge and other additional charges (e.g. a penalty such as a purposive penalty) for a UAV/craft to carry payload on a mission (e.g. one payload segment or multiple payload segments) from an originator to a destination. According to an exemplary embodiment, a method may compromise the steps of planning the mission in route; packaging and loading payload to be carried on the mission; assessing the payload (e.g. determining an aerodynamic profile); estimating the freight charge for carrying the payload on the route (e.g. in the operating conditions); determining and transacting a freight charge (including any surcharge or penalty or discount); conducting and monitoring the mission to deliver the payload from the originator to the destination; assessing the freight charge for the payload/route. As indicated the transaction (e.g. payment) of the freight charge may be made in advance of conducting the mission; according to another exemplary embodiment the transaction (e.g. payment of the freight charge may be made after completion of the mission.

According to an exemplary embodiment, the method may include a determination of a base aerodynamic profile for the UAV/craft in the planning of the mission in route; and a determination of the loaded aerodynamic profile for the UAV/craft with payload at the time the payload is assessed prior to confirmation and/or reconfiguration. The aerodynamic performance of the UAV/craft with payload may be used to estimate the freight charge for the mission; a determination of aerodynamic performance of the UAV/craft with payload may also be evaluated during the mission (e.g. by monitoring and/or instrumentation, etc.). As indicated schematically, if the aerodynamic performance of the UAV/craft with payload is improved over the estimated aerodynamic performance of the UAV/craft with payload a discount may be applied; if the aerodynamic performance of the UAV/craft with payload is worse over the estimated aerodynamic performance of the UAV/craft with payload a surcharge or a penalty may be applied.

According to an exemplary embodiment, when the payload comprises multiple payload segments freight charge may be assessed and determined (e.g. estimated, transacted, allocated, billed, invoiced, etc.) for each payload segment; when a mission comprises multiple payload segments that are delivered separately at different locations freight charge may be assessed and determined (e.g. estimated, transacted, allocated, billed, invoiced, etc.) for each payload segment according to the route and destination/location of delivery of each payload segment. For example, a payload segment is of greater mass and/or that causes increased aerodynamic drag (or other reduction of aerodynamic performance) may be assessed a greater freight charge on the mission than a payload segment that is of lesser mass and/or that does not cause as substantial an increase of aerodynamic drag (or other reduction of aerodynamic performance). According to an exemplary embodiment, when a mission comprises the UAV/craft carrying a payload of multiple payload segments, each individual or grouped payload segment may be allocated a share of the total freight charge for the mission based on a wide variety of factors (e.g. including but not limited to the effect of each individual or grouped payload segment on aerodynamic profile/effects and performance as well as on the route/routing and distance).

According to an exemplary embodiment, when the payload is pre-packaged by the originator and/or packaged in a form that will reduce adverse aerodynamic effects (e.g. on the aerodynamic profile) the freight charge may be adjusted (e.g. a reduced charge/surcharge or discount may be available/applied); when the payload is carried with a lesser aerodynamic effects (e.g. on the aerodynamic profile) the freight charge may be adjusted (e.g. a reduced charge/surcharge or discount may be available/applied). When the payload or payload segment (e.g. individual or group) is configured or carried in a manner that will adversely affect aerodynamic effects, the freight charge may be adjusted (e.g. an increased charge/surcharge or penalty/propulsive penalty may be determined and applied). According to an exemplary embodiment as indicated, each payload segment may be allocated a share of freight charge based on the net effect of the payload segment on the mission by the UAV/craft.

As indicated schematically, according to the system and method optimization of a mission (e.g. in an effort to reduce energy use, to improve mission speed, to shorten mission route, to avoid traffic congestion, to follow a preferred flyway, in view of operating conditions such as weather, to reduce costs, etc.) may be performed in operation based on any of a wide variety of considerations (e.g. assessment of the payload, route, operating conditions, aerodynamic profile/performance, etc.). See for example FIGS. 4, 5, 6 and 7. According to an exemplary embodiment when optimization is possible and can be effectuated by the UAV/craft on the mission, the freight charge transaction may reflect a reduced surcharge and/or discount for carrying and delivering the payload to the destination.

As indicated schematically, according to an exemplary embodiment, the aerodynamic profile and aerodynamic performance (e.g. determined/estimated before the mission and/or determined after the mission) for payload (including individual and grouped payload segments) can be considered in determination of the freight charge for the mission to carry the payload on the mission. According to an exemplary embodiment the system and method may be configured to complete a transaction for freight charge (e.g. including any surcharge/penalty and discount) for the UAV/craft carrying payload (or individual/grouped payload segments) that is representative of the determined effect (e.g. net effect) of the payload on the mission. According to an exemplary embodiment of the system and method, adjustment and reconfiguration (e.g. modifications of payload/payload configuration and packaging, of route, of schedule, of sequencing of delivery, etc.) may be employed to adjust freight charge for a mission in view of considerations available to the system (e.g. as information and data). Data review and data analytics may be employed to improve the accuracy of determinations and estimations by the system and method.

According to an exemplary embodiment the system and method will be configured to provide a generally accurate assessment and transaction of freight charge for payload (e.g. individual or grouped payload segments) carried by the UAV/craft on a mission to deliver payload to a destination in operating conditions that is representative of the net effect of the payload (e.g. including consideration of profile/effects, logistics, performance, optimization, etc.).

As indicated in the FIGURES, according to exemplary and other alternative embodiments the payload management system can be operated according to a wide variety of methods including but not limited to as shown in the embodiments indicated in the FIGURES (e.g. with more or fewer steps than indicated, with variations in the sequence of steps, etc.). The payload management system and method generally will be configured to facilitate management of UAV/craft carrying payload to make an assessment determination of freight charge (e.g. base charge and any surcharge/penalty or discount) that corresponds to the net effect of carrying the payload on the mission in the operating conditions to the destination.

Referring generally to FIGS. 39 to 47, a method of operation of a payload management system is shown generally according to an exemplary embodiment; the method of payload management generally comprises the steps of planning the mission (including route), packaging/loading the payload and carrying the payload on the mission to a destination (showing example packaging/carrying configurations for payload associated with a UAV/craft including in a pod, container, box, sling or set of slings, attached receptacle, etc.).

Referring to FIG. 39, the method comprises the steps of planning the route or mission for the UAV/craft; packaging and loading payload on the UAV/craft; assessing the payload (e.g. determining the profile/aerodynamic profile and aerodynamic effects); estimating a freight charge for the payload and route (e.g. based on the assessment of the payload/profile and route in operating conditions); determining (and transacting such as by prepayment or quotation/price) the freight charge for the mission delivering the payload to the destination (e.g. including any surcharge/penalty or discount); conducting the mission (e.g. and monitoring conditions/recording data and information); assessing and transacting the freight charge for the mission delivering the payload on the route to the destination. As indicated, the freight charge transaction will be based on data and/or other information relating to the payload (e.g. aerodynamic profile) and the route (e.g. representative of fuel/energy usage as well as time in service) for the UAV/craft.

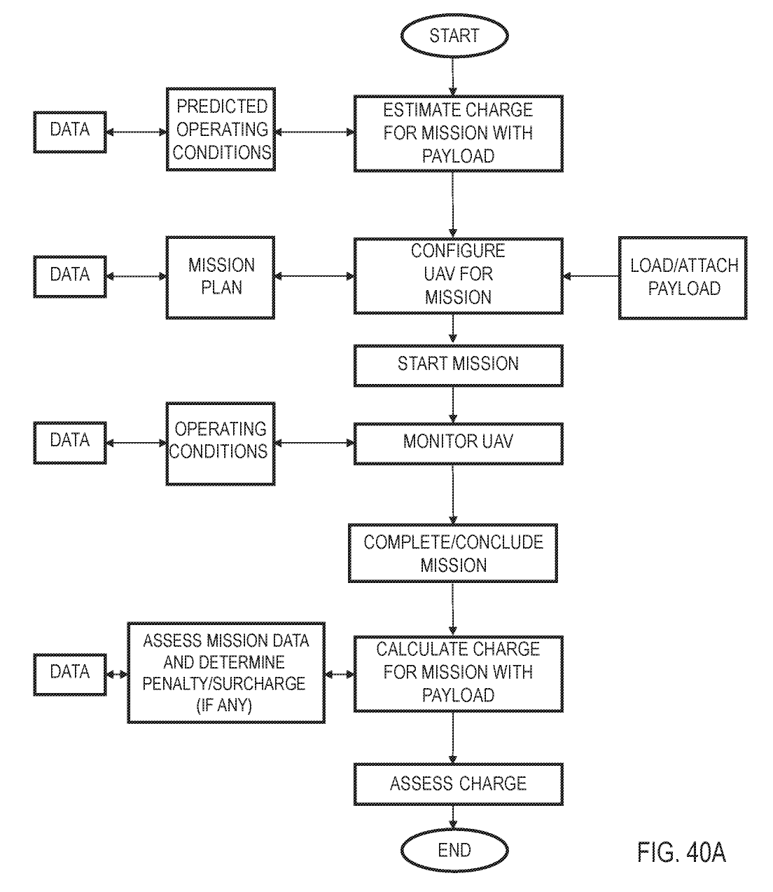

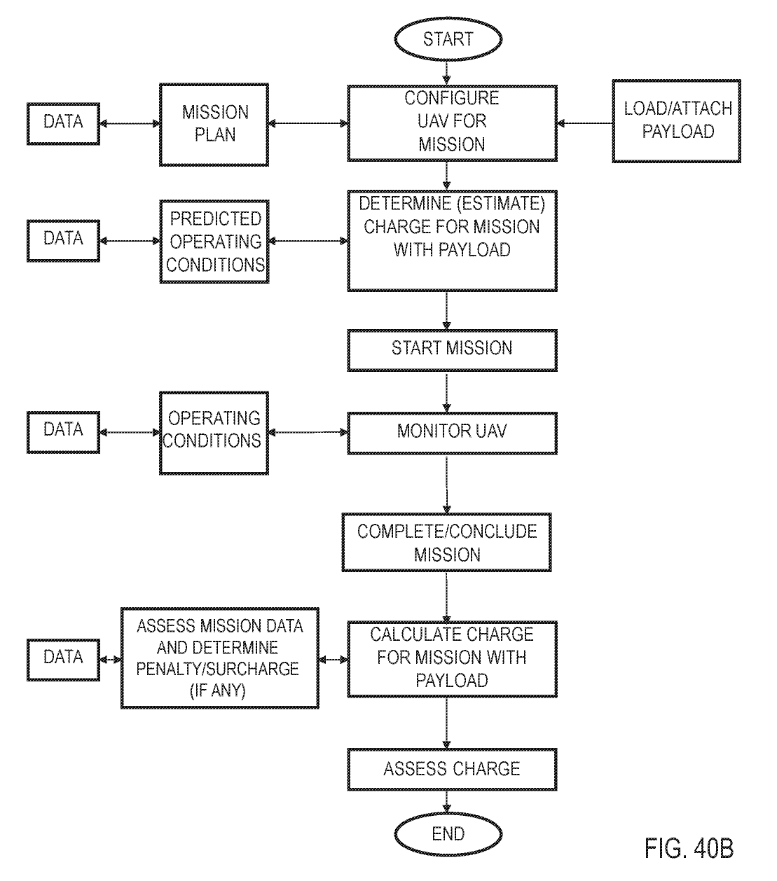

Referring to FIGS. 40A and 40B, a method of operation of a payload management system is shown according to an exemplary embodiment.

Referring to FIG. 40A according to an exemplary embodiment, the payload management system may estimate the charge (e.g. freight charge) for the mission with payload in predicted operating conditions using data from data sources; the UAV/craft may configured for the mission including determination of a mission plan (e.g. routing, timing, etc.) and a payload may be loaded and/or attached to the UAV/craft; the mission of the UAV/craft with payload is initiated and monitored in operating conditions encountered by the UAV/craft. Upon completion/conclusion of the mission data collected during the mission is assessed and determined and a determination is made as to whether any surcharge/penalty (if any) should be assessed for carrying the payload on the mission from originator to destination. A charge (e.g. freight charge is calculated for the mission (e.g. carrying the payload) and assessed for payment (e.g. assessed to the originator and/or to the destination).

Referring to FIG. 40B according to an exemplary embodiment, the UAV/craft may be configured for a mission (e.g. delivery of payload from originator to destination by carrier) along with determination of a mission plan (e.g. routing, timing, etc.); payload is loaded and/or attached to the UAV/craft (e.g. one payload segment or multiple payload segments). A determination or estimate of the charge for the mission with payload based on predicted operating conditions may be made based on data available. The mission is started or initiated in operating conditions and the UAV/craft is monitored during the mission until completion/conclusion of the mission (e.g. delivery of the payload to the destination).

Referring to FIGS. 41A through 41C, a method of operation of a payload management system is shown according to an exemplary embodiment.

As indicated schematically and representationally in FIGS. 41A through 41C, the method of operation of a payload management system for a UAV/craft carrying a payload on a mission is shown schematically and representationally according to an exemplary embodiment. As shown in FIG. 41A, the system may comprise the steps of planning a mission/route, packing/loading payload, assessing the payload (e.g. determining an aerodynamic profile, etc.), estimating a freight charge for carrying the payload on the route/mission, conducting and monitoring the mission and assessment of a freight charge for carrying the payload on the route/mission and transacting a freight charge (e.g. assessing a charge including a surcharge/penalty and/or discount) for carrying the payload on the mission.

Referring to FIGS. 41A, 41B and 41C, the method may comprise the determination or estimate of a base aerodynamic profile for the UAV/craft and estimation of a loaded aerodynamic profile for the UAV/craft with payload. As indicated schematically and representationally in FIG. 41C, determination and/or estimation of the aerodynamic performance (e.g. aerodynamic effects based on aerodynamic profile in operating conditions) is made; an estimate of the freight charge for carrying the payload on the route/mission may be determined. According to an exemplary embodiment, the freight charge may be based on determination and/or estimation of performance and/or profile of the UAV/craft with payload; a transaction (e.g. for payment) for freight charge can be executed before or during or after the mission (e.g. based on data by estimate, prediction, actual/recorded, monitored, calculated, etc.). See e.g. FIGS. 41B and 41C.

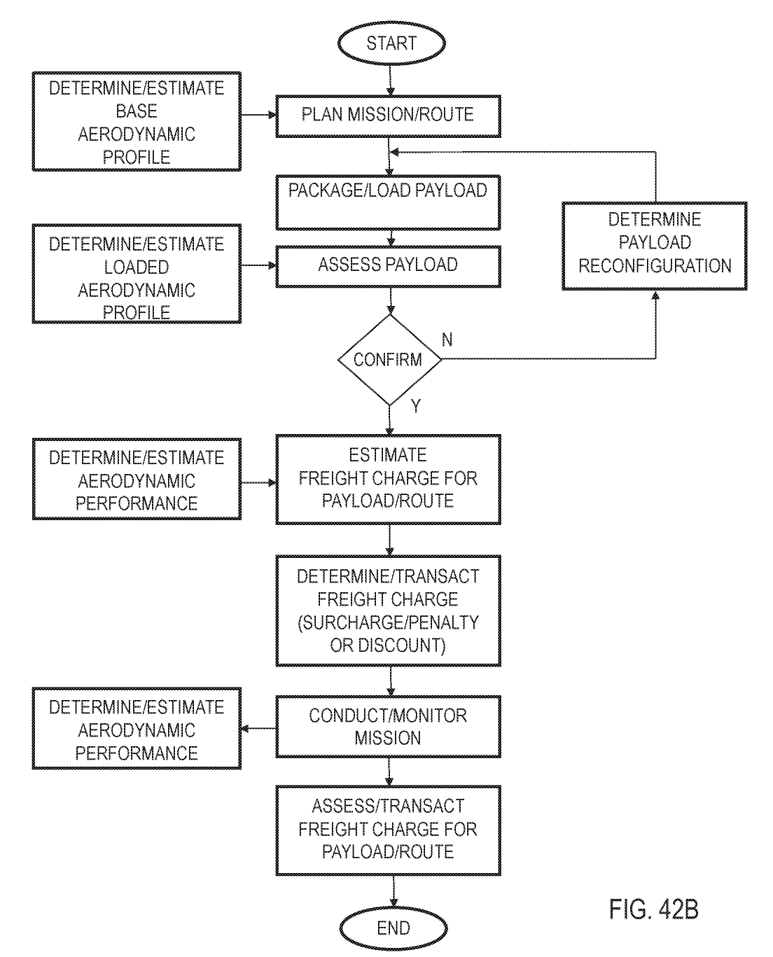

Referring to FIGS. 42A and 42B, a method of operation of a payload management system is shown according to an exemplary embodiment.

As indicated schematically and representationally in FIG. 42A, the method comprises the steps of planning the mission in route for the UAV/craft to deliver the payload from an originator to a destination; packaging and loading the payload onto the UAV/craft; assessing the payload (e.g. including using data and information such as the aerodynamic profile). The process then comprises the step of a confirmation of the payload configuration for the UAV/craft (based on the assessment); if the payload configuration is not confirmed the payload may be reconfigured and/or payload repackaged or reloaded for the UAV/craft. If the payload configuration is confirmed an estimated of the freight charge for carrying the payload on the mission will be determined (based on data); a determination will be made of the freight charge (including any surcharge, penalty or discount) and a transaction executed (e.g. a prepayment or deposit based on the estimated/determined freight charge). The mission will then be conducted and the UAV/craft monitored as the payload is delivered to the destination along the route (e.g. with data recorded by monitoring/instrumentation); an assessment and transaction to complete payment for the freight charge will be completed after the mission has been completed. As indicated, the freight charge may be paid by any involved entity including but not limited to the originator or the destination. As indicated schematically and representationally in FIG. 42B, the method may be configured to estimate or determine aerodynamic profile and performance of the UAV/craft for assessing freight charge for the mission to deliver payload.

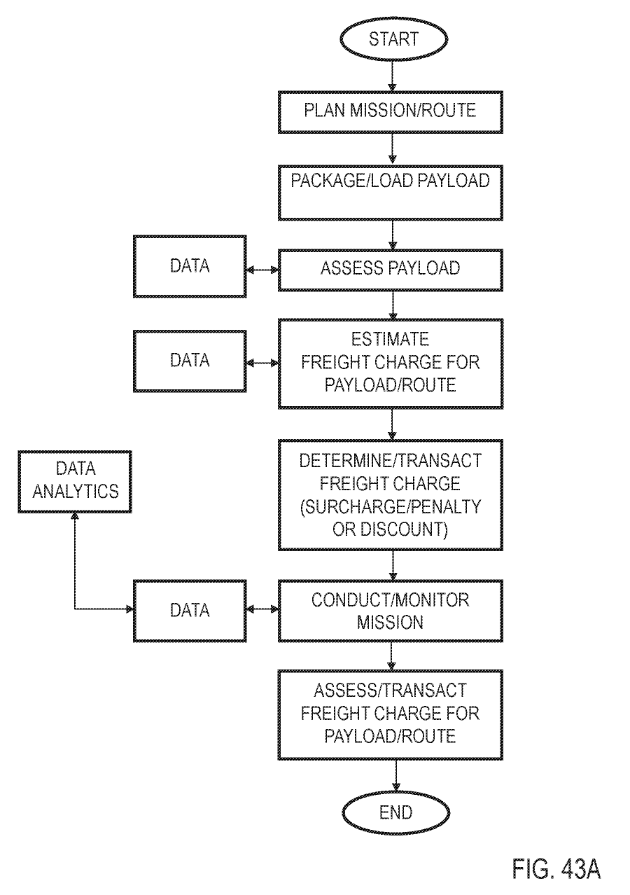

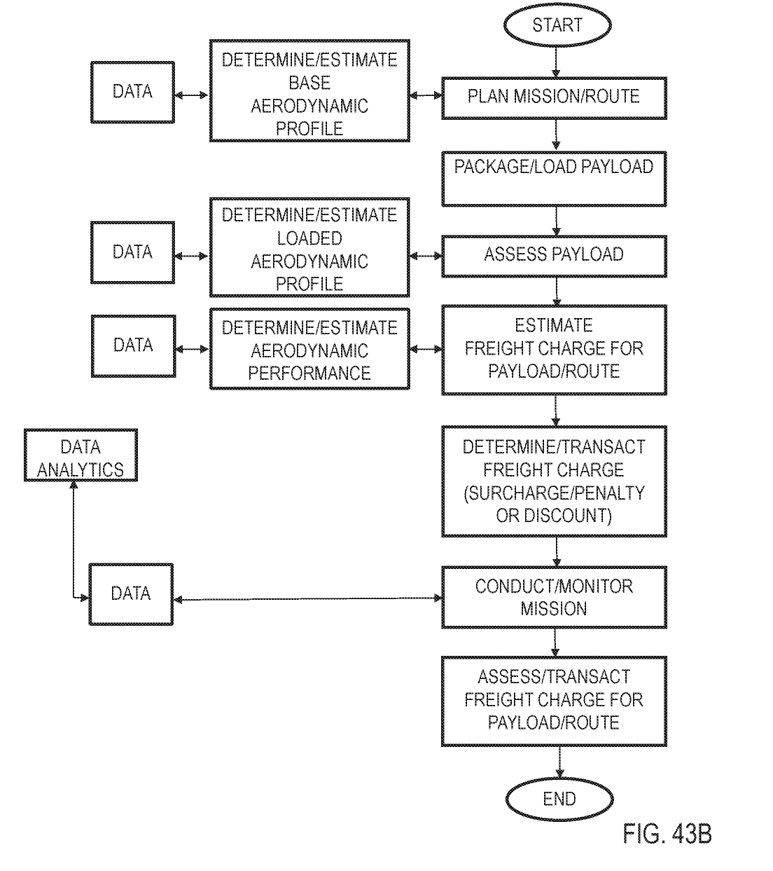

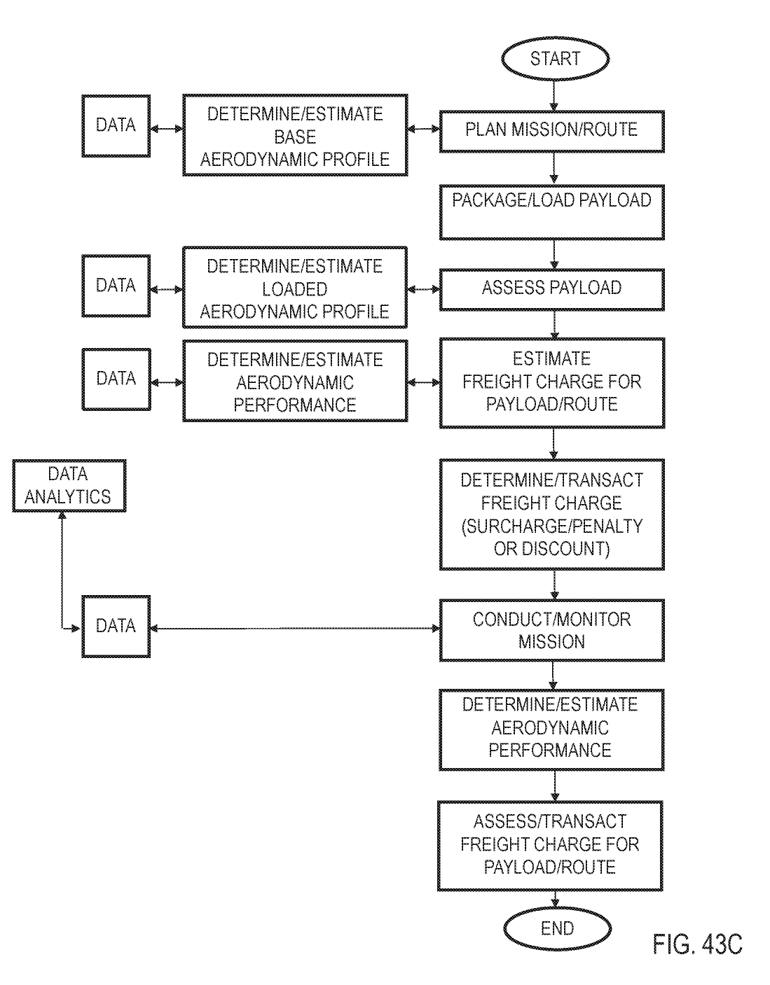

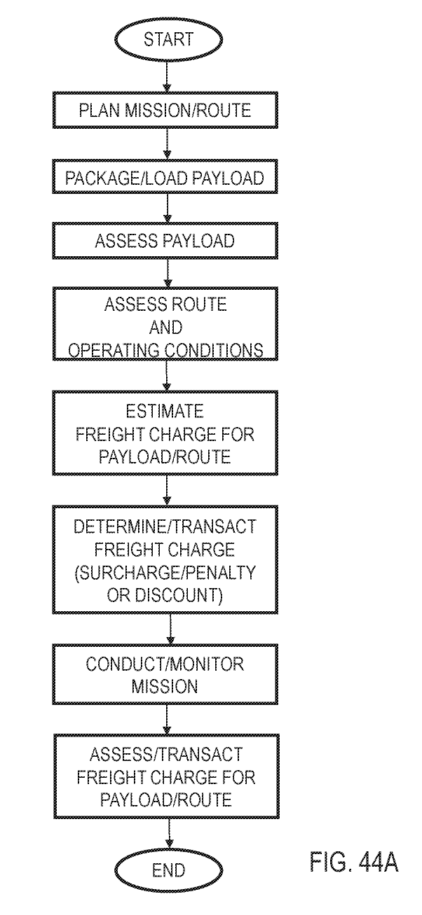

Referring to FIGS. 43A through 43C, a method of operation of a payload management system is shown according to an exemplary embodiment.

As indicated schematically and representationally in FIGS. 43A through 43B, the payload management system and method may employ data analytics (e.g. use collected and available data from monitoring, instrumentation and other data sources relating to UAV/craft performance and conditions (to improve quality and accuracy of determinations and estimates used for assessing aerodynamic profile and assessing/transacting freight charge (including base charge, surcharge/penalty, discount, etc.). See also FIGS. 28, 35-37 and 46A-46B. As indicated schematically in FIG. 43A, the method comprises planning a mission and route for the UAV/craft to deliver payload to a destination; packaging and loading the payload to be carried to the destination; assessing the payload (including determination of aerodynamic profile/effects); estimating a freight charge for carrying a payload on the mission following the route to the destination for delivery; determining and transacting freight charge (preliminary assessment prior to the mission of base charge and any surcharge/penalty or discount); conducting the mission including monitoring to collect data (e.g. from monitoring system, instrumentation, other data sources); and assessing and transacting (with the appropriate entity such as the originator or destination) the freight charge for carrying the payload for the UAV/craft carrying the payload on the mission to the destination. As indicated schematically in FIG. 43B, the method may comprise determination of a base aerodynamic profile (e.g. using data from data sources for the UAV/craft without payload) and the method may comprise determination of a loaded aerodynamic profile (e.g. using data from data sources for the UAV/craft with payload).

According to an exemplary embodiment, data from data sources may also be used to estimate and/or determine the performance of the UAV/craft with payload (e.g. as expected or predicted for the mission in the operating conditions).

As indicated schematically in FIG. 43C, data relating to the aerodynamic performance of the UAV/craft of payload may also be used after completion of the mission to assess and transact the appropriate freight charge for the mission.

Referring to FIGS. 44A through 44C, a method of operation of a payload management system is shown according to an exemplary embodiment; system and method provides for consideration of route and operating conditions for the mission for the UAV/craft to deliver payload from an originator to a destination (e.g. over the route in the operating conditions).

As indicated schematically in FIGS. 44A through 44C, the method comprises the steps of planning the mission with route for the UAV/craft to deliver the payload to the destination; packaging the payload and loading the UAV/craft with payload; assessing the payload (e.g. to determine effects, profile, etc.); assessing the route and operating condition (e.g. to determine effects in combination with flight characteristics, payload, etc.); providing an estimate of freight charge for the UAV/craft to carry the payload on the mission (e.g. on the route in operating conditions); determining and transacting freight charge for the UAV/craft to carry the payload on the mission (e.g. communicating the charge including any surcharge or penalty or discount and/or invoicing or collecting pre-payment of the charge); conducting the mission for the UAV/craft to deliver the payload to the destination (e.g. on the route in the operating conditions) with monitoring (e.g. obtaining information/data for the mission and UAV/craft by monitoring system, detectors, instrumentation, data sources, etc.); assessing and transacting freight charge for the UAV/craft on the mission after delivery of the destination (e.g. completing the transaction including any adjustments of the charge (if any) based on information/data for the mission). See e.g. FIGS. 44A, 44B and 44C. See also generally FIGS. 39 and 47.

As indicated schematically in FIG. 44B, the method may comprise (in advance of the mission) an estimation or determination of aerodynamic profile including the base aerodynamic profile for the UAV/craft (e.g. without payload) and the loaded aerodynamic profile for the UAV/craft with payload; the method may comprise an estimation or determination of the aerodynamic performance of the UAV/craft with payload on the mission (e.g. on the route in the operating conditions). As indicated schematically in FIG. 44C, the method may comprise (after completion of the mission) a determination of aerodynamic performance for the mission (e.g. based on information and data obtained and/or communicated to the system).

As indicated schematically, according to an exemplary embodiment, the aerodynamic profile and aerodynamic performance (e.g. determined/estimated before the mission and/or determined after the mission) can be considered in determination of the freight charge for the mission to carry the payload on the mission. See e.g. FIGS. 44B and 44C. According to an exemplary embodiment the system and method is configured to complete a transaction for freight charge (e.g. including any surcharge/penalty and discount) for the UAV/craft carrying payload (or individual/grouped payload segments) that is representative of the determined effect (e.g. net effect) of the payload on the mission.

Referring to FIGS. 45A and 45B, a method of operation of a payload management system is shown according to an exemplary embodiment; the system and method provides for consideration of route and operating conditions for the mission for the UAV/craft to deliver payload from an originator to a destination (e.g. over the route in the operating conditions). Compare FIGS. 39 and 47.

As indicated schematically in FIGS. 45A and 45B, the method comprises the steps of planning the mission with route for the UAV/craft to deliver the payload to the destination; packaging the payload and loading the UAV/craft with payload; assessing the payload (e.g. to determine effects, profile, etc.); assessing the route and operating condition (e.g. to determine effects in combination with flight characteristics, payload, etc.); providing an estimate of freight charge for the UAV/craft to carry the payload on the mission (e.g. on the route in operating conditions); determining and transacting freight charge for the UAV/craft to carry the payload on the mission (e.g. communicating the charge including any surcharge or penalty or discount and/or invoicing or collecting pre-payment of the charge).

As indicated, the method may comprise the step of facilitating confirmation of the freight charge to be allocated; if confirmation is made the mission will be initiated; if confirmation is not obtained, reconfiguration of payload and/or routing may be performed (e.g. until confirmation is obtained). For example, the entity to provide confirmation (e.g. originator, carrier, destination, etc.) may intend to reduce freight charge and reconfiguration of payload and/or route may be possible to reduce freight charge for the mission; optimization of route may be possible or intended before confirmation is obtained. According to an exemplary embodiment, the step of confirmation will facilitate adjustments and modifications of the mission in advance of the mission.

After confirmation, the method comprises conducting the mission for the UAV/craft to deliver the payload to the destination (e.g. on the route in the operating conditions) with monitoring (e.g. obtaining information/data for the mission and UAV/craft by monitoring system, detectors, instrumentation, data sources, etc.); assessing and transacting freight charge for the UAV/craft on the mission after delivery of the destination (e.g. completing the transaction including any adjustments of the charge (if any) based on information/data for the mission). See e.g. FIGS. 45A and 45B. See also generally FIGS. 39 and 47.

As indicated, data that is collected or obtained during the mission can be stored by the system (e.g. and made available for use for the system/method in determining estimates and assessments of profile, effects, performance, etc. for freight charge and other purposes such as data analytics).

As indicated schematically in FIG. 45B, the method may comprise (in advance of the mission) an estimation or determination of aerodynamic profile including the base aerodynamic profile for the UAV/craft (e.g. without payload) and the loaded aerodynamic profile for the UAV/craft with payload; the method may comprise an estimation or determination of the aerodynamic performance of the UAV/craft with payload on the mission (e.g. on the route in the operating conditions). As indicated schematically in FIG. 45B, the method may comprise (after completion of the mission) a determination of aerodynamic performance for the mission (e.g. based on information and data obtained and/or communicated to the system) as information/data available for an assessment and transaction for freight charge.

As indicated schematically, according to an exemplary embodiment, the aerodynamic profile and aerodynamic performance (e.g. determined/estimated before the mission and/or determined after the mission) can be considered in determination of the freight charge for the mission to carry the payload on the mission. See e.g. FIG. 45B. According to an exemplary embodiment the system and method is configured to complete a transaction for freight charge (e.g. including any surcharge/penalty and discount) for the UAV/craft carrying payload (or individual/grouped payload segments) that is representative of the determined effect (e.g. net effect) of the payload on the mission.

Referring to FIGS. 46A and 46B, a method of operation of a payload management system is shown according to an exemplary embodiment; the system and method provides for consideration of route and operating conditions for the mission for the UAV/craft to deliver payload from an originator to a destination (e.g. over the route in the operating conditions). Compare FIGS. 39 and 46B.

As indicated schematically in FIGS. 46A and 46B, the system and method is configured to provide data and/or to perform data analytics (e.g. use of data from data sources for the system including data from missions conducted) in an effort to improve the accuracy of estimate determinations and assessment determinations (e.g. based on profile, effects, performance, etc.) of freight charge (including base charge, surcharge/penalty, discount, etc.).

According to an exemplary embodiment, the system and method is configured to obtain data from any of a wide variety of sources relating to any of a wide variety of factors. See for example FIG. 25A (indicating data sources) and FIG. 36 (indicating functions/data sets for potentially applicable data). As indicated, features and considerations affecting or relating to aerodynamic profile (including base profile for a UAV/craft based on type, form, etc. and loaded profile with payload) and aerodynamic effects (including drag effect, lift effect, etc.) and operating conditions (e.g. weather, wind, other environmental effects, etc.), mission planning/implementation (e.g. logistics of payload loading/carrying/delivery, sequencing of destinations, routing, speed, etc.), payload configuration (e.g. type, mass, form, etc.), etc. may comprise data used by the system and method for estimate/assessment determinations and data analytics. See also FIGS. 27, 28, 29, 30, 32, 33, 34, 35, 36, 37 and 38.

As indicated schematically, the method comprises the steps of planning the mission with route for the UAV/craft to deliver the payload to the destination; packaging the payload and loading the UAV/craft with payload; assessing the payload (e.g. to determine effects, profile, etc.); assessing the route and operating condition (e.g. to determine effects in combination with flight characteristics, payload, etc.); providing an estimate of freight charge for the UAV/craft to carry the payload on the mission (e.g. on the route in operating conditions); determining and transacting freight charge for the UAV/craft to carry the payload on the mission (e.g. communicating the charge including any surcharge or penalty or discount and/or invoicing or collecting pre-payment of the charge).

As indicated, the method may comprise the step of facilitating confirmation of the freight charge to be allocated; if confirmation is made the mission will be initiated; if confirmation is not obtained, reconfiguration of payload and/or routing may be performed (e.g. until confirmation is obtained). For example, the entity to provide confirmation (e.g. originator, carrier, destination, etc.) may intend to reduce freight charge and reconfiguration of payload and/or route may be possible to reduce freight charge for the mission; optimization of route may be possible or intended before confirmation is obtained. According to an exemplary embodiment, the step of confirmation will facilitate adjustments and modifications of the mission in advance of the mission.

As indicated schematically, the method may comprise (in advance of the mission) consideration and confirmation of the payload configuration (see FIG. 46A) (e.g. including logistics and attachment/loading and grouping of payload segments) and/or consideration of the routing (see FIG. 46B) (e.g. including logistics and sequencing).

After consideration and confirmation, the method comprises conducting the mission for the UAV/craft to deliver the payload to the destination (e.g. on the route in the operating conditions) with monitoring (e.g. obtaining information/data for the mission and UAV/craft by monitoring system, detectors, instrumentation, data sources, etc.); assessing and transacting freight charge for the UAV/craft on the mission after delivery of the destination (e.g. completing the transaction including any adjustments of the charge (if any) based on information/data for the mission). See e.g. FIGS. 46A and 46B.

As indicated schematically, according to an exemplary embodiment, the aerodynamic profile and aerodynamic performance (e.g. determined/estimated before the mission and/or determined after the mission) can be considered in determination of the freight charge for the mission to carry the payload on the mission. According to an exemplary embodiment the system and method is configured to complete a transaction for freight charge (e.g. including any surcharge/penalty and discount) for the UAV/craft carrying payload (or individual/grouped payload segments) that is representative of the determined effect (e.g. net effect) of the payload on the mission.

As indicated, data that is collected or obtained during the mission can be stored by the system (e.g. and made available for use for the system/method in determining estimates and assessments of profile, effects, performance, etc. for freight charge and other purposes such as data analytics) and made available to the system for use and data analytics after the mission (e.g. on future missions and for other purposes). As indicated, the system and method may use data from past missions to provide more accurate determinations for future missions; for example, a mission that involves carrying a same or similar payload configuration with a same or similar UAV/craft on a same or similar route in same or similar operating conditions as on a prior mission (e.g. where data has been monitored and logged/stored) can be planned and/or modified using data from the prior mission (as well as other available data). Effects of variations in payload configuration, UAV/craft and payload combinations, routing and sequencing/logistics, operating conditions as well as sensitivity to variations may be determined using data that is collected and obtained from missions by UAV/craft using the payload management system.

Referring to FIG. 47, a method of operation of a payload management system is shown according to an exemplary embodiment.

The system and method provides for consideration of route and operating conditions for the mission for the UAV/craft to deliver payload from an originator to a destination (e.g. over the route in the operating conditions).

As indicated schematically, the method comprises the steps of configuring the UAV (with mission plan and attached/loaded payload) for the mission with route for the UAV/craft to deliver the payload to the destination (using the base aerodynamic profile); providing an estimate of freight charge for the UAV/craft to carry the payload on the mission (e.g. on the route in operating conditions (using the loaded aerodynamic profile)); starting/conducting the mission for the UAV/craft to deliver the payload to the destination (e.g. on the route in the operating conditions); monitoring the UAV/craft (e.g. obtaining information/data for the mission and UAV/craft by monitoring system, detectors, instrumentation, data sources, etc.); completing/concluding the mission (e.g. delivery of payload); calculating the freight charge for the mission; assessing and transacting freight charge for the UAV/craft on the mission after delivery of the destination (e.g. completing the transaction including any adjustments of the charge (if any) based on information/data for the mission). (e.g. the total charge including any surcharge or penalty or discount for invoicing or collecting payment of the charge).

As indicated schematically in FIG. 47, the method may comprise (in advance of the mission) prediction of operating conditions for the mission as well as an estimation or determination of aerodynamic profile including the base aerodynamic profile for the UAV/craft (e.g. without payload) and the loaded aerodynamic profile for the UAV/craft with payload; the method may comprise an estimation or determination of the aerodynamic performance of the UAV/craft with payload on the mission (e.g. on the route in the operating conditions). As indicated schematically, the method may comprise a determination/estimate of aerodynamic performance for the mission (e.g. based on information and data obtained and/or communicated to the system).

As indicated schematically, according to an exemplary embodiment, the aerodynamic profile and aerodynamic performance (e.g. determined/estimated before the mission and/or determined after the mission) can be considered in determination of the freight charge for the mission to carry the payload on the mission. According to an exemplary embodiment the system and method is configured to complete a transaction for freight charge (e.g. including any surcharge/penalty and discount) for the UAV/craft carrying payload (or individual/grouped payload segments) that is representative of the determined effect (e.g. net effect) of the payload on the mission. See FIG. 47.

As shown schematically, the system and method may be configured to make a prediction of operating conditions for the mission (e.g. environmental conditions such as weather, wind, etc. and other conditions such as traffic, etc.) to be used in the mission plan and/or in the estimation determination of freight charge before the mission; when the mission is conducted operating conditions as encountered can be monitored; data collected and obtained relating to the operating conditions encountered on the mission can be used in the assessment determination and transaction for freight charge after the mission is completed and concluded (e.g. after the payload has been delivered to the destination in the operating conditions). The aerodynamic performance of the UAV/craft with payload on the mission in the operating conditions encountered can be used to make a determination of freight charge (including any surcharge/penalty or discount); if the performance as indicated in the assessment determination was improved or reduced in comparison with the estimation determination then freight charge for the final transaction after the mission can be adjusted (e.g. with a surcharge if the performance was reduced or a reduction/discount if the performance was improved). See FIG. 47.

As indicated schematically and representationally in FIGS. 39-47, the system and method can be implemented according to any exemplary embodiment with a wide variety of configurations and combinations of steps to provide payload management for use of a UAV/craft (e.g. as suitable for a particular arrangement of UAV/craft and payload and entity relationships) to carry payload on a mission on a route in operating conditions to deliver payload from an originator (e.g. entity) to a destination (e.g. location and/or entity) and for determination and transaction of a charge (e.g. freight charge, surcharge, etc.) for use of the UAV/craft on the mission on the route in the operating conditions (e.g. using data/information including profile from data sources including instrumentation, monitoring, storage, network, etc.). See also FIGS. 25A through 38.

### INCORPORATION OF PRESENT TECHNOLOGY/SYSTEMS

The system and method according to exemplary and alternative embodiments may be configured to integrate or operate with present known (and/or future) systems and technology.

According to an exemplary embodiment, the UAV/craft may be of any suitable type or basic form of “helicopter” used for unmanned flight and provided (as necessary or useful) with any/all associated aircraft systems.

### RELATED APPLICATIONS (INCORPORATION BY REFERENCE)

The following commonly-owned (at present) U.S. patent applications are listed and incorporated by reference in the present application: (a) U.S. patent application Ser. No. 14/501,302, titled SYSTEM AND METHOD FOR ADMINISTRATION AND MANAGEMENT OF AN AIRSPACE FOR UNMANNED AIRCRAFT, naming R. Hyde et al. as inventors, filed Sep. 30, 2014 (Docket No. 0712-035-002) is related to and incorporated by reference in the present application; (b) U.S. patent application Ser. No. 14/501,343, titled UNMANNED AIRCRAFT CONFIGURED FOR OPERATION IN A MANAGED AIRSPACE OF FLYWAY, naming R. Hyde et al. as inventors, filed Sep. 30, 2014 (Docket No. 0712-035-003) is related to and incorporated by reference in the present application; (c) U.S. patent application Ser. No. 14/501,365, titled SYSTEM AND METHOD FOR OPERATION OF UNMANNED AIRCRAFT WITHIN A MANAGED AIRSPACE OR FLYWAY, naming R. Hyde et al. as inventors, filed Sep. 30, 2014 (Docket No. 0712-035-004) is related to and incorporated by reference in the present application; (d) U.S. patent application Ser. No. 14/546,487, titled SYSTEM AND METHOD FOR ADMINISTRATION AND MANAGEMENT OF AN AIRSPACE FOR UNMANNED AIRCRAFT, naming R. Hyde et al. as inventors, filed Nov. 18, 2014 (Docket No. 0712-035-002-000001) is related to and incorporated by reference in the present application.

It is important to note that the construction and arrangement of the elements of the inventions as described in system and method and as shown above is illustrative only. Although some embodiments of the present inventions have been described in detail in this disclosure, those skilled in the art who review this disclosure will readily appreciate that many modifications are possible without materially departing from the novel teachings and advantages of the subject matter recited. Accordingly, all such modifications are intended to be included within the scope of the present inventions. Other substitutions, modifications, changes and omissions may be made in the design, variations in the arrangement or sequence of process/method steps, operating conditions and arrangement of the preferred and other exemplary embodiments without departing from the spirit of the present inventions.

It is important to note that the system and method of the present inventions can comprise conventional technology (e.g. aircraft design, construction, components, mechanisms, frames/systems, energy/power systems, monitoring/sensors, materials, control systems, computing systems, telecommunication systems, networking technology, data storage, data transmission, data/file structures/formats, systems/software, application programs, mobile device technology, etc.) or any other applicable technology (present or future) that has the capability to perform the functions and processes/operations indicated in the FIGURES. All such technology is considered to be within the scope of the present inventions.

In the detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A payload management system to determine freight charge for an unmanned aircraft system providing an aircraft configured to carry a payload with an aerodynamically-exposed portion on a mission from an originator by a carrier to a destination in operating conditions comprising:
an aerodynamic profile for the aircraft with the payload;
wherein the aerodynamic profile for the aircraft comprises consideration of an effect of the payload on the flight characteristics of the aircraft;
wherein the freight charge for carrying the payload as freight on the mission to the destination are based on the aerodynamic profile of the aircraft with the payload.

2. The system of claim 1 wherein the flight characteristics comprise at least one of (a) mass properties; (b) center of mass; (c) moment of inertia; (d) oscillatory effect of the payload; (e) drag effect of aircraft carrying the payload; (f) lift effect of the aircraft carrying the payload.

3. The system of claim 1 wherein the effect of the payload comprises at least one aerodynamic effect.

4. The system of claim 1 wherein the aerodynamic profile comprises at least one of a base aerodynamic profile and a loaded aerodynamic profile.

5-11. (canceled)

12. The system of claim 1 wherein the aerodynamically-exposed portion of the payload comprises a pod attached to the aircraft.

13. The system of claim 1 wherein the aerodynamically-exposed portion of the payload comprises a payload segment.

14. The system of claim 1 wherein the aerodynamically-exposed portion of the payload comprises at least one payload segment.

15. The system of claim 1 wherein the aerodynamically-exposed portion of the payload comprises payload attached under the aircraft.

16-31. (canceled)

32. The system of claim 1 wherein the aerodynamically-exposed portion of the payload comprises a pod attached to the aircraft.

33-60. (canceled)

61. The system of claim 1 wherein the freight charge is paid by an originator of the mission.

62. The system of claim 1 wherein the freight charge is billed by the carrier of the payload.

63-65. (canceled)

66. The system of claim 1 wherein the aerodynamic profile comprises payload-induced drag effect (a) as measured and/or (b) as estimated.

67-85. (canceled)

86. The system of claim 1 wherein the aircraft system is configured to determine drag effect to plan a route for the mission.

87. (canceled)

88. The system of claim 1 wherein the aircraft system is configured to use aerodynamic profile to assess freight charge after the mission.

89. The system of claim 1 wherein the aircraft system is configured to use aerodynamic profile to assess freight charge before the mission.

90. The system of claim 1 wherein the payload can be attached to the exterior of the aircraft.

91-221. (canceled)

222. A method of managing payload for an unmanned aircraft system comprising an aircraft configured to carry a payload with an aerodynamically-exposed portion as freight on a mission from an originator by a carrier to a destination in operating conditions comprising the steps of:
(a) associating the payload with the aircraft;
(b) determining an aerodynamic profile of the aircraft with payload;
wherein an effect of the payload on the flight characteristics of the aircraft is determined;
wherein a freight charge for carrying the payload as freight on the mission to the destination is based on the aerodynamic profile of the aircraft with payload.

223-346. (canceled)

347. A method of managing an unmanned aircraft system comprising an aircraft configured to carry a payload with an aerodynamically-exposed portion on a mission from an originator by a carrier to a destination in operating conditions comprising the steps of:
(a) associating the payload with the aircraft;
(b) determining aerodynamic profile of the aircraft with payload;
(c) assessing freight charge for the mission based on aerodynamic profile of the aircraft with the payload including consideration of an effect of the payload on flight characteristics of the aircraft;
wherein flight characteristics for the unmanned aircraft system comprise at least one of:
(c) mass properties;
(d) center of mass;
(e) moment of inertia;
(f) oscillatory effect of movement and/or oscillation of the payload;
(g) drag effect of aircraft carrying the payload.

348-359. (canceled)

360. A method for assessing a charge for carrying a payload in an an unmanned aircraft based on effect of the payload with an aerodynamically-exposed portion comprising the steps of:
(a) assessing characteristics of the payload on a mission;
(b) assessing packaging of the payload on a mission;
(c) assessing effect of characteristics of the payload on a mission;
(d) assessing effect of packaging of the payload on a mission;
(e) determining the charge based on effect of the payload carried on a mission.

361-459. (canceled)

460. A payload management system for an unmanned aircraft system providing an aircraft configured to carry a payload with an aerodynamically-exposed portion on a mission from an originator by a carrier to a destination to determine a charge for carrying the payload as freight in operating conditions comprising:
[1] a container for the payload to be associated with the aircraft;
[2] an aerodynamic profile for the aircraft with the payload;
wherein the aerodynamic profile for the aircraft comprises consideration of an effect of the payload on the flight characteristics of the aircraft;
wherein the charge for carrying the payload as freight is based on the aerodynamic profile of the aircraft with the payload.

461-514. (canceled)

515. A method of managing an unmanned aircraft system comprising an aircraft configured to carry a payload with an aerodynamically-exposed portion on a mission to a destination comprising the steps of:
(a) associating the payload with the aircraft;
(b) determining aerodynamic profile of the aircraft with payload;
wherein an effect of the payload on the flight characteristics of the aircraft is determined;
wherein flight characteristics comprise at least one of:
(c) mass properties;
(d) center of mass;
(e) moment of inertia;
(f) oscillatory effect of movement and/or oscillation of the payload;
(g) drag effect of aircraft carrying the payload;
wherein freight charge for carrying the payload as freight on the mission to the destination is based on the aerodynamic profile of the aircraft with the payload.

516-528. (canceled)

529. A payload management system to determine freight charge for an unmanned aircraft system providing an aircraft configured to carry a payload with an aerodynamically-exposed portion on a mission from an originator by a carrier to a destination in operating conditions comprising:
(a) an aerodynamic profile for the aircraft with the payload;
wherein the aerodynamic profile for the aircraft comprises consideration of an effect of the payload on the flight characteristics of the aircraft;
wherein the freight charge for carrying the payload as freight on the mission to the destination are based on the aerodynamic profile of the aircraft with the payload.

530-568. (canceled)
